(19) United States
(12) Patent Application Publication
(10) Pub. No.: US 2021/0195908 A9
(43) Pub. Date: Jul. 1, 2021

(54) CREAMY EDIBLE EMULSIONS

(71) Applicant: VIRUN, INC., Pomona, CA (US)

(72) Inventor: Philip J. BROMLEY, Fullerton, CA (US)

(21) Appl. No.: 16/691,348

(22) Filed: Nov. 21, 2019

Related U.S. Application Data
(60) Provisional application No. 62/877,752, filed on Jul. 23, 2019.
(60) Provisional application No. 62/773,988, filed on Nov. 30, 2018.

(51) Int. Cl. A23D 7/00; A23D 7/005; A23L 29/00; A23L 25/10; A23L 25/00

(52) U.S. Cl. CPC A23D 7/001; A23D 7/0056; A23L 25/30; A23L 25/10; A23L 29/035

(57) ABSTRACT

Provided are edible emulsions that can be used as smoothies, creamers, syrups or other products to be used in food or consumed directly. The emulsions contain relatively high amounts, such as 10%-50% by weight of a protein composition, such as one or more of nut butters, whey, and, optionally, collagen, and very low amounts of a surfactant, typically less than 2%, such as less than 1.5%. The resulting emulsions are stable and have large particles in the range of about 3 μm, 4 μm or 5 μm to 10 μm or 15 μm. As a result, the emulsions have a creamy consistency.

### RELATED APPLICATIONS

Benefit of priority is claimed to U.S. Provisional Application No. 62/773,988, filed Nov. 30, 2018, and U.S. Provisional Application No. 62/877,752, filed Jul. 23, 2019, each entitled “CREAMY EDIBLE EMULSIONS,” each to inventor Philip J. Bromley, and to applicant Virun, Inc. The subject matter of each of the above-referenced applications is incorporated by reference in its entirety.

### FIELD

Provided are emulsions that can be used as smoothies, creamers, syrups or other products to be used in food or consumed directly.

### BACKGROUND

Non-polar compounds are not easily dissolved in aqueous solutions, such as water and other polar solvents. Non-polar compounds are used in compositions for human ingestion. These include, for example, pharmaceuticals, nutraceuticals and/or dietary supplements. Exemplary of non-polar compounds are vitamins and minerals, fatty acids, and other non-polar compounds, non-polar active agents and non-polar active ingredients. Because of poor water solubility, inclusion of non-polar compounds, particularly in high amounts, in products for human consumption can be difficult. Also, since compositions for delivery of non-polar compounds can be combined with food and beverages, it is advantageous that the compositions containing the non-polar compounds are palatable; it can be difficult to provide palatable compositions.

### SUMMARY

Provided herein are edible and palatable, including tasty, emulsions for use for direct consumption and for addition to or consumption with foods and beverages. The compositions provided herein are edible emulsions that are creamy and tasty and can be used in place of creamers, yogurts, ice creams, mayonnaise and other such foods. The compositions, for example, have a high amounts of proteins and non-polar compound compounds. This is achieved by use of proteins from native sources that contain high amounts of protein and fats. By virtue of the fat in the native source, such as a certain nuts and seeds or whey, the protein can be emulsified with a relatively low amount, such as less than 2%, less than 1.5%, less than 1%, or between about 0.5% and 1%, by weight of the resulting emulsion, of a surfactant, such as a pegylated derivative of vitamin E, such as a tocopheryl polyethylene glycol succinate (TPGS). The emulsions provided herein are very stable, and contain particles of size greater than about 3, 4 or 5 μm, up to about 15 μm, so that the distribution of particles is between 3-15 μm or 5-10 μm, or have an average particle size between about 5 μm and 10 μm or about 15 μm. These relatively large particles provide a creamy texture. The combination of the protein compositions as described herein and the surfactant in low amount results in a stable emulsion with these relatively large particles.

Hence, provided are stable emulsions that contain at least about 10% up to as much as 40%, 45%, or 50% protein and oil(s), such as between about 10% and 40%, or between 45% and 70% that can include non-polar nutraceutical compounds, such as fish oil and cannabidiol (CBD) oil and/or hemp oil and/or algal oil. The emulsions can be liquids or of higher viscosity such that they are spreadable. Any of the emulsions provided herein can have a pH that is or is adjusted to between 6 and 8, such as between 6.4 and 7.5, or a pH that is between 4 and 8, such as between 4.61 and 6.0.

Provided are edible emulsions that contain protein and relatively low amounts of surfactant Exemplary of the emulsions provided herein is an emulsion that contains: one or more polar protic solvents in an amount between about 13% and 50%, by weight, of the emulsion; a protein composition selected from one or more of a nut butter, whey protein, and hydrolyzed collagen, in an amount between about 12% and 45%, by weight, of the emulsion, where the whey protein is an 80% whey protein concentrate or 90% whey protein isolate; the nut butter is from nuts or seeds that contain about 10% to 35% protein, by weight, and about 30% to 70% fat, by weight; one or more edible oils in an amount between about 10% to 40%, by weight; and a surfactant, wherein the amount of surfactant is between 0.5% up to less than 2%, or 0.5% up to 1.5%. By virtue of this combination of ingredients and components, the resulting emulsion contains particles with a diameter that ranges between about 3 μm, 4 μm or 5 μm and up to, and including, about 10, 12, 13, 14 or 15 μm, such as about 5 μm to 10 μm. The average particle size can be about 5 μm or larger, such as 6, 7, 8, 9, 10, 11 or 12 μm.

In these emulsions and any emulsions provided herein, the amount of polar protic solvent(s) is between about 25% and 50%, by weight; the amount of the protein composition is between about 12% and 38%, by weight; and the amount of oil(s) is between about 30% and 40% or 46%, by weight, of the emulsion. The oil component can include a non-polar active compound, such as an algal or fish oil, or a CBD oil, or a vitamin or other such nutraceutical known to those of skill in the art or as described herein. In other of these embodiments, the amount of polar protic solvent(s) is between about 20% and 30%, by weight; the amount of the protein composition is between about 25% and 38%, by weight; and the amount of oil(s) is between 10% and 15%, by weight, of the emulsion. In other of these embodiments, the amount of polar protic solvent(s) is between 15% and 30%, by weight; the amount of the protein composition is between about 12% and 38%, by weight; and the amount of oil is between about 10% and 20%, by weight, of the emulsion. In others of these embodiments, the amount of polar protic solvent(s) is between about 15% and 20%, by weight; the amount of the protein composition is between about 30% or 35% and 50%, by weight; and the amount of oil(s) is between about 10% and 20%, by weight, of the emulsion. In others of these embodiments, the amount of polar protic solvent(s) is between about 40% and 50%, by weight; the amount of the protein composition is between about 12% and 20%, by weight; and the amount of oil(s) is between about 25% and 40%, by weight, of the emulsion. In others of these embodiments, the amount of polar protic solvent(s) is between about 20% and 30%, by weight; the amount of the protein composition is between about 30% and 35%, by weight; and the amount of oil(s) is between about 30% and 40%, by weight, of the emulsion. In others of these embodiments, the amount of protein composition is between 40% and 45% or 50%, by weight; and the amount of oil is between about 10% and 15%, by weight, of the emulsion. Emulsions with higher amounts of protein, such as between 40% and 50%, or 40% and 45%, the viscosity can be from the viscosity of a jelly to peanut butter, which is about 500-30,000 centipoise (cps).

In others of these embodiments, the amount of polar protic solvent(s) is between about 35% and 50%, by weight; the amount of the protein composition is between about 10% and 30%, by weight; and the amount of oil(s) is between about 30% and 40%, by weight, of the emulsion.

In all embodiments herein, the surfactant can be a polyalkylene glycol derivative of vitamin E. The amount is relatively low, such as between about 0.3% to up to 2%, such as less than 2%, 1.5% or less, 1% or less, between about 0.5% and 1%, inclusive, by weight, such as between about 0.6% and 0.7%, by weight. The polyalkylene glycol derivative of vitamin E can be a polyethylene glycol (PEG)-derivative of vitamin E, such as, but not limited to a tocopheryl polyethylene glycol succinate (TPGS), such as TPGS-1000. The polyalkylene glycol derivative of vitamin E can be a high dimer mixture, such as described in U.S. Pat. No. 9,351,517, and also below. A high dimer PEG-derivative of vitamin E mixture contains at least 13 wt % water-soluble dimer and up to 87 wt % monomer, generally 25% or more than 25%, by weight, dimer. The polyalkylene glycol derivative of vitamin E high dimer can be a tocopheryl polyethylene glycol succinate (TPGS) mixture. For example, the polyalkylene glycol derivative of vitamin E mixture, such as TPGS, contains up to 75%, 70%, 69%, 62%, 55%, 50%, 45%, 40%, or 35% dimer or 29%-69%, inclusive, of dimer; and/or contains less than 70%, 65%, 63%, 62%, or 61% of the TPGS monomer. For example, the polyalkylene glycol derivative of vitamin E mixture, which can be a TPGS mixture, can contain up to 75%, 70%, 69%, 62%, 55%, 50%, 45%, 40%, or 35% dimer or 29%-69%, inclusive, of dimer; and/or contains less than 70%, 65%, 63%, 62%, 61% of the monomer. In some embodiments the high dimer polyalkylene glycol derivative of vitamin E mixture can contain an amount of dimer that is greater than 29%, and the total amount of dimer and monomer in the mixture that is greater than 95%, 96%, 97%, 98%, or 99%. The polyalkylene glycol derivative of vitamin E can be a TPGS. In some embodiments of these high dimer polyalkylene glycol derivative of vitamin E mixtures the monomer comprises between or between about 25% and 30%, 25% and 35%, 25% and 40%, 25% and 45%, 25% and 50%, 25% and 55%, 25% and 60%, 25% and 65%, 30% and 35%, 30% and 40%, 30% and 45%, 30% and 50%, 30% and 55%, 30% and 60%, 30% and 65%, 30% and 69%, 35% and 40%, 35% and 45%, 35% and 50%, 35% and 55%, 35% and 60%, 35% and 65%, 35% and 69%, 40% and 45%, 40% and 50%, 40% and 55%, 40% and 60%, 40% and 65%, 40% and 69%, 45% and 50%, 45% and 55%, 45% and 60%, 45% and 65%, 45% and 69%, 50% and 55%, 50% and 60%, 50% and 65%, 50% and 69%, 55% and 60%, 55% and 65%, 55% and 69%, 60% and 65%, 60% and 69%, or 65% and 69%, by weight, of the TPGS mixture or is or is at least about 25%, 26%, 27%, 28%, 29%, 30%, 31%, 32%, 33%, 34%, 35%, 36%, 37%, 38%, 39%, 40%, 41%, 42%, 43%, 44%, 45%, 46%, 47%, 48%, 49%, 50%, 51%, 52%, 53%, 54%, 55%, 56%, 57%, 58%, 59%, 60%, 61%, 62%, 63%, 64%, 65%, 66%, 67%, or 68%, up to and including 69%, by weight, of the mixture. In other embodiments, the dimer comprises between or between about 13% and 15%, 13% and 20%, 13% and 25%, 13% and 30%, 13% and 35%, 13% and 40%, 13% and 45%, 13% and 50%, 13% and 55%, 13% and 60%, 13% and 65%, 13% and 70%, 13% and 75%, 20% and 25%, 20% and 30%, 20% and 35%, 20% and 40%, 20% and 45%, 20% and 50%, 20% and 55%, 20% and 60%, 20% and 65%, 20% and 70%, 20% and 75%, 25% and 30%, 25% and 35%, 25% and 40%, 25% and 45%, 25% and 50%, 25% and 55%, 25% and 60%, 25% and 65%, 25% and 70%, 25% and 75%, 30% and 35%, 30% and 40%, 30% and 45%, 30% and 50%, 29% and 52%, 30% and 55%, 30% and 60%, 30% and 65%, 30% and 70%, 30% and 75%, 35% and 40%, 35% and 45%, 35% and 50%, 35% and 55%, 35% and 60%, 35% and 65%, 35% and 70%, 35% and 75%, 40% and 45%, 40% and 50%, 40% and 55%, 40% and 60%, 40% and 65%, 40% and 70%, 40% and 75%, 45% and 50%, 45% and 55%, 45% and 60%, 45% and 65%, 45% and 70%, 45% and 75%, 50% and 55%, 50% and 60%, 50% and 65%, 50% and 69%, 55% and 60%, 55% and 65%, 55% and 70%, 55% and 75%, 60% and 65%, 60% and 70%, 60% and 75%, 65% and 70%, 65% and 75%, or 70% and 75%, by weight, of the TPGS mixture or is or is at least about 13%, 14%, 15%, 16%, 17%, 18%, 19%, 20%, 21%, 22%, 23%, 24%, 25%, 26%, 27%, 28%, 29%, 30%, 31%, 32%, 33%, 34%, 35%, 36%, 37%, 38%, 39%, 40%, 41%, 42%, 43%, 44%, 45%, 46%, 47%, 48%, 49%, 50%, 51%, 52%, 53%, 54%, 55%, 56%, 57%, 58%, 59%, 60%, 61%, 62%, 63%, 64%, 65%, 66%, 67%, 68%, 69%, 70%, 71%, 72%, 73%, or 74%, up to 75%, by weight, of the mixture. For example, in some embodiments the monomer comprises between or between about 35% and 65%, inclusive, by weight, of the mixture, and the dimer comprises between or between about 25% and 65%, by weight, of the mixture, or the dimer comprises between or between about 29% and 61% or 62%, by weight, of the mixture, and the monomer and dimer together comprise at least 70%, by weight, of the polyalkylene glycol derivative of vitamin E, such as TPGS, mixture in the composition. The PEG moiety, such as the PEG moiety in TPGS, has a molecular weight between or between about 100 Da and 20,000 Da, 200 Da and 10,000 Da, 200 Da and 8000 Da, 200 Da and 6000 Da, 200 Da and 5000 Da, 200 Da and 3000 Da, 200 Da and 1000 Da, 200 Da and 800 Da, 200 Da and 600 Da, 200 Da and 400 Da, 400 Da and 20,000 Da, 400 Da and 10,000 Da, 400 Da and 8000 Da, 400 Da and 6000 Da, 400 Da and 5000 Da, 400 Da and 3000 Da, 400 Da and 1000 Da, 400 Da and 800 Da, 400 Da and 600 Da, 600 Da and 20,000 Da, 600 Da and 10,000 Da, 600 Da and 8000 Da, 600 Da and 6000 Da, 600 Da and 5000 Da, 600 Da and 3000 Da, 600 Da and 1000 Da, 600 Da and 800 Da, 800 Da and 20,000 Da, 800 Da and 10,000 Da, 800 Da and 8000 Da, 800 Da and 6000 Da, 800 Da and 5000 Da, 800 Da and 3000 Da, 800 Da and 1000 Da, 1000 Da and 20,000 Da, 1000 Da and 10,000 Da, 1000 Da and 8000 Da, 1000 Da and 6000 Da, 1000 Da and 5000 Da, 1000 Da and 3000 Da, 3000 Da and 20,000 Da, 3000 Da and 10,000 Da, 3000 Da and 8000 Da, 3000 Da and 6000 Da, 3000 Da and 5000 Da, 5000 Da and 20,000 Da, 5000 Da and 10,000 Da, 5000 Da and 8000 Da, 5000 Da and 6000 Da, 6000 Da and 20,000 Da, 6000 Da and 10,000 Da, 6000 Da and 8000 Da, 8000 Da and 20,000 Da, 8000 Da and 10,000 Da, or 10,000 Da and 20,000 Da, or has a molecular weight of 100, 200, 238, 300, 400, 500, 600, 750, 800, 1000, 1200, 1500, 2000, 2500, 3000, 3400, 3500, 4000, 6000, 8000, 10,000, 12,000 or 20,000 Da.

The polyalkylene glycol derivative of vitamin E, high dimer mixture, or conventional polyalkylene glycol derivative of vitamin E, which generally has less than about 12% dimer and other forms, can be substantially free of any free polyalkylene glycol moieties, such as substantially free of free PEG moieties. The polyalkylene glycol derivative of vitamin E can treated, such as by chromatography to remove free polyalkylene glycol moieties. When polyalkylene glycol moieties, such as PEG moieties are removed, and the resulting polyalkylene glycol derivative of vitamin E, such as TPGS, is used in the emulsions herein, the particles in the resulting emulsions are generally larger than those formed with polyalkylene glycol derivative of vitamin E that contains polyalkylene glycol moieties. The polyalkylene glycol moieties aid in emulsification. If larger particles are desired, that polyalkylene glycol moieties can be reduced or removed. Larger particles renders the resulting emulsion more creamy in consistency. In all instances, the emulsions provided herein are stable (i.e., the phases do not separate).

The emulsions provided herein can contain a phospholipid. The amount of phospholipid generally is in an amount less than 0.5%, by weight, of the emulsion, whereby the total amount of surfactant and phospholipid is less than 2% or less than 1.5%, by weight, of the emulsion. Exemplary of phospholipids is a phosphatidylcholine. The emulsions provided herein can contain, for example, an amount less than 0.5%, by weight, of the emulsion. The phospholipid can be a lecithin.

The emulsions contain the polar protic solvent. Exemplary of polar protic solvents is water or glycerin or a mixture of water and glycerin. In embodiments, the polar protic solvent is a mixture of water and glycerin; and the amount of water is greater than the amount of glycerin. In such embodiments, the polar protic solvent is a mixture of water and glycerin; the amount of water is about 15% to 20%, by weight; and the amount of glycerin is 5% to 10%, by weight, of the emulsion. In others of these embodiments, the polar protic solvent is a mixture of water and glycerin; the amount of water in the emulsion is about 5%-30% or 35%, by weight; and the amount of glycerin is 5%-25%, by weight, of the emulsion. In other embodiments, the polar protic solvent is a mixture of water and glycerin; and the amount of water is about 17% or 18% to about 30%, by weight; and the amount of glycerin is about 12% to about 20%, by weight, of the emulsion. In other embodiments, the polar protic solvent is a mixture of water and glycerin; and the amount of water is about 23% or 24% to about 26%, by weight; and the amount of glycerin is about 17% to about 19%, by weight, of the emulsion. In other embodiments, the amount of glycerin can be greater than the amount of water, and the above percentages reversed.

In the emulsions provided herein, the amount of oil can be 10%-15%, by weight, of the emulsion, or the amount of oil is 30%-40%, by weight, or is 35%-40%, by weight, or the amount of oil is 20%-25%, by weight, or 25%-45%, by weight Oils include vegetable and other edible oils, such as, but not limited to, one or more of vitamin E oil, flaxseed oil, coconut oil, conjugated linoleic acid (CLA), borage oil, rice bran oil, D-limonene, canola oil, corn oil, MCT (medium chain triglycerides) oil and oat oil. In particular the embodiments the oil is MCT oil and/or CLA. In the emulsions the oil can be or can contain a nutraceutical or supplement or therapeutically active oil. For example, the emulsions can contain about 5%-10%, by weight, of a nutraceutical or supplement or therapeutically active oil, or can contain less than 5%, by weight. For example, the oil can contain a fish oil or an algal oil, or hemp oil, or can contain a cannabinoid. The cannabinoid can be tetrahydrocannabinol (THC) and/or cannabidiol (CBD). The amount of the nutraceutical can be a small percentage of the oil or can be up to all of the oil. In particular embodiments, the emulsions contain about 0.1% or 0.2%-0.5% or 0.1 to 2% or 3%, by weight, of a nutraceutical or supplement or therapeutically active oil. For example, the emulsions can contain 0.1%-0.5%, or 0.2-0.5% by weight, CBD oil. Exemplary of such oils is a fish oil or algal oil or hemp oil.

The protein compositions can be or contain a nut butter, a whey protein, collagen or a mixture of nut butter(s) and whey protein, or a mixture of whey protein and collagen, or a mixture of nut butter(s), whey protein and collagen, or a mixture of nut butter(s) and collagen. For example, emulsions provided herein contain 15%-30%, by weight, or 5%-10%, by weight, whey protein and optionally 3%-4%, by weight, collagen, or 40%-45%, by weight, of a nut butter, or 15-40% nut butter, or 15-38% nut butter, or 15%-30%, by weight, of a nut butter. The emulsions can contain a mixture of 80% whey protein concentrate and 90% whey protein isolate in an amount between about 5% and 16%, by weight.

Exemplary emulsions contain, by weight of the emulsion: 18%-22% water; 5%-10% glycerin; 25%-35% nut butter; 0.6%-0.7% TPGS; 10%-12% MCT oil; 0.3% to 0.5% CBD oil (60%); optionally 3%-10% flavors; and 20%-25% sugar or additional nut butter or a mixture thereof. Sugar can be replaced by artificial sweetener in an appropriate amount, or replaced by nut butter or additional oil or polar protic solvent. Other exemplary emulsions contain, by weight of the emulsion: 5%-10% water; 8%-12% glycerin; 35%-45% nut butter; 0.6%-0.7% TPGS; 10%-12% MCT oil; 0.3% to 0.5% CBD oil (of 60% CBD oil); optionally 3%-10% flavors; and optionally 20%-25% sugar or additional nut butter or a mixture thereof, or artificial sweetener in an appropriate amount in place of the sugar. Other emulsions contain, by weight of the emulsion: 15%-30% water; 15%-22% glycerin; 10%-17% whey protein products and/or collagen; 0.6%-0.7% TPGS; 30%-38% oil selected from one or more of MCT oil, CLA, algal oil, fish oil, canola oil, sunflower oil, and hemp seed oil; 0.3% to 0.5% CBD oil (60%) or phytocannabinoid-rich hemp oil; and 1%-7% flavors. Other emulsions contain, by weight of the emulsion: 15%-20% water; 15%-20% glycerin; 10%-22% nut butter; 5%-15% whey protein product(s); 0.6%-0.7% TPGS; 30%-38% oil selected from one or more of MCT oil, CLA, algal oil, fish oil, canola oil, sunflower oil, and hemp seed oil; and 1%-5% flavors. Other emulsions contain, by weight of the emulsion: 15%-20% water; 10%-15% glycerin; 25%-36% nut butter; 5%-15% whey protein product(s); 0.6%-0.7% TPGS; 30%-38% oil selected from one or more of MCT oil, CLA, algal oil, fish oil, canola oil, sunflower oil, and hemp seed oil; and 1%-5% flavors. Other emulsions contain, by weight of the emulsion: 20%-30% water; 12%-22% glycerin; 13%-20% whey protein products and/or collagen; 0.6%-0.7% TPGS; 30%-38% oil selected from one or more of MCT oil, CLA, algal oil, fish oil, canola oil, sunflower oil, and hemp seed oil; and 1%-5% flavors. Other emulsions contain, by weight of the emulsion: 15%-20% water; 10%-15% glycerin; 25%-36% nut butter; 0.6%-0.7% TPGS; 30%-38% oil selected from one or more of MCT oil, CLA, algal oil, fish oil, canola oil, sunflower oil, and hemp seed oil; and 1%-5% flavors. Other emulsions contain, by weight of the emulsion: 20%-30% water; 12%-22% glycerin; 10%-20% whey protein products and/or collagen; 0.6%-0.7% TPGS; 35%-43% oil selected from one or more of MCT oil, CLA, cannabidiol (CBD), algal oil, fish oil, canola oil, sunflower oil, and hemp seed oil; and 2%-6% flavors. Other emulsions contain, by weight of the emulsion: 20%-30% water; 12%-22% glycerin; 10%-17% whey protein products and/or collagen; 0.6%-0.7% TPGS; 30%-38% oil selected from one or more of MCT oil, CLA, algal oil, fish oil, canola oil, sunflower oil, and hemp seed oil; 0.2% to 0.5% citric acid; and 1%-5% flavors. Other emulsions contain, by weight of the emulsion: 15%-30% water; 15%-22% glycerin; 10%-17% whey protein products; 0.6%-0.7% TPGS; 28%-40% oil selected from one or more of MCT oil, CLA, algal oil, fish oil, canola oil, sunflower oil, and hemp seed oil; 0.2% to 0.5% citric acid; and 1%-7% flavors. Other emulsions contain, by weight of the emulsion: 15%-30% water; 10%-15% glycerin; 10%-30% nut butter and/or collagen; 0.6%-0.7% TPGS; 20%-30% oil selected from one or more of MCT oil, CLA, algal oil, fish oil, canola oil, sunflower oil, and hemp seed oil; 1%-10% other active ingredient; and 1%-7% flavors. Other emulsions contain, by weight of the emulsion: 15%-30% water; 10%-25% glycerin; 10%-17% nut butter; 0.6%-0.7% TPGS; 35%-50% oil selected from one or more of MCT oil, CLA, algal oil, fish oil, canola oil, sunflower oil, and hemp seed oil; 2%-15% other active ingredient; and 1%-7% flavors. Other emulsions contain, by weight of the emulsion: 10%-15% water; 1%-5% glycerin; 15%-25% nut butter; 0.6%-0.7% TPGS; 35%-50% oil selected from one or more of MCT oil, CLA, algal oil, fish oil, canola oil, sunflower oil, and hemp seed oil; 2%-10% other active ingredient; and 1%-7% flavors. Other emulsions contain, by weight of the emulsion: 30%-40% water; 15%-25% glycerin; 5%-15% nut butter; 0.6%-0.7% TPGS; 20%-30% oil selected from one or more of MCT oil, CLA, algal oil, fish oil, canola oil, sunflower oil, and hemp seed oil; 2%-10% other active ingredient; and 1%-7% flavors. In these emulsions, the protein composition can be a mixture of whey protein and nut butter or a mixture of whey protein, nut butter and collagen. For example, the protein composition can contain a nut butter, wherein the nut butter is selected from one or more of almond, pecan, pistachio, walnut, Brazil nut, peanut, hazelnut, and cashew nut butter.

The emulsions herein can additionally contain up to about 1%, 2%, 3%, by weight, of a bicarbonate. They also can contain up to 1%-10%, or 0.5%-2%, or 1% to 3%, or 1% to 7%, by weight, of a flavoring or a mixture thereof. Flavors include, for example: vanilla, chocolate, churros, cinnamon, brownie, caramel, strawberry, grapefruit, pink grapefruit, tangerine, raspberry, blueberry, mango, peach, graham cracker, banana, Caramel Coffee, French toast, Strawberry French Toast, s'mores, tangerine, almond raspberry, peaches, peaches and cream, blueberries and cream, and pecan. The emulsions can contain about 0.1% or 0.2% or 0.3%-10%, by weight, flavoring(s) selected from among vanilla, chocolate, churros, cinnamon, brownie, caramel, strawberry, grapefruit, pink grapefruit, tangerine, raspberry, blueberry, mango, peach, graham cracker, banana, Caramel Coffee, French toast, Strawberry French Toast, s'mores, tangerine, almond raspberry, peaches, peaches and cream, blueberries and cream, and pecan.

Other exemplary emulsions provided herein are oil-in-water emulsions, comprising: a polar protic solvent, and: a) a nut butter or protein composition in an amount of at least 25%, by weight of the emulsion; b) less than about 1%, by weight, of polyalkylene glycol derivative of vitamin E; and c) at least 11% up to about or at 40%, by weight, of one or more oils, wherein the oils are present in the emulsion as droplets having a mean median particle size of greater than 5 μm but less about 10 μm or less than 15 μm. The oils, polyalkylene glycol derivative of vitamin E and nut butter and protein composition are as defined and described above, and also below. The oils are as described above, and also below. For examples, the oils can contain CBD oil or hemp oil, generally in an amount between 0.1 and 3%, by weight of the composition. The CBD oil can be provided in as 60% CBD oil, as described in the examples and below. The polar protic solvent can be water, glycerin or a mixture thereof, such as, for example in an amount that is at least 15% or 17% by weight of the emulsion, or in an amount that is at least 20% by weight of the emulsion. The amount of nut butter or protein composition can be at up to 30%, 35%, 45% or 50% by weight of the emulsion. The polyalkylene glycol derivative of vitamin E is a PEG-derivative of vitamin E, including the high dimer mixtures as defined above. The polyalkylene glycol derivative of vitamin E can be tocopheryl polyethylene glycol succinate (“TPGS”) or a derivative thereof. The emulsions can contain 0.6% to 0.7%, by weight, TPGS, such as about 0.66-0.68% TPGS by weight. The polyalkylene glycol derivative of vitamin E, such as TPGS, can be polyalkylene glycol moiety-free, such as PEG free. The polyalkylene glycol derivative of vitamin E can be a high dimer mixture that comprises at least 13 wt % water-soluble dimer and up to 87% monomer. As described above, the polyalkylene glycol derivative of vitamin E can contain up to 75%, 70%, 69%, 62%, 55%, 50%, 45%, 40%, or 35% dimer or 29%-69%, inclusive, of dimer; and/or contains less than 70%, 65%, 63%, 62%, or 61% of the monomer. It can be TPGS mixture that contains up to 75%, 70%, 69%, 62%, 55%, 50%, 45%, 40%, or 35% dimer or 29%-69%, inclusive, of dimer; and/or contains less than 70%, 65%, 63%, 62%, 61% of the monomer. In the high dimer polyalkylene glycol derivative of vitamin E mixtures, such as high dimer TPGS, the amount of dimer can greater than 29% and the total amount of dimer and monomer in the polyalkylene glycol derivative of vitamin E mixture can be greater than 95%, 96%, 97%, 98%, or 99%. Other exemplary emulsions provided herein can contain a pH adjuster. Other exemplary emulsions provided herein can contain citric acid.

Provided are methods of making the emulsions provided herein. The methods include the steps of: a) mixing and heating the ingredients in a vessel; b) homogenizing the ingredients; and c) cooling the mixed ingredients to produce the emulsion. For example, the oil-in-water emulsion can be produced by combining one or more polar protic solvents in an amount between about 13% and 50%, by weight, of the emulsion; a protein composition selected from one or more of a nut butter, whey protein, and hydrolyzed collagen, in an amount between about 12% and 45% by weight, such as between about 8% and 45% by weight, of the emulsion, wherein: the whey protein is an 80% whey protein concentrate or 90% whey protein isolate; the nut butter is prepared from nuts or seeds that contain about 10% to 35% protein, by weight, and about 30% to 70% fat, by weight; one or more edible oils in an amount between about 10% to about 40%, by weight; and a surfactant, wherein the amount of surfactant is between 0.5% up to less than 2%, or 0.5% up to 1.5%, whereby the resulting emulsion comprises particles with a diameter between about 5 μm and 10 μm, or have an average particle size between about 5 μm and 10 μm, or between about 5 μm and 15 μm or a diameter between about 5 μm and 15 μm.

Methods include providing a first mixture, where: the first mixture comprises one or more polar protic solvents in an amount between about 13% and 50%, by weight, of the emulsion; the first mixture comprises a protein composition selected from one or more of a nut butter, whey protein, and hydrolyzed collagen, in an amount between about 12% and 45%, by weight, of the emulsion; and a second mixture where: the second mixture comprises one or more edible oils in an amount between about 10% to about 40%, by weight; and the second mixture comprises less than about less than about 1%, by weight, of polyalkylene glycol derivative of vitamin E; and combining the first mixture with the second mixture under high-shear conditions to form an emulsion of the non-polar compound or mixture of non-polar compounds, whereby the non-polar compounds or mixture thereof are present in the emulsion comprising particles with a diameter between about 5 μm and 15 μm, or have an average particle size between about 5 μm and 15 μm.

### DETAILED DESCRIPTION

### Outline

A. Definitions
B. Overview of the Emulsions and Uses
C. Protein compositions
   1. Nut Butters
   2. Whey Proteins
   3. Collagens
D. Surfactants
   1. Polyalkylene Derivatives of Vitamin E
      i. Tocopherols and Tocotrienols
      ii. Linkers
      iii. PEG Moieties
      iv. Tocopheryl Polyalkylene Glycol Derivatives
         a. Synthesis
         b. Water-Soluble Vitamin E Derivative Mixtures (Compositions)
      v. Methods for Making Water-Soluble Vitamin E Derivatives
         a. Reaction Mixture
            i. Vitamin E Succinate
            ii. Polyethylene glycol
            iii. Catalyst
            iv. Solvent
            v. Exemplary reaction mixtures
            vi. Exemplary methods
            a. Preparation of a crude water-soluble vitamin E derivative mixture
            b. Processing the Reaction Mixture to Obtain a Crude Water-Soluble Vitamin E Derivative Mixture
            c. Purification of the Crude Water-Soluble Vitamin E Derivative Mixture to Obtain a Purified High Dimer-Containing Water-Soluble Vitamin E Derivative Mixture
   2. PEG-Free PEG-derivatives of vitamin E
   3. Other Surfactants
E. Oils
F. Non-Polar Compounds
   1. Polyunsaturated Fatty Acid (PUFA)-Containing Non-Polar Compounds
      a. Omega-3 Fatty Acid Compounds
         i. DHA/EPA
         ii. Fish Oils
         iii. Algae Oil
         iv. Flaxseed Oil—Omega 3 (ALA)
      b. Omega-6 Compounds
      c. Saw Palmetto Extract
      d. Conjugated Linoleic Acid (CLA)
   2. Phytochemical-Containing Non-Polar Compounds
      a. Phytosterols
      b. Flavonoids
   3. Micronutrient-Containing Compounds
      a. Vitamins
   4. Alkaloids
   5. Cannabinoids
   6. Hops-Containing Compounds
   7. Antioxidants
   8. Coenzyme Q Compounds
   9. Carotenoid-Containing Compounds
      a. Carotenes
      b. Xanthophylls
   10. Boswellia Extracts
   11. Phospholipids
G. Preservatives and Sterilizers
H. Polar Protic Solvents
I. Optional Ingredients
J. Exemplary Methods for Preparing the Emulsions
K. EXAMPLES

### A. DEFINITIONS

Unless defined otherwise, all technical and scientific terms used herein have the same meaning as is commonly understood by one of skill in the art to which the invention(s) belong. All patents, patent applications, published applications and publications, GenBank sequences, websites and other published materials referred to throughout the entire disclosure herein, unless noted otherwise, are incorporated by reference in their entirety. In the event that there are a plurality of definitions for terms herein, those in this section prevail. Where reference is made to a URL or other such identifier or address, it is understood that such identifiers can change and particular information on the internet can come and go, but equivalent information can be found by searching the internet Reference thereto evidences the availability and public dissemination of such information.

As used herein, nuts refer to the culinary definition of nut, and include seeds. A nut is a fruit composed of an inedible hard shell and an edible seed.

As used herein, a nut butter refers to a pasty product produced by grinding or otherwise pulverizing nuts. Nut butters can be prepared by roasting and blanching raw nuts and then grinding them. For example, almond butter added to the water/glycerin phase, such as described in the Examples, is produced only with dry roasted almonds with no other added ingredients. The almond butter also can be formed, for example, using raw almonds. Almond butter can be generated by grinding raw or roasted almonds with a food processor, or mashing or blending. Other nut butters are similarly prepared. The resulting nut butter product is a pasty material, which is a mixture of nut particles and oil that is released from the cellular structure of the nuts during the grinding operation. For purposes herein, the nuts for use in nut butters are those that contain about 10% to 35% protein, by weight, and about 30% to 70% fat, by weight. These include, but are not limited to, almonds, pecans, pistachios, walnuts, Brazil nuts, peanuts, hazelnuts, and cashews.

As used herein, “water activity” is the partial vapor pressure of water in a substance divided by the standard state partial vapor pressure of water. With respect to foods, the standard state can be defined as the partial vapor pressure of pure water at the same temperature. In accord with this definition, pure distilled water has a water activity of exactly one. Compositions with higher water activity tend to support growth of more microorganisms. Bacteria usually require at least about 0.91. Hence, it is desirable to have lower water activity or have conditions, such a lower pH, to prevent or reduce the risk of microbial growth.

As used herein, a “PEG derivative of vitamin E” or “vitamin E-PEG conjugate” or “vitamin E-PEG derivative,” is a compound containing one or more vitamin E moieties (e.g., a tocopherol or tocotrienol) joined by a covalent bond, for example, an ester, ether, amide or thioester bond, to one or more polyethylene glycol (PEG) moieties, via a linker, such as a dicarboxylic or tricarboxylic acid. Exemplary of PEG derivatives of vitamin E are D-α-tocopheryl polyethylene glycol succinate (TPGS), TPGS analogs, TPGS homologs and TPGS derivatives.

As used herein, “tocopheryl polyethylene glycol succinate,” “TPGS,” “tocopheryl polyethylene glycol succinate surfactant” and “TPGS surfactant” refer to tocopheryl polyethylene glycol conjugates that are formed by covalently joining tocopherol succinate, an ester formed through esterification of tocopherol and succinic acid, to a polyethylene glycol (PEG) moiety via an esterification reaction. The PEG moiety of the TPGS surfactant can be any PEG moiety, for example, a PEG moiety with a molecular weight of between or between about 200 Da and 20,000 Da or about 20,000 Da, for example, PEG moieties having a molecular weight of or about 200, 300, 400, 500, 600, 800, 1000, 3000, 5000, 6000, 8000, 10,000, 20,000 Da, or more; or PEG analogs, including, for example, PEG-NHS (N-hydroxysuccinimide), PEG-aldehyde, PEG-SH, PEG-NH₂, PEG-CO₂H, and branched PEGs.

Exemplary of a TPGS surfactant is TPGS-1000, which has a PEG moiety with a molecular weight of 1000 Da. The TPGS can be any natural, water-soluble, tocopherol polyethylene glycol succinate, for example, the food grade TPGS sold under the name Eastman Vitamin E TPGS®, food grade, by Eastman Chemical Company, Kingsport, Tenn. This TPGS is a water-soluble form of natural-source vitamin E, which is prepared by esterifying the carboxyl group of crystalline d-alpha-tocopheryl acid succinate with polyethylene glycol 1000 (PEG 1000), and contains between 260 and 300 mg/g total tocopherol. TPGS typically has a reported HLB value of between 12 or 13 or about 12 or 13 and 18 or about 18.

As used herein, “analog” refers to a chemical compound that is structurally similar to another compound (referred to as a parent compound), but differs slightly in composition, for example, due to the variation, addition or removal of an atom, one or more units (e.g., methylene units, —(CH₂)ₙ—) or one or more functional groups. The analog can have different chemical or physical properties compared with the original compound and/or can have improved biological and/or chemical activity. Alternatively, the analog can have similar or identical chemical or physical properties compared with the original compound and/or can have similar or identical biological and/or chemical activity. For example, the analog can be more hydrophilic or it can have altered reactivity as compared to the parent compound. The analog can mimic the chemical and/or biological activity of the parent compound (i.e., it can have similar or identical activity), or, in some cases, can have increased or decreased activity. The analog can be a naturally or non-naturally occurring (e.g., synthetic) variant of the original compound. Other types of analogs include isomers (e.g., enantiomers, diastereomers) and other types of chiral variants of a compound, as well as structural isomers. The analog can be a branched or cyclic variant of a linear compound. For example, a linear compound can have an analog that is branched or otherwise substituted to impart certain advantageous properties (e.g., improved hydrophobicity or bioavailability). Exemplary of the analogs used in the provided compositions and methods are TPGS analogs, which can be formed using the methods provided herein and can be used in place of TPGS in the provided compositions.

As used herein, “tocopheryl polyethylene glycol succinate analog” or “TPGS analog” refers to compounds, other than TPGS, that are similar to a parent TPGS compound, but differ slightly in composition, for example, by the variation, addition or removal of an atom, one or more units (e.g., methylene units, —(CH₂)ₙ—), or one or more functional groups. TPGS analogs include vitamin E-derived surfactants, e.g., tocopheryls and tocotrienols, including PEG derivatives of vitamin E, including vitamin E PEG monomers and dimers, such as, but not limited to, tocopheryl polyethylene glycol sebacate (PTS), tocopheryl polyethylene glycol dodecanodioate (PTD), tocopheryl polyethylene glycol suberate (PTSr), tocopheryl polyethylene glycol azelaate (PTAz), and polyoxyethanyl tocotrienyl sebacate (PTrienS), as well as other PEG derivatives of vitamin E. The compositions provided herein include at least 13%, typically more than 29%, such as 29%-55% or 30%-52%, dimer form in the composition, with the rest of the composition the monomer form or small amounts of other forms and trace contaminants.

Exemplary of TPGS analogs are compounds having the formula shown in Formula I:

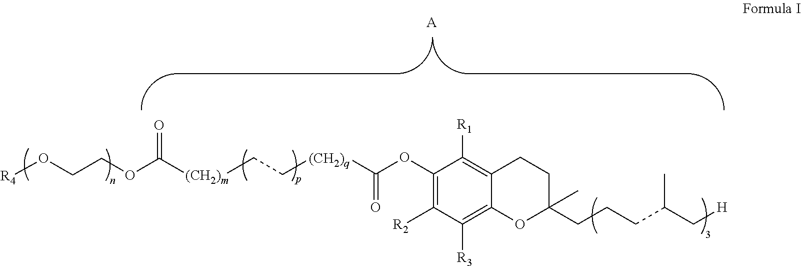

where R₁, R₂ and R₃ each independently is hydrogen (H) or methyl (CH₃); R₄ is H, CH₃ or the portion marked “A”; each dashed line (-----) is independently a single or double bond; n is an integer from 1 to 5000; m and q each independently are 0 or 1; and p is an integer from 1 to 20.

As used herein, “TPGS 1000 analogs” are compounds other than TPGS 1000 that are similar to a parent TPGS 1000 compound due to the addition or removal of an atom, one or more units (e.g., methylene units —(CH₂)ₙ—), or one or more functional groups. TPGS 1000 analogs include, but are not limited to, TPGS compounds having one or more PEG moieties that vary in chain length and molecular weight compared to TPGS 1000, including, for example, TPGS compounds having PEG moieties having a molecular weight between or about between 200 Da to 20,000 Da or about 20,000 Da, for example, PEG moieties having a molecular weight of or about 200, 300, 400, 500, 600, 800, 1000, 3000, 5000, 6000, 8000, 10,000, 20,000 Da, or more. Also exemplary of TPGS 1000 analogs are TPGS compounds including PEG analogs, e.g., PEG-NHS, PEG-aldehyde, PEG-SH, PEG-NH₂, PEG-CO₂H, and branched PEGs. Also exemplary of TPGS 1000 analogs are any TPGS analogs, e.g., vitamin E-derived surfactants, including PEG derivatives of vitamin E, including but not limited to, tocopheryl polyethylene glycol sebacate (PTS), tocopheryl polyethylene glycol dodecanodioate (PTD), tocopheryl polyethylene glycol suberate (PTSr), tocopheryl polyethylene glycol azelaate (PTAz) and polyoxyethanyl tocotrienyl sebacate (PTrienS), as well as other PEG derivatives of vitamin E.

As used herein, “homolog” refers to an analog that differs from the parent compound only by the presence or absence of a simple unit, such as a methylene unit, or some multiple of such units, e.g., —(CH₂)ₙ—. Typically, a homolog has similar chemical and physical properties as the parent compound. Exemplary of the homologs used in the provided compositions and methods are TPGS homologs.

As used herein, “TPGS homologs” are analogs of TPGS that differ from a TPGS parent compound only by the presence or absence of a simple unit, such as a methylene unit, or some multiple of such units, e.g., —(CH₂)ₙ—. Typically, suitable TPGS homologs have similar surfactant properties compared to the parent compound (TPGS), for example, similar HLB values, for example, HLB values between 12 or about 12 and 20 or about 20. Exemplary of TPGS homologs are tocopheryl polyethylene glycol sebacate (PTS), tocopheryl polyethylene glycol dodecanodioate (PTD), tocopheryl polyethylene glycol suberate (PTSr), tocopheryl polyethylene glycol azelaate (PTAz). Exemplary of TPGS homologs are compounds having the formula in Formula I (above), where neither of the dashed lines represent a double bond and where, when m and q both are 0, p is greater than 1.

As used herein, “TPGS 1000 homologs” are analogs of TPGS 1000 that differ from a TPGS 1000 parent compound only by the presence or absence of a simple unit, such as a methylene unit, or some multiple of such units, e.g., —(CH₂)ₙ—. Suitable TPGS 1000 homologs have similar surfactant properties compared to the parent compound (TPGS 1000), for example, similar HLB values, for example, HLB values between 12 or about 12 and 20 or about 20, such as 13-18. TPGS 1000 homologs include TPGS 1000 homologs with slight variations in the length of the PEG chain moiety.

As used herein, a “concentrate,” is a composition that generally is formulated for dilution, rather than direct ingestion, or for direct ingestion in a small quantity, such as in a capsule.

As used herein, “vitamin E” refers to any naturally occurring or synthetic form of vitamin E, for example, tocopherols and tocotrienols, and can refer to a single form of the compound or a mixture of forms.

As used herein, “water-soluble vitamin E derivative composition,” “water-soluble vitamin E derivative,” “water-soluble vitamin E derivative surfactant,” “water-soluble vitamin E surfactant,” and “water-soluble derivative of vitamin E mixture,” which are to be used interchangeably, refer to compositions that contain mixtures of water-soluble forms of vitamin E (vitamin E derivatized with moieties, such as polyalkylene glycol, such as polyethylene glycol, that increase the water solubility of the water-insoluble vitamin E). A “polyalkylene glycol derivative of vitamin E” is thus a water-soluble vitamin E derivative composition that contains a mixture of water-soluble forms of vitamin E and is derivatized with a polyalkylene glycol moiety.

The mixtures can contain dimers and monomers of the vitamin E derivatives. The water-soluble vitamin E derivative mixtures (compositions) include vitamin E (natural or synthetic forms of vitamin E), such as tocopherol derivatives and tocotrienol derivatives. Generally, vitamin E derivative mixtures contain predominantly or primarily monomer forms. Derivatives of vitamin E, such as polyethylene glycol (PEG) derivatives previously produced, are manufactured to contain as much monomer form as possible, and to contain minimal amounts of any dimer form (see, e.g., Christiansen et al. (2011) J. Pharm. Sci. 100(5):1773-1782). All are intended to be included in the compositions herein.

In contrast, “high dimer-containing” (or “high dimer”) vitamin E derivative mixtures, such as PEG derivative of vitamin E compositions (also referred to herein as high dimer PEG derivatives of vitamin E mixtures) can be employed herein. These mixtures are manufactured to contain dimer forms, and they contain at least 13%, particularly at least or at least about 20%, 25%, 29%, or more, of the dimer form of the water-soluble vitamin E derivative. In particular, the water-soluble vitamin E derivative mixtures (compositions) are manufactured to contain between or between about 13 wt % and about or up to 95%, 90%, 85%, 80%, or 75 wt %, particularly at least 29% to 75% or 80%, inclusive, of the water-soluble vitamin E dimer form. In general, the high dimer-containing vitamin E derivative mixtures, such as PEG derivatives of vitamin E mixtures, such as a high dimer-containing TPGS composition, contain 30% to 60%, particularly 35% to 52%, dimer, and the remainder is the monomer form and other trace components, such as unreacted reagents, such as vitamin E and the hydrophilic derivatizing moiety.

In general, for the high dimer-containing vitamin E derivative mixtures, the mixtures contain at least 13% of the dimer form and up to 87% monomer form, in particular, at least 25% of the dimer form and up to 70% of the monomer form, such as between or between about 25 wt % and 69%, inclusive, of the monomer. Hence, the water-soluble vitamin E derivative mixtures (compositions) (high dimer-containing compositions) contain a substantial amount (i.e., 13% or more, particularly 25%, 29%, 35%, 48%, 52%, or more) of the dimer form compared to commercially available forms that are manufactured to provide the monomer form.

As manufactured, the high dimer-containing vitamin E derivative mixtures can include other forms and unreacted components, hence the total amount of dimer and monomer do not necessarily total 100%, by weight, of the composition. It is shown herein that inclusion of at least 13%, 20%, 25%, 29%, or more of the dimer form, and some monomer form, about less than 87%, 69%, 65%, 60%, 55%, or 50% of the monomer with at least 13% dimer, confers advantageous properties on these water-soluble vitamin E derivative mixtures (compositions) not possessed by such compositions that contain lower amounts of the dimer form.

Examples of water-soluble vitamin E derivatives are those formed by covalently attaching a vitamin E moiety, e.g., a tocopherol or tocotrienol, to a hydrophilic moiety, for example, an alkylene glycol, such as a polyethylene glycol (PEG) moiety, via a linker. The compositions include those that are commercially available, manufactured to maximize the concentration of monomer (such as those sold by Eastman), and those that are manufactured so that the resulting water-soluble vitamin E derivative mixtures (compositions) include a mixture of monomers and dimers of the water-soluble vitamin E derivatives (see, e.g., U.S. patent application Ser. No. 14/207,310, and International Application No. PCT/US2014/025006, now published as US-2014-0271593-A1 and WO 2014/151109, respectively, which describe such mixtures), and contain a substantial amount (compared to prior art preparations), i.e., 13% to 95%, inclusive, such as at least 13%, 20%, 25%, or 29%, up to as much as 75%, 80%, 85%, 90%, or 95%, by weight, of the dimer form and generally less than 70%, 65%, 63%, 62%, 61% or 60%, or less, of the monomer form. Water-soluble vitamin E derivative mixtures (compositions) include, for example, polyalkylene glycol derivatives of tocopherol, e.g., polyethylene glycol (PEG) derivatives of tocopherol, and polyalkylene glycol derivatives of tocotrienol, e.g., polyethylene glycol (PEG) derivatives of tocotrienol. The water-soluble vitamin E derivatives can include, for example, polyalkylene glycol derivatives of vitamin E, such as polyethylene glycol derivatives of vitamin E, e.g., vitamin E TPGS (D-α-tocopheryl polyethylene glycol succinate), TPGS analogs, TPGS homologs and TPGS derivatives.

As used herein, “tocopherol” and “tocotrienol” refer to any naturally occurring or synthetic form of vitamin E, and can refer to a single compound or a mixture of tocopherols and tocotrienols. Examples of tocopherols include, for example, α-tocopherol, D-α-tocopherol, β-tocopherol, γ-tocopherol and δ-tocopherol. Examples of tocotrienols include, for example, α-tocotrienol, β-tocotrienol, γ-tocotrienol and δ-tocotrienol.

As used herein, “organoleptic properties” refer to sensory attributes of a food or beverage. Those of skill in the art understand such properties and they can be quantitated if needed. Organoleptic properties include, but are not limited to, taste, odor and/or appearance. Desirable organoleptic properties include those organoleptic properties that make a food or beverage composition desirable for consumption by an average human subject, such as a desirable odor, taste and/or appearance, or the lack of an undesirable odor, taste and/or appearance. Undesirable organoleptic properties include the presence of, for example, an undesirable taste, odor or appearance attribute, such as the presence of an “off-taste” or “off-odor,” for example a fishy, grassy, metal or iron, sharp or tingling taste or odor, or the presence of an undesirable appearance attribute, such as separation or precipitation. In one example, the provided beverage compositions retain the same or about the same taste, odor and/or appearance as the same beverage composition that does not contain the one or more probiotics and/or mucoadhesive, i.e., lactoferrin, that is, the provided beverage compositions retain organoleptic properties desirable for consumption by an average human subject. Desirable and undesirable organoleptic properties can be measured by a variety of methods known to those skilled in the art, including, for example, organoleptic evaluation methods by which undesirable properties are detectable by sight, taste and/or smell and chemical tests, as well as by chemical analytical methods.

As used herein, a “solvent” is an ingredient that can be used to dissolve another ingredient Solvents include polar and non-polar solvents. Non-polar solvents include oils and other non-polar ingredients that dissolve non-polar compounds. Typically, the non-polar solvent is an oil that is included in the emulsion compositions provided herein in addition to the non-polar compound. More than one non-polar solvent can be used. Certain compounds, for example, flaxseed oil and safflower oil, can be non-polar solvents and non-polar active ingredients. Typically, the non-polar solvent contains one or more oils, typically oils other than the non-polar active ingredient or oil(s) not contained in the active ingredient Exemplary non-polar solvents include, but are not limited to, oils (in addition to the non-polar active ingredient), for example, vitamin E oil, flaxseed oil, conjugated linoleic acid (CLA), borage oil, rice bran oil, D-limonene, canola oil, corn oil, MCT (medium chain triglycerides) oil and oat oil. Other oils also can be used.

As used herein, “MCT oil” is comprised of primarily caprylic and capric fatty acids, and is a light-yellow, odorless, translucent liquid at room temperature. MCT oil occurs naturally in coconut oil and other foods.

As used herein, “polar solvent” refers to a solvent that is readily miscible with water and other polar solvents. Polar solvents are well-known and can be identified by measuring any parameter known to those of skill in the art to identify them, including dielectric constant, polarity index and dipole moment (see, e.g., Przybitek (1980) “High Purity Solvent Guide,” Burdick and Jackson Laboratories, Inc.). For example, polar solvents generally have high dielectric constants, such as greater than or about 15, generally have high polarity indices, typically greater than or about 3, and generally large dipole moments, for example, greater than or about 1.4 Debye. Polar solvents include polar protic solvents and polar aprotic solvents.

As used herein, a “polar protic solvent” is a solvent containing a hydrogen atom attached to an electronegative atom, such that the hydrogen has a proton-like character and/or the bond between the hydrogen and electronegative atom is polarized.

Exemplary polar protic solvents include, but are not limited to, water, alcohols, including monohydric, dihydric and trihydric alcohols, including, but not limited to, water, ethanol, glycerin and propylene glycol. For use herein, the polar protic solvent must be non-toxic so that it can be consumed by a human.

As used herein, “biologically compatible substance” refers to a substance that, when administered to a subject, such as a human, does not produce undesired or toxic effects.

As used herein, “an agent” is any substance that can be delivered via compositions provided herein to a mucosal surface of a subject Generally for purposes herein, the agent is one that is susceptible to degradation in the presence of water or is unstable in the presence of water or moisture.

As used herein, “a biologically active agent,” “a biological agent,” or “an agent” is any substance which when introduced into the body causes a desired biological response, such as altering body function at the cellular, tissue or organ level and/or altering cosmetic appearance. Such substance can be any synthetic or natural element or compound, protein, cell, or tissue including a pharmaceutical, drug, therapeutic, nutritional supplement, herb, hormone, or the like, or any combinations thereof. The terms also encompass pharmaceutically acceptable, pharmacologically active derivatives of those active agents specifically mentioned herein, including, but not limited to, salts, esters, amides, prodrugs, active metabolites, isomers, fragments and analogs. When the terms “biologically active agent,” “biological agent” and “agent” are used, then, or when an active agent is specifically identified, it is intended to include the active agent per se as well as pharmaceutically acceptable, pharmacologically active salts, esters, amides, prodrugs, active metabolites, isomers, fragments and analogs.

As used herein, a “subject” is defined as an animal, including a mammal, typically a human.

As used herein, “emulsion” refers to a colloidal dispersion of two immiscible liquids, for example, an oil and water (or other aqueous liquid, e.g., a polar solvent), one of which is part of a continuous phase and the other of which is part of a dispersed phase. Emulsions typically are stabilized by one or more surfactants and/or co-surfactants and/or emulsion stabilizers. Surfactants form an interfacial film between the oil and water phase of the emulsion, providing stability. Typically, emulsions contain micelles that contain one or more surfactants surrounding a non-polar compound which is dispersed in the water phase. In general, emulsions (e.g., oil-in-water emulsions) are colloidal dispersions of two immiscible liquids (e.g., oil and an aqueous liquid, such as water) that contain a continuous and a dispersed phase.

Emulsions can be used to disperse non-polar compounds in aqueous liquids. In an oil-in-water emulsion, the dispersed phase is an oil phase and the continuous phase is an aqueous (e.g., water) phase.

As used herein, “surfactants” (or “surface-active agents”) are chemical or naturally occurring entities that, when dissolved in an aqueous solution, reduce the surface tension of the solution or the interfacial tension between the aqueous phase and the oil phase, to form a stable oil in polar protic solvent, other than water, or polar protic solvent, other than water, in oil emulsion. The surfactant molecules are amphiphilic and contain hydrophilic head groups and hydrophobic tails. The surfactant molecules form various macro-molecular structures in an emulsion, such as micelles, inverse micelles, lipid bilayers (liposomes) and cubosomes. The exact macromolecular structure formed depends on the relative sizes of the hydrophilic and hydrophobic regions of the surface active molecules.

As used herein, “viscosity” refers to a physical property of fluids that determines the internal resistance to shear forces and is expressed in centipoise (cp).

As used herein, “medium chain” represents a hydrocarbon chain of C8 to C12 and short chain is a hydrocarbon chain of less than C8 and long chain means a hydrocarbon chain of more than C12. The polar protic solvent, other than water, phase in the emulsion can be water, aqueous solutions, alcohols and alcohol solutions.

As used herein, the stability of a composition provided herein refers to the length of time at a given temperature the emulsion is stable, and/or that greater than 10%, 20%, 30%, 40%, 50%, 60%, 70%, 80%, 85%, 90%, 91%, 92%, 93%, 94%, 95%, 96%, 97%, 98% or 99% of the initial amount of the agent to be delivered, e.g., cannabidiol (CBD) oil or fish oil, is present in the composition. Thus, for example, a composition that is stable for 30 days at 25° C. would have greater than 10%, 20%, 30%, 40%, 50%, 60%, 70%, 80%, 85%, 90% 91%, 92%, 93%, 94%, 95%, 96%, 97%, 98% or 99% of the initial amount of active ingredient present in the composition at 30 days following storage at 25° C.

As used herein, “surfactant” refers to synthetic and naturally occurring amphiphilic molecules that have hydrophobic portion(s) and hydrophilic portion(s). Due to their amphiphilic (amphipathic) nature, surfactants typically can reduce the surface tension between two immiscible liquids, for example, the oil and water phases in an emulsion, stabilizing the emulsion. Surfactants can be characterized based on their relative hydrophobicity and/or hydrophilicity. For example, relatively lipophilic surfactants are more soluble in fats, oils and waxes, and typically have HLB values less than or about 10, while relatively hydrophilic surfactants are more soluble in aqueous compositions, for example, water, and typically have HLB values greater than or about 10. Relatively amphiphilic surfactants are soluble in oil- and water-based liquids and typically have HLB values close to 10 or about 10.

As used herein, “co-surfactant” refers to a surfactant that is used in the provided compositions in combination with the primary surfactant, for example, the water-soluble vitamin E derivative mixtures (compositions) described herein, for example, to improve the emulsification of the provided compositions and/or compounds, for example, to emulsify the ingredients. In one example, the provided compositions can contain at least one surfactant and at least one co-surfactant Typically, the co-surfactant represents a lower percent, by weight (w/w), of the provided compositions, compared to the surfactant. Thus, the provided compositions typically have a lower concentration of the co-surfactant(s) than of the surfactant.

As used herein, “HLB” refers to a value that is used to index and describe a surfactant according to its relative hydrophobicity/hydrophilicity, relative to other surfactants. A surfactant's HLB value is an indication of the molecular balance of the hydrophobic and hydrophilic portions of the surfactant, which is an amphipathic molecule. Each surfactant and mixture of surfactants (and/or co-surfactants) has an HLB value that is a numerical representation of the relative weight percent of hydrophobic and hydrophilic portions of the surfactant molecule(s). HLB values are derived from a semi-empirical formula. The relative weight percentages of the hydrophobic and hydrophilic groups are indicative of surfactant properties, including the molecular structure, for example, the types of aggregates the surfactants form and the solubility of the surfactant. See, for example, Griffin (1949) J. Soc. Cos. Chem. 1:311. Surfactant HLB values range from 1-45, while the range for non-ionic surfactants typically is from 1-20. The more lipophilic a surfactant is, the lower its HLB value. Conversely, the more hydrophilic a surfactant is, the higher its HLB value.

As used herein, “micelle” refers to aggregates formed by surfactants that typically form when a surfactant is present in an aqueous composition, typically when the surfactant is used at a concentration above the critical micelle concentration (CMC). In micelles, the hydrophilic portions of the surfactant molecules contact the aqueous or the water phase, while the hydrophobic portions form the core of the micelle, which can encapsulate non-polar ingredient(s), for example, cannabidiol (CBD) oil or fish oil.

As used herein, “shelf life” refers to a time period within which the provided compositions retain desirable organoleptic properties, for example, the ability of the provided compositions to retain desirable organoleptic properties for a period of time, for example, for at least or more than 1, 2, 3, 4, or more weeks, typically at least or more than 1, 2, 3, 4, 5, 6, 7, 8, 9, 10, 11, 12, or more months, or at least or more than 1, 2, 3, 4, or more years. In one example, the compositions retain desirable organoleptic properties if they exhibit one or more of these described characteristics, over time, when kept at a particular temperature. In one example, the compositions retain desirable organoleptic properties at room temperature, for example, 25° C. or about 25° C. In another example, the compositions retain desirable organoleptic properties at between 19° C. and 25° C. In another example, the compositions retain desirable organoleptic properties at refrigerated temperatures, for example, 4° C. or about 4° C., or at frozen temperatures, for example, at −20° C. or about −20° C. In another example, the compositions retain desirable organoleptic properties at elevated temperatures, for example, at 40° C. or at about 40° C.

As used herein, “room temperature” and “ambient temperature” are used to describe a temperature that is common in one or more enclosed spaces in which human beings typically are or reside. Room temperature can vary, but generally refers to temperatures between or between about 19° C. and 25° Celsius with an average of 23° C. When a composition is stored at room temperature, it should be understood it is generally kept at a temperature within this range or about within this range.

As used herein, “refrigerated temperature” refers to a temperature that is common in a refrigerator, for example, a household or restaurant refrigerator, for example, a temperature that is cooler than room temperature, but typically a few degrees above the freezing point of water. Typically, refrigerated temperatures are between or between about 0° C. and 10° C., for example, at or about 4° C. When a composition is stored at a refrigerated temperature, it should be understood that it is kept at a temperature common to household or industrial refrigerators.

As used herein, “hydrophilic” and “polar” refer synonymously to ingredients and/or compounds having greater solubility in aqueous liquids, for example, water, than in fats, oils and/or organic solvents (e.g., methanol, ethanol, ethyl ether, acetone and benzene).

As used herein, “food and beverage product” refers to a product that is suitable for human consumption. For example, “food and beverage product” can refer to a emulsion that is dissolved in a solvent, typically an aqueous solvent, e.g., water, to form a beverage composition or beverage product. “Food and beverage product” can also refer to the final product that is suitable for human consumption.

As used herein, “fatty acid” refers to straight-chain hydrocarbon molecules with a carboxyl (—COOH) group at one end of the chain.

As used herein, “polyunsaturated fatty acid” and “PUFA” are used synonymously to refer to fatty acids that contain more than one carbon-carbon double bonds in the carbon chain of the fatty acid. PUFAs, particularly essential fatty acids, are useful as dietary supplements.

As used herein, “essential fatty acids” are PUFAs that mammals, including humans, cannot synthesize using any known chemical pathway. Thus, essential fatty acids must be obtained from diet or by supplementation. Exemplary of essential PUFA fatty acids are the omega-3 (ω3; n-3) fatty acids and omega-6 (ω-6; n-6) fatty acids.

As used herein, “omega-3 (ω-3; n-3) fatty acids” and “omega-3 fatty acids” are used synonymously to describe methylene-interrupted polyenes which have two or more cis double bonds separated by a single methylene group, in which the first double bond appears at the third carbon from the last (ω) carbon. Omega-3 fatty acids are used as dietary supplements, for example, for disease treatment and prevention. The provided emulsions can contain non-polar ingredients that include at least one omega-3 fatty acid. Exemplary of omega-3 fatty acids are alpha-linolenic acid (α-linolenic acid; ALA) (18:3 ω-3) (a short-chain fatty acid); stearidonic acid (18:4 ω-3) (a short-chain fatty acid); eicosapentaenoic acid (EPA) (20:5 ω-3); docosahexaenoic acid (DHA) (22:6 ω-3); eicosatetraenoic acid (24:4 ω-3); docosapentaenoic acid (DPA, clupanodonic acid) (22:5 ω-3); 16:3 ω-3; 24:5 ω-3 and nisinic acid (24:6 ω-3). Longer chain omega-3 fatty acids can be synthesized from ALA (the short-chain omega-3 fatty acid). Exemplary of non-polar ingredients containing omega-3 fatty acids are non-polar ingredients containing DHA and/or EPA, for example, containing fish oil, krill oil and/or algae oil or algal oil, for example, microalgae oil, and non-polar ingredients containing alpha-linolenic acid (ALA), for example, containing flaxseed oil.

As used herein, “omega-6 (ω-6; n-6) fatty acids” and “omega-6 fatty acids” are used synonymously to describe methylene-interrupted polyenes which have two or more cis double bonds separated by a single methylene group, in which the first double bond appears at the sixth carbon from the last (ω) carbon. The emulsions provided herein can contain non-polar ingredients that include at least one omega-6 fatty acid. Exemplary of omega-6 fatty acids are linoleic acid (18:2 ω-6) (a short-chain fatty acid); gamma-linolenic acid (GLA) (18:3 ω-6); dihomo gamma linolenic acid (DGLA) (20:3 ω-6); eicosadienoic acid (20:2 ω-6); arachidonic acid (AA) (20:4 ω-6); docosadienoic acid (22:2 ω-6); adrenic acid (22:4 ω-6); and docosapentaenoic acid (22:5 ω-6). Exemplary of non-polar ingredients containing omega-6 fatty acids are ingredients containing GLA, for example, borage oil. Also exemplary of omega-6-containing non-polar ingredients are ingredients containing conjugated fatty acids, for example, conjugated linoleic acid (CLA) and ingredients containing saw palmetto extract.

As used herein, “algae oil” or “algal oil” refers to any oil derived from marine dinoflagellates in, for example, microalgae, for example, Crypthecodinium sp, particularly, Crypthecodinium cohnii. Algae oil can be used as a non-polar ingredient. The algae oil typically contains DHA. The algae oil can be a source of EPA.

As used herein, “fish oil” refers to any oil derived from any fish, typically a cold water fish, for example, from fish tissue, such as from frozen fish tissue, for example, from cod liver. Fish oil can be used as a non-polar ingredient. The fish oil typically contains DHA. The fish oil also can contain EPA. For example, the fish oil can contain a mixture of DHA and EPA.

As used herein, “flavor” is any ingredient that changes, typically improves, the taste and/or smell of the provided compositions.

As used herein, “G.RAS.” and “GRAS” are used synonymously to refer to compounds, compositions and ingredients that are “Generally Regarded as Safe” by the USDA and FDA for use as additives, for example, in foods, beverages and/or other substance for human consumption, such as any substance that meets the criteria of sections 201(s) and 409 of the U.S. Federal Food, Drug and Cosmetic Act. Typically, the emulsions provided herein are GRAS certified.

As used herein, “kosher” is used to refer to substances that conform to Jewish Kosher dietary laws, for example, substances that do not contain ingredients derived from non-kosher animals or do not contain ingredients that were not made following kosher procedures.

As used herein, “rapid cooling” refers to a process by which a composition is cooled to a desired temperature, for example, between or between about 25° C. and 45° C., in less than or less than about 2 hours, typically less than or less than about 1 hour, for example, less than or less than about 30 minutes, such as 15 minutes.

As used herein, “particle size” and “average particle size” refer synonymously to the average diameter of particles in a provided liquid, for example, the droplet diameter or micelle diameter in an emulsion. Particle size diameter can be expressed in terms of a unit of length, for example, nanometers (nm). Alternatively, information about particles in compositions can be expressed in terms of particle density, for example, ppm (parts per million), or percent solids, in the compositions.

As used herein, “stability” refers to a desirable property of the provided, for example, the ability of the provided emulsions to remain free from one or more changes over a period of time, for example, at least or longer than 1 day, 1 week, 1 month, 1 year, or more. For example, a emulsions can be described as stable if it is formulated such that it remains free from oxidation or substantial oxidation over time, remains clear over time, remains safe and/or desirable for human consumption over time, has a lack of precipitates forming over time, has a lack of ringing over time, and/or does not exhibit any visible phase separation over a period of time. For example, the emulsions can be described as stable if they exhibit one or more of these described characteristics, over time, when kept at a particular temperature, for example, room temperature, e.g., at or about 25° C., slightly below room temperature, e.g., between or between about 19° C. and 25° C., at refrigerated temperatures, e.g., at or about 4° C., or at frozen temperatures, e.g., at or about −20° C. or lower.

As used herein, “phase separation” refers to the physical separation of a homogenous emulsion, for example, the separation of the oil and water phases of an emulsion, into two separate visible heterogeneous layers.

As used herein, “stabilize” means to increase the stability of one of the provided compositions.

As used herein, a “bicarbonate” or “carbonate” refers to a stabilizer or one component of a stabilizing system that, when added to a composition in combination with the other components (i.e., the acid and/or antioxidant) yields compositions that retain one or more desired organoleptic properties, such as, but not limited to, the taste, smell, odor and/or appearance of the beverage composition over time. Typically, bicarbonates or carbonates are food-approved, e.g., edible bicarbonates or carbonates, for example, bicarbonates or carbonates that are safe and/or approved for human consumption. Exemplary bicarbonates include, but are not limited to, potassium bicarbonate and sodium bicarbonate. Exemplary carbonates include, but are not limited to, potassium carbonate, sodium carbonate, calcium carbonate, magnesium carbonate and zinc carbonate.

As used herein, a “pH adjuster” is any compound, typically an acid or a base, that is capable of changing the pH of the emulsions, for example, to reduce or increase the pH, typically without altering other properties of the compositions, or without substantially altering other properties. pH adjusters are well known. Exemplary of the pH adjusters are acids, for example, citric acid and phosphoric acid, and bases. The target pH can be between about 4 and 8, or about 6 and 8.5, such as between about 7 and 8.2, such as neutral pH around 7-7.4. It is shown herein that lower pH can increase the stability of the result compositions, in such embodiment the pH is between about 4.6 and 6, such as pH of at or about 4.7 to 5.6 up to 6. The pH can be adjusted, such as by addition of an edible acid, such as citric acid. In other such embodiments, the pH is lower by virtue of the components, such natural flavors or flavors or juice, such as citrus.

As used herein, “vessel” refers to any container, for example, any tank, pot, vial, flask, cylinder or beaker that can be used to contain the ingredients and/or phases of the compositions during the methods for making the compositions. The vessel can be a tank that is used to mix and/or heat one or more ingredients and/or phases of the composition, for example, the water phase tanks and oil phase tanks, such as during the provided scaled-up methods. The oil and the water phases can be mixed and heated in separate tanks before combining the phases to form an emulsion. The tank can be a packaging or holding tank, which holds the provided compositions after forming the compositions, for example, the emulsions. A number of tanks are available for mixing ingredients. Typically, the tanks are cleaned, for example, rinsed, soaped and/or sanitized according to known procedures prior to use and between uses. The tanks can be equipped with one or more mixers, for example, a standard mixer and/or homogenizer, which are used to mix the ingredients added to the tank. The tank can be equipped with a heating and/or cooling device. For example, the tank can be a water-jacketed tank. The temperature of the water-jacketed tank is controlled through the water-jacket, for example, to heat the contents, for example, while mixing.

As used herein, a “water phase vessel” refers to a vessel used to mix and/or heat the water phase ingredients to generate the water phase of the provided compositions. The water phase vessel can be a tank. The tank can be a water-jacketed tank, which is a tank equipped with a water jacket that can be used to heat the contents of the tank.

As used herein, an “oil phase vessel” refers to a vessel used to mix and/or heat the oil phase ingredients to generate the oil phase of the provided compositions. The oil phase vessel can be an oil phase tank. The tank can be a water-jacketed tank.

As used herein, “transfer device” refers to any equipment, combination of equipment and/or system that can be used to transfer liquid, for example, from one tank to another tank, in the provided methods for making the emulsion compositions. Exemplary of the transfer devices is a transfer pump and appropriate fittings, for example, sanitary fittings, ball valves and transfer hoses, for example, food grade hoses.

As used herein a “mixer” is any piece of equipment or combination of equipment that can be used to mix ingredients in the provided methods for making the emulsion compositions, for example, standard mixers and homogenizers (shears). For example, mixers can be used to mix the ingredients of the water phase and the oil phase and/or to mix the additional ingredients.

As used herein, “standard mixers” are mixers that are used to combine a group of ingredients, for example, the oil phase ingredients or the water phase ingredients, or to mix one or more ingredients with a liquid, for example, with an emulsion, for example, to mix additional ingredients with the emulsion. Standard mixers can be any mixers that move the material, for example, the ingredients, during heating, for example, to promote dissolving of the ingredients.

As used herein, “homogenizer” and “shear” are used to refer to mixers that typically have high shear, which can be used, for example, to form an emulsion, for example, to emulsify the water phase and the oil phase, in the provided methods. The homogenizers typically are capable of high-shear mixing, which emulsifies the phases.

As used herein, a “cooling apparatus” is any piece of equipment or combination of equipment that can be used with the provided methods to cool the compositions and phases and ingredients thereof, for example, during mixing and/or homogenizing, for example, to chill the mixture while emulsifying the oil and water phases. Exemplary of the cooling apparatuses are coolers (chillers), for example, recirculating coolers which can be attached, for example, to the tanks used in the provided methods, for example, remotely or by a tank mounted in the cooler, to recirculate fluid from the tank, through the chiller and back to the tank, in order to rapidly cool and maintain the temperature of the mixture during mixing. Typically, the cooling apparatus can be used to cool the liquid to between or about between 25° C. and 45° C., for example, to at or about 25, 26, 27, 28, 29, 30, 31, 32, 33, 34, 35, 36, 37, 38, 39, 40, 41, 42, 43, 44 or 45° C.

As used herein, “excipients,” refer to any substance needed to formulate the composition to a desired form. For example, suitable excipients include but are not limited to, diluents or fillers, binders or granulating agents or adhesives, disintegrants, lubricants, antiadherants, glidants, wetting agents, dissolution retardants or enhancers, adsorbents, buffers, chelating agents, preservatives, colors, flavors and sweeteners. Typical excipients include, but are not limited to, starch, pregelatinized starch, maltodextrin, monohydrous dextrose, alginic acid, sorbitol and mannitol. In general, the excipient should be selected from non-toxic excipients (IIG, Inactive Ingredient Guide, or GRAS, Generally Regarded as safe, Handbook of Pharmaceutical Excipients).

As used herein, “w/w,” “by weight,” “% by weight,” “wt %” and “weight percent” are used synonymously to express the ratio of the mass of one component of a composition compared to the mass of the entire composition. For example, when the amount of a particular ingredient represents 1%, by weight (w/w), of a concentrate, the mass of that ingredient is 1% of the mass of the entire concentrate. Similarly, when the amount of an ingredient is 50% (w/w) of the concentrate, the mass of that ingredient is 50% of the entire mass of the concentrate. Similarly, when a composition and/or a compound contains 10%, by weight, of an ingredient, the mass of the ingredient is 10% of the total mass of the composition or compound. When a composition contains 10 wt % of an ingredient, the mass of that ingredient is 10% of the mass of the entire composition. When only a concentration, amount, or percentage (without units) is listed, it is to be understood that the concentration or percentage is a concentration or percentage by weight.

As used herein “v/v” and “volume percent” are used synonymously to express the ratio of the volume of one component of a composition to the volume of the entire composition.

As used herein, “not more than” and “NMT” refer to a quantity that is less than or equal to the listed quantity. Similarly, “not less than” and “NLT” refer to a quantity that is greater than or equal to the listed quantity.

As used herein, the singular forms “a,” “an” and “the” include plural referents unless the context clearly dictates otherwise. Thus, for example, reference to a composition containing “a non-polar ingredient” includes compositions with one or more non-polar ingredients.

As used herein, ranges and amounts can be expressed as “about” a particular value or range. About also includes the exact amount Hence, “about 5 grams” means “about 5 grams” and also “5 grams.” It also is understood that ranges expressed herein include whole numbers within the ranges and fractions thereof. For example, a range of between 5 grams and 20 grams includes whole number values such as 5, 6, 7, 8, 9, 10, 11, 12, 13, 14, 15, 16, 17, 18, 19 and 20 grams, and fractions within the range including, but not limited to, 5.25, 6.72, 8.5 and 11.95 grams.

As used herein, “optional” or “optionally” means that the subsequently described event or circumstance does or does not occur and that the description includes instances where said event or circumstance occurs and instances where it does not. For example, a reaction mixture that “optionally includes a catalyst” means that the reaction mixture contains a catalyst or it does not contain a catalyst.

As used herein, “consisting essentially of” means containing the following list of ingredient(s), and not including any additional ingredients surfactants or active non-polar compounds.

### B. OVERVIEW OF THE EMULSIONS AND USES

It is shown herein that proteins, such as non-dairy proteins such as nut butters (e.g., ground up nuts, such as almonds, cashews, pecans, peanuts, hazelnuts), and/or isolated or concentrated whey protein, facilitate emulsification of healthy oils, in the presence of very low concentrations (1.5% or less, less than 1.5%, and as low as 0.3% or 0.5%, such as 0.6% to 0.7%, by weight, of the resulting emulsion) of a palatable surfactant, such as a polyalkylene glycol derivative of vitamin E, such as a PEG-derivative of vitamin E, such that stable, creamy-tasting emulsions that taste like and/or have the consistency of cream, ice cream, mayonnaise, yogurt and other such products can be prepared. These products are emulsions that are prepared with relatively high concentrations of the protein component to be spreadables, or, with lower amounts of the protein and higher liquid, as liquid emulsions, that can be poured on or mixed with foods, such as, as a non-dairy creamer, or a syrup replacement, such as for pancakes and French toast, or as a smoothie. The whey/nut butter proteins with the low concentration of surfactant, result in an emulsion with a large average particle size, greater than about 3, 4, or 5 μm, and up to about 10, 11, 12, 13, 14, or 15 μm, with a maximum of about 30 μm in the distribution, of the fat in the emulsion. These combination of ingredients and amounts produces a thicker, creamier and better textured emulsion similar to creamy products, such as ice cream, yogurt, butter, mayonnaise. These textures allow for a flavor experience that is more savory or dairy-like, as opposed to emulsions with smaller particles, that contain water, juice or other flavors that are more sour and citrus-like and have smaller particle size. Products, such as ice cream, mayonnaise and yogurt, have very large particle size that is much larger than 5 μm; the compositions herein provide similar textures and flavors.

The amount of surfactant is sufficient when combined with the protein composition, and the oil ingredients, including a polar nutrient, nutraceutical, supplement, or therapeutic, such as CBD oil, fish oil, or algal oil, to produce a stable emulsion that includes a distribution of relatively large particles, greater than about 5 μm up to about 10 μm. An emulsion with this combination of protein composition and low amount of surfactant mimics the consistency of a cream or mayonnaise, ice cream, or yogurt or similar product. The emulsion include flavors so that they are tasty and provide a source of the nutrient, supplement or nutraceutical.

Producing a non-dairy, such as vegan product with no dairy, is challenging. For example, when the dairy protein in a product was replaced with a similar amount of a vegan protein, such as soy protein, rice protein, or pea protein, the resulting emulsions were chalky, and bad textured. Also, the emulsions were not stable, and separated. Using nut and seed proteins, such as almond protein, cashew protein, hazelnut protein, brazil nut protein, walnut protein, tahini seed protein, sunflower seed protein, peanut protein, pumpkin seed protein, pistachio seed protein, hemp seed protein, in emulsions described herein, that contain about 10% to 45%, such as 10-43%, 12-36%, or 25%-45% protein. 25%-35% nut butter/whey protein, with a very low amount of surfactant, such as a polyalkylene glycol derivative of vitamin E, such as a PEG-derivative of vitamin E, results in tasty stable emulsions.

The emulsions herein contain one or more polar protic solvents, such as water and/or glycerin, whey protein and/or nut butter, an oil phase containing an oil or oils that can include a non-polar active ingredient or nutraceutical, such as CBD oil or fish oil or hemp oil or algal oil, flavoring, and a low amount of a surfactant, such as a polyalkylene glycol derivative of vitamin E, such as a PEG-derivative of vitamin E. The oil phase contains about 1% to 50% oil, such as 10% to 15%, such as at or about 11% or at or about 12% oil, by weight, of the emulsion. In other embodiments the oil phase contains 20% to 45% oil, such as 30% to 40% oil, such as at or about 33% or 34% or at or about 36% or 37% oil, by weight, of the emulsion.

Optional ingredients include phospholipids, such as phosphatidylcholine (lecithin), such as sunflower lecithin, and sugar or artificial sweetener. All ingredients are edible. The amounts of polar protic solvent(s) range from about or at 15% to 50%, such as 20%-40%, oil, such as MCT oil, in an amount of 8%-42%, such as 8%-36%, 12%-33%, by weight, or 8%-12%, by weight; nut butter/whey protein in an amount of 10%-35% or higher, such as 40-45% for spreadables, such as 12%-33%, 10% to 42%, or 12%-35%, flavors 1%-10%, and the surfactant, such as the polyalkylene glycol derivative of vitamin E, such as a PEG-derivative of vitamin E, 0.5%-1.5%, 0.5%-1%, 05%-0.7%, and 0.6%-0.7%. All amounts are by weight. Optional sugars up to about 10% by weight, lecithin about 0.1%-0.5%, by weight.

In particular, provided are edible emulsions for direct consumption (without dilution into a food or beverage) or as additives in foods and beverages that contain:

polar protic solvents, such as water, glycerin, and mixtures thereof, in an amount, by weight of a total of 15%-50%, such as 15%-45%, 15%-20%, 15%-40%, 15%-36%, 18%-40%, or 25%-45%, by weight;

nut butter/whey protein in an amount, by weight, of about 10-%35% (up to 45% for spreadables), 10-42%, 12-35%, 12-36%, for liquid emulsions;

edible oils (such as vegetable oils), MCT oil, and nutritional and medicinal oils, such as algal oil, CBD oil in an amount, by weight, of 10-45%, 10-42%, 12-36%, 10-40%, 12-33%, 15-30%;

flavors in an amount of about 0.5 or 1%-10%, by weight;

sugars (optional) or other sweeteners, in an amount, by weight, of 10-30%, 15-25%, (usual with lower protein) in the creamers, syrups; and

surfactant, such as polyalkylene glycol derivative of vitamin E, such as PEG-derivatives of vitamin E, such as TPGS, in an amount, by weight, of 0.5%-less than 2%, 0.5-1.7%, 0.5 to 1.5%, 0.5-1%, 0.5-0.8%, 0.5-0.7%, 0.6-0.7%, such as 0.67%, as exemplified. In some embodiments, the polyalkylene glycol derivative of vitamin E is TPGS, particular vitamin E TPGS where the free PEG has been removed. Removal of free PEG produces a larger particle size, since the PEG acts as a co-surfactant reducing particle size. In general the particle size is greater than 5 μm. Also, water activity is low, 0.86 or less which also increases particle size than higher levels of water activity.

The resulting products include: liquids, smoothies, creamers, syrups (or syrup replacements), and spreadables. The emulsions are provided as liquids, spreadables, or other consistencies, such as creamers. The consistency can be varied by varying the amount of water. The resulting emulsions, particularly, by virtue of the use of the nut butters/whey protein and low amount of surfactant, have a large particular size greater than 5 μm, such as 5 μm-15 μm, or greater than 5 μm up to about 10 μm, with a maximum of about 30 μm.

### C. PROTEIN COMPOSITIONS

The emulsions contain protein compositions; the proteins for use therein are proteins that occur in their native state with relatively high amounts of fat, such as seed/nut proteins, such as almonds, peanuts and other discussed herein, and whey protein, which is contained in milk and isolated and separated therefrom. Nuts, such as almonds, when ground or other blended to become nut butters, contain relatively high amounts of fats. It is found herein that the fats in the native source contribute to emulsification of the proteins. Protein compositions from nuts/seeds as described below that contain relatively high amounts of fats and protein when ground into butters. This is similar to whey protein concentrates and isolates which are separated from milk fats. When whey is in the native state, in milk before separation from curds, it interacts with the naturally occurring fats in milk. This prior interaction facilitates formation of the emulsion containing the whey protein. It is shown herein that these protein compositions can be used to produce stable emulsions with very low amounts of added surfactant(s). The resulting emulsions have very large particles, but are stable, and have a creamy texture, rendering them suitable for use as substitutes for creamers, mayonnaise, yogurts, ice creams, smoothies and other such products.

The emulsions provided herein include nut butter(s) and/or whey protein, such as whey protein concentrates, and optionally collagen. The emulsions contain 10% to as much as about or a 45% or 50% of these protein compositions. It is shown herein that, the nut butters and whey proteins are processed/prepared so that the fats in the original nuts/seeds or milk contribute to emulsification or processing of the proteins, whereby when the proteins are included in the emulsions provided herein, the resulting product emulsion can be prepared with very low amounts of surfactant, such as a PEG derivative of vitamin E, to produce stable emulsions that contain large particles.

1. Nut Butters

The nut butters, as contemplated herein, include seed butters and nut butters, such as butters prepared from peanuts, almonds, pecans, walnuts, cashews, macadamia nuts, hazelnuts, Brazilian nuts, sunflower seeds, sesame seeds, pumpkin seeds, and mixtures thereof. The nut butters include, but are not limited to peanut butter, almond butter, cashew butter, hazelnut butter, macadamia nut butter, pecan butter, pistachio butter, walnut butter, pumpkin seed butter, sesame seed butter, soybean butter, and sunflower seed butter. The nuts/seeds are those that have at or about 10% to 35% protein, by weight, and about 30% to 70% fat, by weight. Hence, as shown in the table below, all of the nuts/seeds listed except coconut, can be used to prepare nut butters for use in the emulsions herein. Exemplary of the composition of exemplary nuts/seeds are as follows:

| | | % Protein |
|---|---|---|
| “nut butter” | % Fat (w/w) | (w/w) |
| Almonds | 45 | 21 |
| Walnuts | 65 | 15 |
| Cashews | 44 | 18 |
| Pistachios | 44 | 21 |
| Hazelnuts | 61 | 15 |
| Peanuts | 45 | 25 |
| Coconuts* | 35 | 3 |

*coconuts not suitable for preparing “nut butters”

The nut butters for use herein can be prepared by grinding nuts or by suitable any method known to those of skill in the art. In general the nut butters for use herein do not include sugars; sugar or artificial sweeteners or other sweeteners optionally can be added to the compositions. Nut butters are included in the non-aqueous (polar phase) in an amount between about 10%-50%, by weight, such as 10%-25%, 15%-50%, 15%-45%, 12%-36%, 25%-38%, 25%-45%. The emulsions with higher amounts of protein compositions result in thicker “spreadable” emulsions. Lower amounts of the proteins are used in the liquid products that can be used, for example, as creamers, to add to beverages, and other compositions of intermediate consistency to pour on food. All can be consumed directly.

2. Whey Proteins

Whey, which contains whey proteins, generally is produced as a by-product of cheese production or acid casein production. Whey proteins are the group of globular milk proteins that remain soluble in “milk serum” when the milk coagulated during cheese production; or after the precipitation of caseins at approximately pH 4.6 and 20° C. Whey protein is typically a mixture of beta-lactoglobulin (such as at or about 65%), alpha-lactalbumin (such as at or about 25%), and serum albumin (such as at or about 8%), which are soluble in their native forms, independent of pH. The term whey protein also includes the kappa-casein fragment (Glycomacropeptide) which remains soluble in “milk serum.”

Whey protein isolate (WPI) is obtained by removing sufficient non-protein constituents from whey such that the finished dry product contains not less than 90% protein. WPI is produced by membrane separation processes or ion exchange. The whey proteins in WPI may be extracted in a highly purified, undenatured form using cross-flow microfiltration membrane technology. Separation of whey proteins in whey protein isolate also may be achieved using conventional chromatography and precipitation methods (see e.g., U.S. Pat. No. 6,096,870; see also, Amundson, C. H., Watanawanichakorn, S., and Hill, C. G., Production of Enriched Protein Fractions of Beta-Lactoglobulin and Alpha-Lactalbumin from Cheese Whey, Journal of Food Processing and Preservation, vol. 6, pp. 55-71 (1982)), and in some examples, ion exchange chromatography, for example cation exchange chromatography. Whey can be further processed by simple drying, such as spray drying after membrane filtration to separate milk proteins from whey proteins.

Whey protein is a rich source of highly bioavailable forms of the amino acid cysteine (as cystine and glutamylcysteine) and also may contain branched chain amino acids, such as leucine, isoleucine and valine. Amino acids in whey protein are from bioactive components such as lactoferrin, serum albumin and alpha-lactalbumin. Accordingly, whey proteins include soluble proteins, including Lactoferrin, lactoperoxidase, immunoglobulins, albumin, alpha-lactalbumin and beta-lactalbumin. Whey protein isolate may contain one or more of: beta-lactoglobulin, alpha-lactalbumin, glycomacropeptides, bovine serum albumin (BSA), immunoglobulins, lactoperoxidase and lactoferrin. Particular protein composition in whey protein may vary depending on, for example, milk source, method of production, and individual manufacturing procedures or specifications.

Whey “concentrate” comprises at or about 80% protein and whey “isolate” comprises at or about 90% protein. During preparation, whey isolate is subjected to an additional filtering step where additional fat and carbohydrates are removed.

Ultrafiltration methods lead to protein enriched whey fractions. Whey protein isolates are generally virtually fat free and are typically lactose free and contain a higher concentration of protein per gram than whey protein concentrate because of the removal of other ingredients, including lactose, fat, and some vitamins and minerals. Whey protein concentrate comprises approximately 80% protein and the remaining 20% comprises water, naturally occurring minerals in whey, carbohydrates, and fat, such as, for example, 5% water, 3-5% naturally occurring minerals in whey and 10-12% of a combination of carbohydrates and fat, such as 8% fat Whey protein isolate, such as whey protein subjected to an additional filtration step(s), comprises less fat, for example 1% fat or less.

Milk is approximately 80-90% water, and the remaining volume comprises fat, carbohydrates (primarily lactose), proteins (casein and whey). Whey remains after coagulation of casein proteins during cheese making. Before isolation from milk, whey protein, such as whey protein in 80% whey concentrate and 90% whey isolate, in its native state associates with fat in milk. This previous association may “prime” the whey proteins for efficient emulsification with the oil and water phase, and allow whey stabilizing activity in the compositions herein.

3. Collagens—BIOCELL Collagen

Collagen preparations for human consumption can be added to the emulsions provided herein. Collagen protein is an excellent source of the amino acids commonly found in high concentrations in connective tissues, such as, for example in tendons, and in skin organs, bone and hair. Collagen typically contains naturally high amounts of proline and hydroxyproline, as well as glycine and other amino acids that facilitate formation of its distinctive tissue structure. Collagen is not for inclusion in vegan and vegetarian products.

Collagen for use in the compositions and emulsions described herewith can be obtained from animal sources, such as animal skin, animal bones or cartilage, such as chicken skin, bone or cartilage, or body parts from fish, pig, cow, jellyfish or other animals, including vertebrates or invertebrates. For example, commercially available BioCell® Collagen is prepared from hormone and antibiotic free chicken sternal cartilage. Chicken sternal cartilage is a high source of collagen type II peptides, hyaluronic acid, and chondroitin sulfate and mimics the composition of human articular cartilage. Collagen can be recovered from animal products and then further digested into basic amino acids. After digestion collagen is referred to as collagen hydrolysate, hydrolyzed gelatin, collagen peptides, or hydrolyzed collagen. BioCell® Collagen is manufactured by subjecting the chicken sternal cartilage to various filtration, purification, concentration, hydrolysis, and sterilization procedures, to remove impurities, decrease molecular size to make the collagen absorbable.

Powdered collagen, such as powder for human consumption, such as BioCell® powdered collagen, contain, for example, about or at 60%-70% hydrolyzed type II collagen, about or at 20% depolymerized chondroitin sulfate, about or at 10% hyaluronic acid, and trace amounts of other proteoglycans. BioCell® Collagen contains hydrolyzed collagen type II, hyaluronic acid, and Chondroitin Sulfate (see, e.g., U.S. Pat. No. 6,780,841).

Collagen for human consumption is used to improve skin elasticity; improve skin, hair and nail texture and growth (see e.g., Proksch et al. (2014) Skin Pharmacol Physiol 27(a): 47-55; Chen et al., (2015) J Invest Dermatol 135(10): 2358-2367); improve digestion (see e.g., Koutroubakis et al. (2003) J Clin Pathol 56: 817-820); improve joint health, such as for improving symptoms of rheumatoid arthritis (see e.g., Trentham et al., (1993) Science 261(5129): 1727-1730); and protect cardiovascular health and boost metabolism.

### D. SURFACTANTS

The emulsions herein include a surfactant (or mixture thereof) in a low amount, generally less than 2%, 1.5% or 1%, by weight, and more than about 0.3%, 0.5%, by weight.

1. Polyalkylene Derivatives of Vitamin E

The emulsions provided herein contains at least one polyalkylene glycol derivative of vitamin E. Exemplary of the polyalkylene glycol derivatives of vitamin E described herein are polyethylene glycol (PEG) derivatives of vitamin E, for example, PEG derivatives of tocopherols or tocotrienols. Suitable PEG derivatives of vitamin E can contain one or more tocopherol or tocotrienol, attached to one or more PEG moiety via a linker, for example, a dicarboxylic acid linker. Exemplary dicarboxylic acid linkers include succinic acid and succinic anhydride. An exemplary polyethylene glycol derivative of vitamin E is shown schematically below:

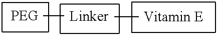

where the line between the PEG and the linker, and the line between the linker and the vitamin E moiety, each independently represent a covalent bond, for example, a covalent bond that forms an ester, ether, amide or thioester.

Typically, the vitamin E-PEG derivatives are made by covalently attaching the PEG moiety, such as by esterification, to a vitamin E-linker conjugate (e.g., a tocopherol-linker conjugate). The vitamin E-linker conjugate can be formed through esterification of the hydroxyl group of the vitamin E moiety with a carboxylic acid group of a linker, such as a dicarboxylic acid linker. In one example, the vitamin E-linker conjugate can be a tocopherol-linker conjugate, such as a tocopherol ester, for example, tocopherol succinate. The esterification reaction can be performed by any of a number of known methods, including those described in U.S. Pat. Nos. 2,680,749; 4,665,204; 3,538,119; and 6,632,443. The resulting vitamin E-linker conjugate can then be attached to a PEG moiety by another esterification reaction, for example, between a carboxylic acid group of the vitamin E-linker conjugate and a hydroxyl group of the PEG moiety, to form a vitamin E-PEG derivative.

PEG derivatives of a tocopherol-linker or tocotrienol-linker compound can be made by any other method known to those of skill in the art Various methods known in the art for producing PEG derivatives can be used to attach a PEG molecule to tocopherol-linker or tocotrienol-linker compounds. For example, a tocopherol-linker compound can form a covalent bond to the PEG molecule via an amide, ether or thioether bond. For example, a tocopherol-linker conjugate that contains an amine group can be reacted with a PEG-NHS (N-hydroxysuccinimide) derivative to form an amide bond between the tocopherol-linker conjugate and the PEG molecule. A tocopherol-linker conjugate that contains an amine group can be reacted with a PEG-aldehyde derivative to form an amide bond between the tocopherol-linker conjugate and the PEG molecule. In another example, a tocopherol-linker conjugate that contains an carboxylic acid can be activated to the corresponding acid halide and reacted with a PEG-SH derivative to form a thioester bond between the tocopherol-linker conjugate and the PEG molecule.

i. Tocopherols and Tocotrienols

The vitamin E derivative can be any vitamin E derivative, for example, any tocopherol or tocotrienol. The tocopherols used can be any natural or synthetic vitamin E tocopherol, including but not limited to, alpha-tocopherols, beta-tocopherols, gamma-tocopherols, and delta tocopherols, either in pure forms or in heterogeneous mixtures of more than one form. Exemplary tocopherols are d-α-tocopherols and dl-tocopherols. To make the vitamin E derivative, the tocopherol typically is esterified with a linker, for example, a dicarboxylic acid, to form a tocopherol ester, which then is joined to a PEG moiety.

The tocotrienols used can be any natural or synthetic vitamin E tocotrienol, including, but not limited to, alpha-tocotrienols, beta-tocotrienols, gamma-tocotrienols, and delta-tocotrienols, either in pure forms or in heterogeneous mixtures of more than one form. Mixtures of tocopherols and tocotrienols are contemplated for use in the provided methods and compositions. A tocotrienol can be esterified with a linker, such as a dicarboxylic acid, before joining with a PEG moiety.

ii. Linkers

Typically, the PEG derivatives of vitamin E are diesters or other esters, e.g., triesters. When the PEG derivative is a diester, the linker joining the vitamin E moiety to the PEG typically is a carboxylic acid, typically a dicarboxylic acid, as in, for example, tocopherol polyethylene glycol succinate (TPGS), where the linker is a succinic acid, and the derivative is made by an esterification reaction joining a PEG moiety and a tocopherol ester of the dicarboxylic acid. In another example, the linker is another molecule, for example, an amino acid, such as glycine, alanine, 5-aminopentanoic acid or 8-aminooctanoic acid, or the linker is an amino alcohol, such as ethanolamine.

iii. PEG Moieties

The polyalkylene glycol moiety used in the polyalkylene glycol vitamin E derivative can be any of a plurality of known polyalkylene glycol moieties, such as any known PEG moiety. Exemplary of suitable polyalkylene glycol moieties are for example, PEG moieties, such as PEG moieties having varying chain lengths, and varying molecular weights, for example, PEG 1000, PEG 200, PEG 500, and PEG 20,000. The number following the individual PEG moiety indicates the molecular weight (in daltons (Da)) of the PEG moiety. Typically, the PEG moiety of a tocopherol-derived surfactant has a molecular weight of between 200 or about 200 to 20,000 or about 20,000 Da, typically between 200 and 6000 Da, for example, between 600 or about 600 Da and 6000 or about 6000 Da, typically between 200 or about 200 Da and 2000 or about 2000 Da, between 600 or about 600 Da and 1500 or about 1500 Da, such as 200, 300, 400, 500, 600, 800, and 1000 Da. Exemplary of a PEG derivative of a tocopherol ester having a PEG moiety with a molecular weight of 1000 Da is TPGS-1000. Also exemplary of suitable PEG moieties are PEG moieties that are modified, for example, methylated PEG (m-PEG), which is a PEG chain capped with a methyl group. Other known PEG analogs also can be used. The PEG moieties can be selected from among any reactive PEG, including, but not limited to, PEG-OH, PEG-NHS, PEG-aldehyde, PEG-SH, PEG-NH₂, PEG-COOH, and branched PEGs.

iv. Tocopheryl Polyalkylene Glycol Derivatives

In its natural water-insoluble state, vitamin E, e.g., tocopherol or tocotrienol, is easily absorbed and used in humans and animals. Processing of foods and feeds by industry for long-term storage can promote accelerated degradation of the effective vitamin E content. To compensate for the loss of natural vitamin E from food sources, nutritional supplements of natural or synthetic fat-soluble vitamin E have been developed. Not all humans and animals can sufficiently absorb the supplements though. To address this problem, water-soluble vitamin E derivatives have been developed that are an excellent source of vitamin E (i.e., maintain a high degree of vitamin E biological activity) in humans with impaired vitamin E absorption, for example, in humans with malabsorption syndromes (Traber et al. (1986) Am. J. Clin. Nutr. 44:914-923). Water-soluble vitamin E derivatives have been developed for this purpose. The water-soluble vitamin E derivative D-α-tocopheryl polyethylene glycol succinate (TPGS) is exemplary of the tocopheryl polyethylene glycol derivatives.

TPGS contains a hydrophilic (i.e., water-soluble) polyethylene glycol (PEG) chain and a lipophilic (i.e., water-insoluble) α-tocopherol head. The amphiphilic structure of TPGS, shown below, renders it much more water-soluble than traditional vitamin E, allowing TPGS to form a micellar solution at low concentrations (0.04-0.06 mmol/L) that can be absorbed by humans and animals in the absence of bile salts.

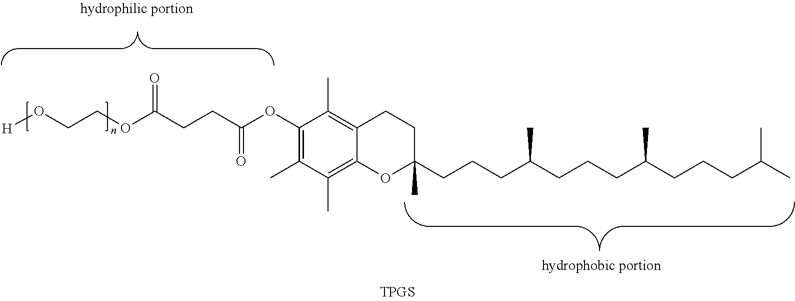

TPGS has been approved by the FDA as a water-soluble vitamin E nutritional supplement. It is a GRAS (Generally Regarded As Safe)-listed supplement that can be taken orally at long-term doses of 13.4-16.8 mg/kg/day or up to 100 mg/kg/day for people with impaired uptake. In the body, TPGS undergoes enzymatic cleavage to deliver the lipophilic antioxidant α-tocopherol (vitamin E) to cell membranes. Cellular enzymatic hydrolysis by cytoplasmic esterases liberates free α-tocopherol, which then localizes in the cell membrane, and through free radical quenching, protects the membrane from lipid peroxidation and damage.

TPGS also is used as a non-ionic surfactant and emulsifier that, as reported, has an HLB value of approximately 13. Non-ionic surface-active agents are used in oral formulations to enhance the bioavailability of water-insoluble pharmaceuticals, such as drugs, vitamins, or other biologically active compounds. TPGS is an effective absorption and bioavailability enhancer, and has been approved for use as a drug solubilizer in oral, parenteral, topical, nasal, and rectal/vaginal therapies (see, e.g., Constantinides et al. (2006) Pharm. Res. 23(2):243-255; Varma et al. (2005) Eur. J. Pharm. Sci. 25(4-5):445-453) and as a solubilizer for inhalation drug delivery (Fulzele et al. (2006) 23(9):2094-2106). TPGS improves the bioavailability of such water-insoluble drugs as the HIV protease inhibitor amprenavir (Yu et al. (1999) Pharm. Res. 16:1812-1817; Brouwers et al. (2006) J. Pharm. Sci. 95:372-383), the non-nucleoside reverse transcriptase inhibitor UC 781 (Goddeeris et al. (2008) Eur. J. Pharm. Sci. 35:104-113), cyclosporin (Sokol et al. (1991) Lancet 338:212-215), paclitaxel (Zhao et al. (2010) J. Pharm. Sci. 99(8):3552-3560), estradiol (Sheu et al. (2003) J. Controlled Release 88:355-368), and fat-soluble vitamins such as vitamin D (Argao et al. (1992) Ped. Res. 31(2):146-150).

Exemplary of a tocopheryl polyalkylene glycol derivative suitable for use in the emulsions provided herein is D-α-tocopheryl polyethylene glycol succinate (TPGS), such as TPGS-1000, for example, the food grade TPGS sold under the name Eastman Vitamin E TPGS®, food grade, by Eastman Chemical Company, Kingsport, Tenn. Other exemplary tocopheryl polyalkylene glycol derivatives suitable for use in the emulsions provided herein are tocopheryl polyalkylene glycol compositions, for example, TPGS compositions, containing a relatively high percentage, such as at least 13%, typically at least 20%, 25%, 29%, 30%, 35%, 40%, 45%, 48%, 49%, 50%, or more, typically up to 60-65%, of the dimer form of TPGS, with the remainder of the TPGS composition containing the monomer form of TPGS and a small percentage, such as less than 5%, 4%, 3%, 2%, 1% of contaminants, such as higher order polymers and reagents, such as vitamin E and polyethylene glycol. Exemplary of tocopheryl polyalkylene glycol derivatives are those described in U.S. patent application Ser. No. 14/207,310 and International PCT Application No. PCT/US14/25006, now published as US-2014-0271593-A1 and WO 2014/151109, respectively, both of which are incorporated herein by reference in their entirety.

Typically, the polyalkylene glycol derivatives of vitamin E used in the provided methods and compositions have an HLB value of between 12 or about 12 and 20 or about 20, for example, 12, 13, 14, 15, 16, 17, 18, 19, 20, or about 12, about 13, about 14, about 15, about 16, about 17, about 18, about 19 or about 20. Exemplary of suitable polyalkylene glycol derivatives of vitamin E include, but are not limited to, tocopherol and/or tocotrienol-derived surfactants, in which the vitamin E moiety represents the hydrophobic region of the surfactant, and is attached, via a linker, to another moiety, such as a polyethylene glycol (PEG) moiety, that provides the hydrophilic portion of the surfactant. Vitamin-E derived surfactants include, but are not limited to, tocopherol derived surfactants, including polyalkylene glycol derivatives of tocopherol, typically polyethylene glycol (PEG) derivatives of tocopherol, such as tocopherol polyethylene glycol succinate (TPGS), TPGS analogs, TPGS homologs and TPGS derivatives. Alternatively, the surfactants can be other PEG derivatives having similar properties, for example, PEG derivatives of sterols, e.g., a cholesterol or a sitosterol (including, for example, any of the PEG derivatives disclosed in U.S. Pat. No. 6,632,443) or PEG derivatives of other fat-soluble vitamins, for example, some forms of vitamin A (e.g., retinol) or vitamin D (e.g., vitamins D1-D5). Typically, the polyalkylene glycol derivatives of vitamin E is GRAS (generally recognized as safe) by the FDA and/or Kosher certified, for example, TPGS.

(a) Synthesis

Scheme 1 shows the synthesis of an exemplary water-soluble vitamin E derivative, TPGS, but any vitamin E moiety, i.e., any tocopherol or tocotrienol, can be used as the starting material and reacted with any linker, such as those described herein, that is capable of reacting with a polyalkylene glycol moiety to form a monomer form and dimer form of a water-soluble vitamin E derivative. As shown in Scheme 1 below, TPGS can be prepared by reacting vitamin E with succinic anhydride or succinic acid to obtain vitamin E succinate, i.e., D-α-tocopheryl succinate, followed by esterification with a polyethylene glycol molecule, to obtain TPGS (see U.S. Pat. No. 2,680,749). TPGS analogs varying in PEG chain length (e.g., TPGS 200, 238, 400, 600, 2000, 3400, 3500, 4000 and 6000) have been synthesized, but the most widely used form of TPGS is TPGS 1000, which incorporates PEG 1000, a polyethylene glycol molecule with a molecular weight of approximately 1,000 Daltons (Collnot et al. (2006) J. Controlled Release 111:35-40). TPGS 1000 is a pale yellow, waxy solid substance that is amphipathic and hydrophilic, with a molecular weight of approximately 1,513 Daltons.

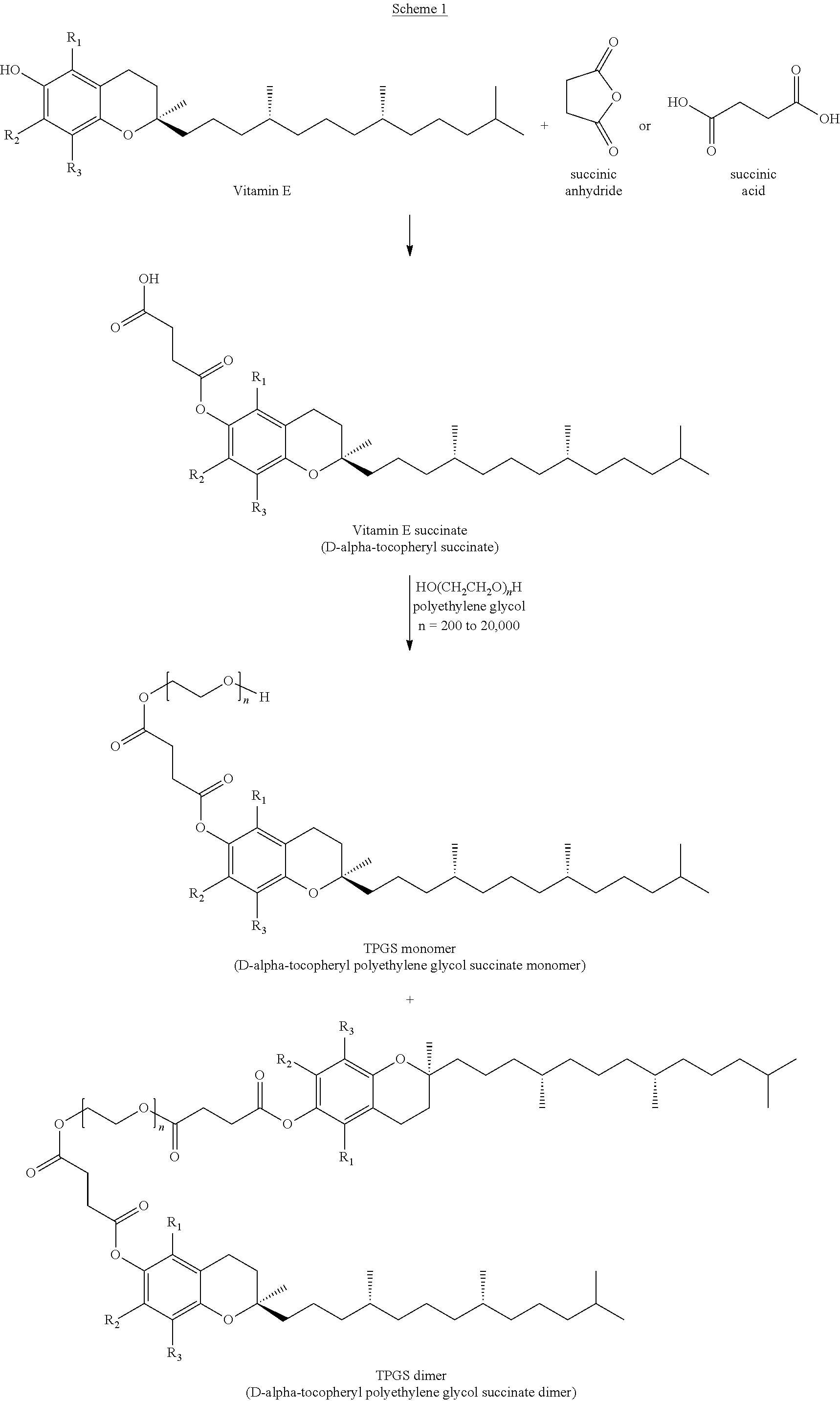

TPGS compositions, as generally prepared, such as commercially available TPGS 1000, are mixtures that contain primarily TPGS monomer (between 70% and 87% or more) and a lesser amount of TPGS dimer (less than 12%). The monomer is considered the effective component in TPGS, while the dimer is viewed as a byproduct of the esterification reaction between polyethylene glycol and vitamin E succinate. For example, commercially available TPGS, such as the TPGS 1000 available from Eastman Chemical Company (Kingsport, Tenn.), contains primarily TPGS monomer (˜86% or more) and a small amount of TPGS dimer (˜11% or less) (Christiansen et al. (2011) J. Pharm. 100(5):1773-1782). TPGS synthesized according to standard methods, for example, the method described in U.S. Pat. No. 2,680,749, results in a TPGS composition that is composed primarily of TPGS monomer (70-87%) and a small amount of TPGS dimer (<12%) (US Pharmacopeia 23 (1998) Supp. 9:4712; Scientific Panel of the European Food Safety Authority (2007) EFSA J. 490:1-20). Because the separation of TPGS monomer and TPGS dimer is difficult and because TPGS monomer is considered the effective component of TPGS, TPGS compositions containing primarily TPGS dimer have not been developed (Kong et al. (2011) J. Chromatography A 1218:8664-8671). TPGS dimer, shown below, is usually considered an unwanted byproduct of the esterification reaction between PEG and vitamin E succinate, formed due to the equal reactivity of both terminal hydroxyl groups of the PEG moiety.

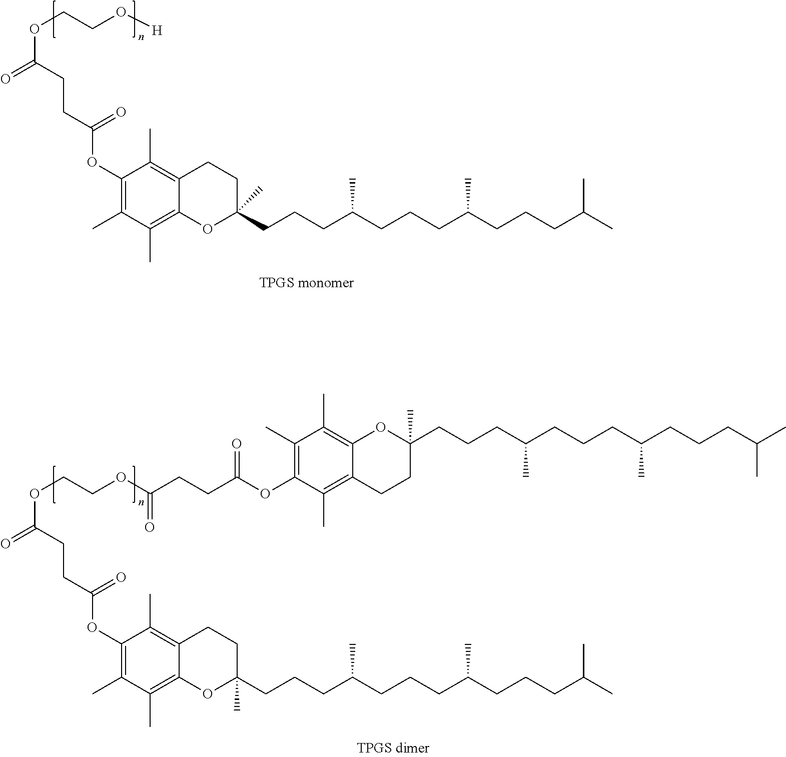

(b) Water-Soluble Vitamin E Derivative Mixtures (Compositions)

The water-soluble vitamin E derivative mixtures (compositions), for example, TPGS compositions, that can be used in emulsions provided herein can contain varying amounts of monomer and dimer, particularly TPGS compositions that contain less monomer than is found in typical, known water-soluble vitamin E derivative mixtures (compositions), for example, less than 70 wt % monomer, and more dimer, i.e., greater than 12 wt % dimer, than in typical, known water-soluble vitamin E derivative mixtures (compositions), for example, known TPGS compositions. For example, the water-soluble vitamin E derivative mixtures (compositions) can contain between or between about 25 wt % and 69 wt % monomer and between or between about 13 wt % and 95 wt % dimer, such as water-soluble vitamin E derivative mixtures (compositions) containing between or about between 40 wt % and 60 wt % monomer and between or about between 25 wt % and 60 wt % dimer, such as 29% to 55%, 35% to 50% or 30% to 45%, dimer.

In the water-soluble vitamin E derivative mixtures (compositions) that can be used in the emulsions described herein, the total amount of monomer as a percentage (%) by weight of the water-soluble vitamin E derivative mixture (composition) (wt %) can be, e.g., between or between about 25 wt % and 69 wt % monomer, inclusive, such as between or between about 25% and 30%, 25% and 35%, 25% and 40%, 25% and 45%, 25% and 50%, 25% and 55%, 25% and 60%, 25% and 65%, 25% and 69%, 30% and 35%, 30% and 40%, 30% and 45%, 30% and 50%, 30% and 55%, 30% and 60%, 30% and 65%, 30% and 69%, 35% and 40%, 35% and 45%, 35% and 50%, 35% and 55%, 35% and 60%, 35% and 65%, 35% and 69%, 40% and 45%, 40% and 50%, 40% and 55%, 40% and 60%, 40% and 65%, 40% and 69%, 45% and 50%, 45% and 55%, 45% and 60%, 45% and 65%, 45% and 69%, 50% and 55%, 50% and 60%, 50% and 65%, 50% and 69%, 55% and 60%, 55% and 65%, 55% and 69%, 60% and 65%, 60% and 69%, and 65% and 69% monomer, by weight of the composition. Generally, the water-soluble vitamin E derivative mixtures (compositions) contain less than 69 wt % monomer. For example, the water-soluble vitamin E derivative mixtures (compositions) described herein contain at least or about at least 25%, 30%, 35%, 36%, 37%, 38%, 39%, 40%, 41%, 42%, 43%, 44%, 45%, 46%, 47%, 48%, 49%, 50%, 51%, 52%, 53%, 54%, 55%, 56%, 57%, 58%, 59%, 60%, 61%, 62%, 63%, 64%, 65%, 66%, 67%, 68%, but less than 69% (wt %), total monomer.

In the water-soluble vitamin E derivative mixtures (compositions) that can be used in the emulsions described herein, the total amount of dimer as a percentage (%) by weight of the water-soluble vitamin E derivative mixture (composition) (wt %) can be, e.g., between or between about 13 wt % and 95 wt % dimer, inclusive, such as between or between about 13% and 20%, 13% and 25%, 13% and 30%, 13% and 35%, 13% and 40%, 13% and 45%, 13% and 50%, 13% and 55%, 13% and 60%, 13% and 65%, 13% and 70%, 13% and 75%, 13% and 80%, 13% and 85%, 13% and 90%, 13% and 95%, 20% and 25%, 20% and 30%, 20% and 35%, 20% and 40%, 20% and 45%, 20% and 50%, 20% and 55%, 20% and 60%, 20% and 65%, 20% and 70%, 20% and 75%, 20% and 80%, 20% and 85%, 20% and 90%, 20% and 95%, 25% and 30%, 25% and 35%, 25% and 40%, 25% and 45%, 25% and 50%, 25% and 55%, 25% and 60%, 25% and 65%, 25% and 70%, 25% and 75%, 25% and 80%, 25% and 85%, 25% and 90%, 25% and 95%, 30% and 35%, 30% and 40%, 30% and 45%, 30% and 50%, 30% and 55%, 30% and 60%, 30% and 65%, 30% and 70%, 30% and 75%, 30% and 80%, 30% and 85%, 30% and 90%, 30% and 95%, 35% and 40%, 35% and 45%, 35% and 50%, 35% and 55%, 35% and 60%, 35% and 65%, 35% and 70%, 35% and 75%, 35% and 80%, 35% and 85%, 35% and 90%, 35% and 95%, 40% and 45%, 40% and 50%, 40% and 55%, 40% and 60%, 40% and 65%, 40% and 70%, 40% and 75%, 40% and 80%, 40% and 85%, 40% and 90%, 40% and 95%, 45% and 50%, 45% and 55%, 45% and 60%, 45% and 65%, 45% and 70%, 45% and 75%, 45% and 80%, 45% and 85%, 45% and 90%, 45% and 95%, 50% and 55%, 50% and 60%, 50% and 65%, 50% and 70%, 50% and 75%, 50% and 80%, 50% and 85%, 50% and 90%, 50% and 95%, 55% and 60%, 55% and 65%, 55% and 70%, 55% and 75%, 55% and 80%, 55% and 85%, 55% and 90%, 55% and 95%, 60% and 65%, 60% and 70%, 60% and 75%, 60% and 80%, 60% and 85%, 60% and 90%, 60% and 95%, 65% and 70%, 65% and 75%, 65% and 80%, 65% and 85%, 65% and 90%, 65% and 95%, 70% to 75%, 70% and 80%, 70% and 85%, 70% and 90%, 70% and 95%, 75% and 80%, 75% and 85%, 75% and 90%, 75% and 95%, 80% and 85%, 80% and 90%, 80% and 95%, 85% and 90%, 85% and 95% and 90% and 95% dimer, by weight of the water-soluble vitamin E derivative mixture (composition). Generally, the water-soluble vitamin E derivative mixtures (compositions) contain less than 95 wt % dimer. For example, the water-soluble vitamin E derivative mixtures (compositions) described herein contain at least or about at least 13%, 15%, 20%, 25%, 26%, 27%, 28%, 29%, 30%, 31%, 32%, 33%, 34%, 35%, 36%, 37%, 38%, 39%, 40%, 41%, 42%, 43%, 44%, 45%, 46%, 47%, 48%, 49%, 50%, 51%, 52%, 53%, 54%, 55%, 56%, 57%, 58%, 59%, 60%, 61%, 62%, 63%, 64%, 65%, 66%, 67%, 68%, 69%, 70%, 71%, 72%, 73%, 74%, 75%, 76%, 77%, 78%, 79%, 80%, 81%, 82%, 83%, 84%, 85%, 86%, 87%, 88%, 89%, 90%, 91%, 92%, 93%, 94%, but less than 95% (wt %) total dimer.

The water-soluble vitamin E derivative mixtures (compositions) that can be used in the emulsions described herein that contain less than 70 wt % monomer and greater than 12 wt % dimer exhibit decreased turbidity values when dissolved in an aqueous solution, for example, when dissolved in water, as compared to typical, known water-soluble vitamin E derivative mixtures (compositions), i.e., water-soluble vitamin E derivative mixtures (compositions) that contain more than 70 wt % monomer and less than 12 wt % dimer. The compositions containing less than 70 wt % monomer and greater than 12 wt % dimer allow for the addition of a higher concentration of non-polar compounds when used in aqueous food and beverage products as compared to available aqueous food and beverage products, while maintaining clarity and stability, for example, exhibiting decreased turbidity values.

Exemplary of the compositions are TPGS compositions containing less than 70 wt % TPGS monomer and more than 12 wt % TPGS dimer, such as compositions containing between or about between 25 wt % and 69 wt % TPGS monomer and between or about between 13 wt % and 95 wt % TPGS dimer, such as TPGS compositions containing between or about between 40 wt % and 60 wt % TPGS monomer and between or about between 25 wt % and 60 wt % TPGS dimer, are described herein. The compositions containing less than 70 wt % TPGS monomer and greater than 12 wt % TPGS dimer exhibit decreased turbidity values when dissolved, for example, when dissolved in water, as compared to typical, known TPGS compositions, i.e., TPGS compositions that contain more than 70 wt % TPGS monomer and less than 12 wt % TPGS dimer. The TPGS compositions allow for the addition of a higher concentration of non-polar compounds when used in aqueous food and beverage products as compared to available aqueous food and beverage products, while maintaining clarity and stability, for example, exhibiting decreased turbidity values.

The water-soluble vitamin E derivative mixtures (compositions), e.g., TPGS compositions, that can be used in the emulsions described herein contain a mixture of monomer and dimer, e.g., a mixture of TPGS monomer and TPGS dimer. The monomer, for example, a TPGS monomer, can be present in an amount that is less than what is typically found in known water-soluble vitamin E derivative mixtures (compositions), e.g., known TPGS compositions, i.e., less than 70 wt % monomer. The dimer, for example, a TPGS dimer, can be present in an amount that is greater than what is typically found in known water-soluble vitamin E derivative mixtures (compositions), e.g., known TPGS compositions, i.e., greater than 12 wt % dimer. The water-soluble vitamin E derivative mixtures (compositions), such as the TPGS compositions, can also contain other components, such as, for example, unreacted PEG, unreacted vitamin E, e.g., D-α-tocopheryl succinate, and one or more catalysts.

Methods for preparing the water-soluble vitamin E derivative mixtures (compositions), such as the TPGS compositions described herein, are described herein, for example, methods of preparing water-soluble vitamin E derivative compositions, such as TPGS compositions, that contain less than 70 wt % TPGS monomer and more than 12 wt % TPGS dimer. Existing methods for preparing derivatives of vitamin E can be employed, except that the methods are modified to produce higher concentrations of the dimer form by modifying reaction conditions. Such modifications can be determined empirically if needed, such as by varying reaction parameters, such as time, temperature and reactant concentrations, to identify conditions that favor higher levels of dimer production.

The water-soluble vitamin E derivative mixtures e.g., TPGS monomer-dimer mixtures, prepared according to the methods, can contain between or about between 25 wt % and 69 wt % monomer, for example, at or about 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68 or 69 wt % monomer and between or about between 13 wt % and 95 wt % dimer, for example, at or about 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 89, 80, 81, 82, 83, 84, 85, 86, 87, 88, 89, 90, 91, 92, 93, 94 or 95 wt % dimer.

Exemplary of the water-soluble vitamin E derivative mixtures (compositions) that can be used in the emulsions described herein that contain a mixture of monomer and dimer, for example, TPGS compositions that contain a mixture of TPGS monomer and TPGS dimer, are compositions that contain between or about between 25 wt % and 69 wt % monomer and between or about between 13 wt % and 95 wt %, such as 29% to 55%, dimer. Thus, described herein are water-soluble vitamin E derivative mixtures (compositions), such as TPGS compositions, that contain less monomer, i.e., less than 70 wt % monomer, such as between 25 wt % and 69 wt % monomer, and more dimer, i.e., more than 12 wt % dimer, such as between 13 wt % and 95% dimer, than typical commercial TPGS compositions.

v. Methods for Making Water-Soluble Vitamin E Derivatives

The water-soluble vitamin E derivative mixtures (compositions) with higher amounts of dimer can be prepared by modification of methods that compositions with higher amounts of monomer and lower amounts of dimer are prepared by, appropriately varying reaction conditions to favor increased dimer formation. Alternatively, standard known methods can be employed and the dimers purified or partially purified and added to compositions to increase the percentage of dimer to a desired level.

For example, for production of compositions with higher amounts of TPGS dimer, the methods employ the use of vitamin E succinate, e.g., D-α-tocopheryl succinate, as a starting material. Methods that use vitamin E, e.g., tocopherol or tocotrienol, and succinic acid or succinic anhydride as the starting materials (to synthesize vitamin E succinate) also can be used to prepare the water-soluble vitamin E derivative mixtures (compositions) described herein. The methods can be adapted for production of any desired water-soluble vitamin E derivative composition that contains the higher amounts of dimer.

These water-soluble vitamin E derivative mixtures (compositions) exhibit decreased turbidity values as compared to known water-soluble vitamin E derivative mixtures (compositions), such as known TPGS compositions, when dissolved, such as, for example, when dissolved in water or other aqueous beverages. Thus, the described methods are advantageous over existing prior art methods of preparing TPGS compositions that exhibit high turbidity values, e.g., higher than 80 NTUs, when dissolved, such as when dissolved in water.

Water-soluble vitamin E derivatives, such as TPGS, can be prepared by esterifying vitamin E succinate, for example, D-α-tocopheryl acid succinate, with polyethylene glycol. The resulting vitamin E TPGS has a chemical formula of C₃₃O₅H₅₄(CH₂CH₂O)ₙ, where “n” represents the number of polyethylene oxide moieties attached to the acid group of the vitamin E succinate. In an exemplary embodiment, the method includes preparing a crude water-soluble vitamin E, e.g., TPGS, composition by first preparing a reaction mixture containing vitamin E succinate, a polyethylene glycol (PEG), and optionally, a catalyst, in a solvent, and heating the reaction mixture to an elevated temperature to produce a crude water-soluble vitamin E, e.g., TPGS, composition containing less TPGS monomer and more TPGS dimer than what is typically found in known TPGS compositions, i.e., less than 70 wt % TPGS monomer and more than 12 wt % TPGS dimer. The crude water-soluble vitamin E, e.g., TPGS, composition then can be purified and concentrated to obtain a purified water-soluble vitamin E, e.g., TPGS, composition containing less TPGS monomer and more TPGS dimer than what is typically found in known TPGS compositions, i.e., less than 70 wt % TPGS monomer and more than 12 wt % TPGS dimer. Any purification process known in the art can be used to purify the reaction product.

(a) Reaction Mixture

The water-soluble vitamin E derivative mixtures can be prepared by first preparing a crude water-soluble vitamin E derivative mixture, such as a crude TPGS composition, by esterifying vitamin E succinate with polyethylene glycol in a solvent. The esterification procedure can be promoted by a catalyst, for example, an esterification catalyst. The crude composition can be prepared from a reaction mixture containing vitamin E succinate, a polyethylene glycol (PEG), a solvent, and optionally, a catalyst. The components of the reaction mixture can be added in any order. In an exemplary embodiment, the polyethylene glycol is dissolved in the solvent before the addition of vitamin E succinate and the catalyst.

A crude water-soluble vitamin E derivative mixture, such as a crude TPGS composition, that contains less TPGS monomer and more TPGS dimer than what is typically found in known TPGS compositions, i.e., less than 70 wt % TPGS monomer and more than 12 wt % TPGS dimer can be produced. In some instances, the crude TPGS composition contains between or about between 25 wt % and 69 wt % TPGS monomer and between or about between 13 wt % and 95 wt % TPGS dimer, such as between or about between 40 wt % and 60 wt % TPGS monomer and between or about between 25 wt % and 60 wt % TPGS dimer.

(i) Vitamin E Succinate

The reaction mixtures can contain vitamin E succinate, for example, D-α-tocopheryl succinate. Vitamin E succinate can be purchased from suppliers such as Sigma-Aldrich (St. Louis, Mo.), Parchem (New Rochelle, N.Y.), Fisher Scientific (Fair Lawn, N.J.), and VWR International (Radnor, Pa.), or can be synthesized according to methods known to those of skill in the art. Typically, vitamin E succinate can be synthesized by reacting vitamin E (i.e., D-α-tocopherol) with succinic anhydride in a solvent (e.g., toluene) in the presence of a base (e.g., triethylamine) (see, for example, U.S. Patent Pub. Nos. 2011/0130562 and 2011/0184194; Lipshutz et al. (2011) J. Org. Chem. 76(11):4379-4391; Gelo-Pujic et al. (2008) Int. J. Cosmet. Sci. 30(3):195-204; and Vraka et al. (2006) Bioorg. Med. Chem. 14(8):2684-2696).

The total amount of vitamin E succinate in the reaction mixture as a percentage (%) by weight of the reaction mixture (wt %) can be, e.g., from at or about 0.1% to at or about 15%, such as 0.1% to 1%, 0.1% to 3%, 0.1% to 5%, 0.1% to 10%, 0.1% to 15%, 0.5% to 1%, 0.5% to 3%, 0.5% to 5%, 0.5% to 10%, 0.5% to 15%, 1% to 3%, 1% to 5%, 1% to 10%, 1% to 15%, 3% to 5%, 3% to 10%, 3% to 15%, 5% to 10%, 5% to 15%, or 10% to 15% by weight of the reaction mixture. Generally, the reaction mixtures contain less than 15 wt % vitamin E succinate. For example, the reaction mixtures described herein contain up to at or about 1%, 2%, 3%, 4%, 5%, 6%, 7%, 8%, 9%, 10%, 11%, 12%, 13%, 14% or 15% vitamin E succinate. Generally, the reaction mixtures described herein contain less than 15% (wt %) total vitamin E succinate.

(ii) Polyethylene Glycol

The reaction mixtures include any polyethylene glycol that can react with the acid moiety of vitamin E succinate to form an ester. The polyethylene glycol can include, for example, any polyethylene glycol that gives the desired molecular weight of the water-soluble vitamin E compound, the desired polyethylene glycol chain length of the water-soluble vitamin E compound or the desired amount of water-soluble vitamin E water-solubility. The polyethylene glycol in the reaction mixtures can include, for example, any polyethylene glycol that is capable of forming an ester when reacted with vitamin E succinate to produce a vitamin E derivative that is water-soluble. For example, the polyethylene glycol can include PEG-OH, PEG-SH, PEG-NH₂ and branched PEGs. Typically, the polyethylene glycol is PEG-OH. The resulting water-soluble vitamin E product, for example, TPGS, formed by the reaction between vitamin E succinate and a polyethylene glycol contains at least polyethylene glycol esters of vitamin E succinate. The esters can be a mixture of esters, such as a mixture of TPGS monomer and TPGS dimer.

The polyethylene glycols in the reaction mixtures can be any molecular weight, for example, any molecular weight that renders vitamin E succinate water-soluble after esterification with the polyethylene glycol (i.e., the resulting TPGS is water-soluble). Such polyethylene glycols are known in the art and can be purchased from suppliers such as Sigma-Aldrich (St. Louis, Mo.), Fisher Scientific (Fair Lawn, N.J.), and VWR International (Radnor, Pa.). The polyethylene glycol can be added to the reaction mixture by any method suitable for transferring the PEG to the reaction mixture. For example, the PEG can be transferred to the reaction mixture in molten form.

Suitable polyethylene glycols include polyethylene glycols having an average molecular weight ranging from between or about between 100 Daltons (Da) and 20,000 Da. For example, the average molecular weight can be between or about between 200 Da and 10,000 Da, or 400 Da and 5,000 Da, or 500 Da and 1500 Da, or 750 Da and 1200 Da, or 1000 Da and 2,500 Da. Generally, the molecular weight of the polyethylene glycol is less than 20,000 Da. For example, the average molecular weight of the polyethylene glycol used in the reaction mixtures can be or can be about 100, 200, 238, 300, 400, 500, 600, 750, 800, 1000, 1200, 1500, 2000, 2500, 3000, 3400, 3500, 4000, 6000, 8000, 10,000, or 12,000 Da, but less than 20,000 Da.

Exemplary polyethylene glycols include PEG 100 (where 100 represents the PEG chain molecular weight), PEG 200, PEG 238, PEG 300, PEG 400, PEG 500, PEG 600, PEG 750, PEG 800, PEG 1000, PEG 1200, PEG 1500, PEG 2000, PEG 2500, PEG 3000, PEG 3400, PEG 3500, PEG 4000, PEG 6000, PEG 8000, PEG 10,000, PEG 12,000 or PEG 20,000. Any other suitable polyethylene glycol known to those of skill in the art also can be used in the methods. In some embodiments described herein, the polyethylene glycol is PEG 1000.

The total amount of PEG in the reaction mixture as a percentage (%) by weight of the reaction mixture (wt %) can be, e.g., from at or about 1% to at or about 50%, such as 1% to 5%, 5% to 10%, 5% to 15%, 5% to 20%, 5% to 25%, 5% to 30%, 5% to 35%, 5% to 40%, 5% to 45%, 10% to 15%, 10% to 20%, 10% to 25%, 10% to 30%, 10% to 35%, 10% to 40%, 10% to 45%, 10% to 50%, 15% to 20%, 15% to 25%, 15% to 30%, 15% to 35%, 15% to 40%, 15% to 45%, 15% to 50%, 20% to 25%, 20% to 30%, 20% to 40%, 20% to 50%, 25% to 50%, or 30% to 50% by weight of the reaction mixture. Generally, the reaction mixtures contain less than 50 wt % PEG. For example, the reaction mixtures described herein contain at least or about at least 1%, 2%, 3%, 4%, 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, 35%, 36%, 37%, 38%, 39%, 40%, 41%, 42%, 43%, 44%, 45%, 46%, 47%, 48%, 49%, but less than 50% (wt %) total PEG.

(iii) Catalyst

The reaction mixtures can optionally contain a catalyst. Suitable catalysts include those catalysts that can be used to promote the esterification reaction between the PEG and the acid moiety of vitamin E succinate. Exemplary catalysts include acidic catalysts, such as p-toluenesulfonic acid, oxalic acid, hydrochloric acid, tricholoracetic acid, and any other known catalyst that can promote esterification.

In the reaction mixtures, the total amount of catalyst, as a percentage (%) by weight of the reaction mixture (wt %) can be, e.g., from at or about 0% to at or about 15%, such as 0.01% to 0.05%, 0.01% to 0.1%, 0.01% to 0.5%, 0.01% to 0.75%, 0.01% to 1%, 0.01% to 3%, 0.01% to 5%, 0.01% to 10%, 0.01% to 15%, 0.01% to 0.5%, 0.01% to 0.75%, 0.01% to 1%, 0.01% to 3%, 0.01% to 5%, 0.01% to 10%, 0.01% to 15%, 0.05% to 0.1%, 0.05% to 0.5%, 0.05% to 0.75%, 0.05% to 1%, 0.05% to 3%, 0.05% to 5%, 0.05% to 10%, 0.05% to 15%, 0.05% to 0.5%, 0.05% to 0.75%, 0.05% to 1%, 0.05% to 3%, 0.05% to 5%, 0.05% to 10%, 0.05% to 15%, 0.1% to 0.5%, 0.1% to 0.75%, 0.1% to 1%, 0.1% to 3%, 0.1% to 5%, 0.1% to 10%, 0.1% to 15%, 0.5% to 0.75%, 0.5% to 1%, 0.5% to 3%, 0.5% to 5%, 0.5% to 10%, 0.5% to 15%, 1% to 3%, 1% to 5%, 1% to 10%, 1% to 15%, 3% to 5%, 3% to 10%, 3% to 15%, 5% to 10%, 5% to 15%, 10% to 15% by weight of the reaction mixture. Generally, the reaction mixtures contain less than 15 wt % catalyst. For example, the reaction mixtures described herein can contain up to at or about 1%, 2%, 3%, 4%, 5%, 6%, 7%, 8%, 9%, 10%, 11%, 12%, 13%, 14% or 15% catalyst, based on the weight of the reaction mixture.

(iv) Solvent

The reaction mixtures include a solvent or combination of solvents. Suitable solvents include those that do not prevent the esterification reaction between the PEG and acid moiety of vitamin E succinate from taking place. For example, the solvent or combination of solvents can be aprotic solvents.

Suitable solvents include solvents that are inert to the reaction and are aprotic, for example, solvents that lack an acidic hydrogen, such as toluene, xylenes, ethers such as tetrahydrofuran (THF), diethyl ether and dioxane, ethyl acetate, acetone, dimethylformamide (DMF), N,N-dimethylacetamide, acetonitrile, methyl ethyl ketone (MEK), methyl isobutyl ketone (MIBK), dimethyl sulfoxide (DMSO), ethylene glycol dimethylether, hexanes, cyclohexane, pentane, cyclopentane and any combination thereof. An exemplary solvent used in the reaction mixtures is toluene.

In the reaction mixtures, the total amount of solvent as a percentage (%) by weight of the reaction mixture (wt %) can be, e.g., from at or about 60% to at or about 95%, such as 60% to 65%, 60% to 70%, 60% to 75%, 60% to 80%, 60% to 85%, 60% to 90%, 60% to 95%, 65% to 70%, 65% to 75%, 65% to 80%, 65% to 85%, 65% to 90%, 65% to 95%, 70% to 75%, 70% to 80%, 70% to 85%, 70% to 90%, 70% to 95%, 75% to 80%, 75% to 85%, 75% to 90%, 75% to 95%, 80% to 85%, 80% to 90%, 80% to 95%, 85% to 90%, 85% to 95% and 90% to 95%, by weight of the reaction mixture. Generally, the reaction mixtures contain less than 95 wt % solvent. For example, the reaction mixtures can contain at least or about at least 60%, 65%, 70%, 75%, 80%, 85%, 90%, but less than 95% (wt %) total solvent.

(v) Exemplary Reaction Mixtures

Exemplary reaction mixtures that can be used to ultimately produce a water-soluble vitamin E derivative mixture, for example, a TPGS composition, that contains less TPGS monomer and more TPGS dimer than what is typically manufactured, i.e., less than 70 wt % TPGS monomer and more than 12 wt % TPGS dimer, are described. They are exemplified with TPGS, but similar reaction mixtures can be prepared and reactions performed to produce tocopherol sebacate polyethylene glycol, tocopherol dodecanodioate polyethylene glycol, tocopherol suberate polyethylene glycol, tocopherol azelaate polyethylene glycol, tocopherol citraconate polyethylene glycol, tocopherol methylcitraconate polyethylene glycol, tocopherol itaconate polyethylene glycol, tocopherol maleate polyethylene glycol, tocopherol glutarate polyethylene glycol, tocopherol glutaconate polyethylene glycol and tocopherol phthalate polyethylene glycol, TPGS analogs and TPGS homologs.

The reaction mixtures exemplified herein include vitamin E succinate, a polyethylene glycol, a solvent, and optionally, a catalyst Exemplary of such reaction mixtures contain from at or about 0.1 wt % to at or about 15 wt % of vitamin E succinate; a polyethylene glycol, in an amount from at or about 1 wt % to at or about 50 wt %; a catalyst, in an amount from at or about 0.01 wt % to at or about 15 wt %; and from at or about 60% to at or about 95% of a solvent.

In some embodiments, the polyethylene glycol can be a polyethylene glycol with a molecular weight of around 1000 Da, for example, PEG 1000. For example, the exemplary reaction mixtures described herein can contain from at or about 0.1 wt % to at or about 15 wt % of vitamin E succinate; from at or about 1 wt % to at or about 50 wt % of a polyethylene glycol, for example, PEG 1000; from at or about 0.01 wt % to at or about 15 wt % of a catalyst, for example, p-toluenesulfonic acid; and from at or about 60% to at or about 95% of a solvent, for example, toluene.

(vi) Exemplary Methods

The methods include preparing a reaction mixture containing vitamin E succinate, a polyethylene glycol and optionally, a catalyst, in a solvent; heating the reaction mixture to a temperature equal to or higher than the boiling point of the solvent to form a crude water-soluble vitamin E derivative mixture; processing the reaction mixture to obtain the crude water-soluble vitamin E derivative mixture; and purifying the crude water-soluble vitamin E derivative mixture to obtain a purified water-soluble vitamin E derivative mixture. In particular, the methods use the exemplary reaction mixtures described above. The methods to synthesize water-soluble vitamin E derivative mixtures described herein result in water-soluble vitamin E derivative mixtures, such as TPGS compositions, that are less turbid than known water-soluble vitamin E derivative mixtures, i.e., known compositions that contain more than 70% TPGS monomer and less than 12% TPGS dimer, when diluted in an aqueous medium, e.g., water.

The following methods are exemplary only and provide a platform from which adjustments can be made. It is understood that changes can be made to the steps of the method and to the reaction components while retaining some if not all of the desirable properties of the method. Further changes can be made by adding or altering steps or components of each step. For example, the order in which the steps are performed can be changed.

(a) Preparation of a Crude Water-Soluble Vitamin E Derivative Mixture

An exemplary method of preparing a high dimer-containing mixture of TPGS is described. The method can be employed to produce high dimer-containing mixtures of any vitamin E derivative, including PEG derivatives of vitamin E. Exemplary is a method of preparing a crude water-soluble vitamin E derivative mixture, for example, a crude TPGS composition, by providing a reaction mixture containing vitamin E succinate, e.g. D-α-tocopheryl succinate, a polyethylene glycol, e.g., PEG 1000, a catalyst, e.g., p-toluenesulfonic acid, and a solvent, e.g., toluene, heating the reaction mixture to a temperature of at least or about at least 110° C. and maintaining the elevated temperature for a period of up to at or about 6.5 hours before cooling, for example, to room temperature, i.e., at or about 20° C., and washing the reaction mixture with an aqueous solution of a weak base, e.g., a 10% aqueous solution of sodium bicarbonate.

A crude water-soluble vitamin E derivative mixture is prepared by providing a reaction mixture containing vitamin E succinate, a polyethylene glycol and optionally, a catalyst, in a solvent and heating the reaction mixture from room temperature, i.e., at or about 20° C., to an elevated temperature, and maintaining the elevated temperature for a period of time until a crude water-soluble vitamin E derivative mixture, for example, a crude TPGS composition, is formed that contains the desired amounts of TPGS monomer and TPGS dimer. The elevated temperature can be any temperature in the range of from 30° C. to about 300° C., generally between 80° C. and 250° C., such as between 100° C. and 200° C. The elevated temperature can be, for example, the boiling point of the solvent in the reaction mixture. A typical heating schedule can be heating the reaction mixture to a temperature of at least or about at least 110° C. with stirring, and once achieved, the elevated temperature, e.g., at least or about at least 110° C., is maintained for a total time of up to at or about 6.5 hours with stirring. Other heating temperatures and times can be used depending on the substrates, solvent and formation of the desired crude water-soluble vitamin E derivative mixture. For example, the total time the elevated temperature is maintained can be at least at or about 1 hour, at least at or about 1.5 hours, at least at or about 2 hours, at least at or about 2.5 hours, at least at or about 3 hours, at least at or about 3.5 hours, at least at or about 4 hours, at least at or about 4.5 hours, at least at or about 5 hours, at least at or about 5.5 hours, at least at or about 6 hours, or at least at or about 6.5 hours, or longer, before cooling.

After the elevated temperature has been maintained for the desired amount of time, e.g., the amount of time required to produce the desired amounts of TPGS monomer and TPGS dimer, the reaction mixture can be cooled to a temperature lower than the elevated temperature. For example, the reaction mixture can be cooled to room temperature, i.e., at or about 20° C., after heating at an elevated temperature for the desired amount of time. The reaction mixture can be heated to at least or about at least 110° C. for a total time of about 6.5 hours before cooling, e.g., to room temperature (i.e., at or about 20° C.), depending on the substrates, solvent and formation of the crude water-soluble vitamin E derivative mixture, for example, a crude TPGS composition, resulting in the desired amounts of TPGS monomer and TPGS dimer. One of skill in the art can perform the methods and, if necessary, empirically determine the appropriate reaction duration to produce the desired ratio of dimer to monomer, based on the formation of the desired amounts of TPGS monomer and TPGS dimer.

In the exemplary method, the reaction mixture can be heated from room temperature (i.e., at or about 20° C.) to an elevated temperature of at least at or about 30° C., 40° C., 50° C., 60° C., 70° C., 80° C., 90° C., 100° C., 105° C., 110° C., 115° C., 120° C., 125° C., 130° C., 140° C., 150° C., 155° C., 160° C., 165° C., 170° C., 175° C., 180° C., 185° C., 190° C., 195° C., 200° C., 205° C., 210° C., 215° C., 220° C., 225° C., 230° C., 235° C., 240° C., 245° C., 250° C., 255° C., 260° C., 265° C., 270° C., 275° C., 280° C., 285° C., 290° C., 295° C., 300° C., or higher. The reaction mixture can be maintained at a temperature elevated from room temperature for at least at or about 1 hour, 1.5 hours, 2 hours, 2.5 hours, 3 hours, 3.5 hours, 4 hours, 4.5 hours, 5 hours, 5.5 hours, 6 hours, 6.5 hours, or longer before cooling. In an exemplary method, the reaction mixture can be maintained at an elevated temperature for up to at or about 6.5 hours before cooling, e.g., to room temperature, i.e., at or about 20° C. The particular conditions depend upon the particular vitamin E derivative and the amount of monomer and dimer desired.

The amount of time that the reaction mixture is maintained at the temperature elevated from room temperature, for example, between or about between 30° C. and 300° C., such as the boiling point of the solvent in the reaction mixture, can be determined by monitoring the progress of reaction during heating. For example, the reaction mixture can be monitored during heating to determine the amounts of TPGS monomer and TPGS dimer present in the reaction mixture. The heating can then be terminated when the desired amounts of TPGS monomer and TPGS dimer are formed. The monitoring can be done by any method of monitoring a reaction known to those of skill in the art, such as by chromatography, spectroscopy or spectrometry. For example, the reaction can be monitored by thin layer chromatography (TLC), high performance liquid chromatography (HPLC), infrared spectroscopy (IR), Fourier transform infrared spectroscopy (FTIR), mass spectrometry (MS), nuclear magnetic resonance (NMR) spectroscopy, or any combination thereof. In some embodiments of the methods, the reaction progress is monitored by TLC. In other embodiments, the reaction progress is monitored by HPLC. In yet other embodiments, the reaction progress is monitored by both TLC and HPLC. One of skill in the art, if necessary, can determine particular parameters empirically, such as appropriate reaction duration, based on monitoring the formation of the desired amounts of vitamin E derivative monomer and dimer, such as TPGS monomer and TPGS dimer.

The reaction mixture can be heated to an elevated temperature under an inert gas atmosphere, such as a nitrogen gas or argon gas atmosphere, or under air. The reaction mixture can be heated to an elevated temperature at atmospheric pressure or at an elevated pressure, i.e., a pressure higher than atmospheric pressure. The elevated pressure can be achieved, e.g., by performing the reaction in a closed vessel or in a vented vessel.

The progress of the reaction can be terminated after heating for the desired amount of time, for example, up to at or about 6.5 hours, by cooling the reaction mixture, for example, to room temperature, i.e., at or about 20° C. After cooling, such as cooling to room temperature, i.e., at or about 20° C., the reaction mixture can be washed with an aqueous solution. The aqueous solution can be an aqueous solution of base, such as a weak base, i.e., bases that do not fully ionize in an aqueous solution. Suitable weak bases include, for example, carbonates or bicarbonates, e.g., sodium carbonate, sodium bicarbonate, potassium carbonate and potassium bicarbonate; amines, ammonias or ammoniums, e.g., methyl amine, methyl ethyl amine, dimethyl amine, aniline, ammonia, trimethyl ammonia and ammonium hydroxide; and pyridine. For example, the aqueous solution of base can be an aqueous solution of sodium bicarbonate. Suitable aqueous solutions of the weak base include solutions that contain, e.g., 1% to 20% weak base, such as at least or about 1%, 1.5%, 2%, 2.5%, 3%, 3.5%, 4%, 4.5%, 5%, 5.5%, 6%, 6.5%, 7%, 7.5%, 8%, 8.5%, 9%, 9.5%, 10%, 10.5%, 11%, 11.5%, 12%, 12.5%, 13%, 13.5%, 14%, 14.5%, 15%, 15.5%, 16%, 16.5%, 17%, 17.5%, 18%, 18.5%, 19%, 19.5%, 20%, or more, weak base. For example, the aqueous solution can be an aqueous solution containing at or about 10% sodium bicarbonate. After the aqueous solution of a weak base has been added to the reaction mixture, the aqueous solution can be separated from the reaction mixture, such as by allowing the reaction mixture and aqueous solution of weak base to separate into layers, and removed. In some embodiments, the reaction mixture and aqueous solution of weak base can be stirred for a period of time before separating. For example, the reaction mixture and aqueous solution can be stirred for 1 minute, 2 minutes, 3 minutes, 4 minutes, 5 minutes, 6 minutes, 7 minutes, 8 minutes, 9 minutes, 10 minutes, 15 minutes, 20 minutes, or more, before allowing the reaction mixture and aqueous solution of weak base to separate into layers.

(b) Processing the Reaction Mixture to Obtain a Crude Water-Soluble Vitamin E Derivative Mixture

After preparing the reaction mixture, the reaction mixture can be further processed in order to obtain a crude water-soluble vitamin E mixture, for example, a crude TPGS composition that contains less TPGS monomer, i.e., less than 70 wt %, and more TPGS dimer, i.e., more than 12 wt %, than known water-soluble vitamin E derivative mixtures. The further processing can be performed to remove impurities from the reaction mixture before obtaining the crude water-soluble vitamin E derivative mixture. The further processing can be performed in order to isolate the crude water-soluble vitamin E derivative mixture from the reaction mixture. For example, the reaction mixture can be further processed by treating the reaction mixture with an adsorbent, such as activated charcoal (i.e., activated carbon). Activated charcoal can be used as a decolorizer and to remove impurities by chemical adsorption. Any activated charcoal known to those of skill in the art can be used to treat the reaction mixture. Such activated charcoal is available from commercial sources under such trade names as Calgon-Type CPG®, Type PCB®, Type SGL®, Type CAL®, and Type OL®.

Further processing of the reaction mixture, for example, treating the reaction mixture with activated charcoal, can take place for a period of time of from at or about 0.5 hours to at or about 5 hours, or longer if required. For example, treating the reaction mixture with activated charcoal can take place for at least or about at least 0.5 hours, 1 hour, 1.5 hours, 2 hours, 3 hours, 4 hours, 5 hours, or longer. The further processing, for example, treating the reaction mixture with activated charcoal, can be done at any temperature of from at or about room temperature, i.e., at or about 20° C., to a temperature elevated from room temperature. For example, the temperature of the process, e.g., activated charcoal treatment, can be at or about 20° C., 30° C., 40° C., 50° C., 55° C., 60° C., 70° C., 80° C., 90° C., or 100° C., or any temperature between 20° C. and 100° C., such as between or about between 55° C. and 60° C. The treatment temperatures and times can be varied depending on the reaction mixture, the solvent, and the impurities present in the reaction mixture. In an exemplary process, such as an activated charcoal treatment process, the reaction mixture can be treated, e.g., with activate charcoal, for at least or about at least 1 hour at a temperature of between or about between 55° C. and 60° C., before cooling.

The reaction mixture can be filtered and washed after cooling, such as cooling to room temperature, i.e., at or about 20° C., after further processing, such as after treating the reaction mixture with activated charcoal. The reaction mixture can be filtered and washed, for example, to remove the activated charcoal from the reaction mixture. For example, the reaction mixture can be filtered through a filter aid, such as diatomaceous earth. Suitable filter aids for use in the methods include, for example, those sold under the trademark Celite®, such as those sold under the trademark Hyflo®. After filtering through a filter aid, such as diatomaceous earth, the reaction mixture can be washed, for example, with the same solvent used in the reaction mixture. In an exemplary embodiment, after further processing, e.g., treatment with activated charcoal, and cooling, e.g., to room temperature, i.e., at or about 20° C., the reaction mixture is filtered through diatomaceous earth, e.g., Hyflo® filter aid, and washed with solvent, e.g., toluene.

The reaction mixture can be further processed in order to isolate the crude water-soluble vitamin E derivative mixture from the reaction mixture. For example, the reaction mixture can be further processed by removing the solvent from the reaction mixture, i.e., concentrating the reaction mixture, in order to obtain a crude water-soluble vitamin E derivative mixture. Any method of removing a solvent from a reaction mixture known to those of skill in the art can be used, including, for example, vacuum distillation, rotary evaporation and filtration. Removing the solvent from the reaction mixture can be done at any temperature, for example at room temperature, i.e., 20° C., or at a temperature elevated from room temperature. For example, the solvent can be removed at a temperature of at or about 20° C., 30° C., 40° C., 50° C., 55° C., 60° C., 70° C., 80° C., or 90° C., but below or about below 100° C., such as below or about below 60° C. In an exemplary embodiment, the solvent can be removed from the reaction mixture by distillation, e.g., vacuum distillation, at a temperature elevated from room temperature, i.e., at or about 20° C., but below or about below 60° C.

Further processing of the reaction mixture of the methods can include further processing by treating the reaction mixture to remove impurities from the reaction mixture, such as by treating the reaction mixture with activated charcoal. Further processing of the reaction mixture of the methods can include further processing by removing the solvent from the reaction mixture, such as by removing the solvent by vacuum distillation. The further processing can include treating the reaction mixture with activated charcoal or removing the solvent from the reaction mixture or both. In an exemplary method, the further processing of the reaction mixture includes removing the impurities from the reaction mixture, e.g., treating the reaction mixture with activated charcoal, and removing the solvent from the reaction mixture, e.g., removing the solvent by vacuum distillation, in order to obtain a crude water-soluble vitamin E derivative mixture, for example, a crude TPGS composition, containing less TPGS monomer, i.e., less than 70 wt %, and more TPGS dimer, i.e., more than 12 wt %, than in known TPGS compositions.

(c) Purification of the Crude Water-Soluble Vitamin E Derivative Mixture to Obtain a Purified High Dimer-Containing Water-Soluble Vitamin E Derivative Mixture

The crude water-soluble vitamin E derivative mixture obtained after further processing can be further purified in order to obtain a purified high dimer-containing water-soluble vitamin E derivative mixture. High dimer water-soluble vitamin E derivative mixtures and their preparation are described in U.S. Pat. No. 9,351,517.

For example, the purified water-soluble vitamin E derivative mixture can be a PEG derivative of vitamin E, such as TPGS, PTS, PTD and other TPGS analogs and PEG derivatives of vitamin E, mixture. The mixture contains less TPGS monomer, i.e., less than 70 wt %, and more TPGS dimer, i.e., more than 12, 19, 24, 29 wt % dimer. The purification process removes impurities from the crude water-soluble vitamin E derivative mixture, such as impurities that were not removed by further processing of the reaction mixture. For example, the crude water-soluble vitamin E derivative mixture can be purified by performing one or more wash, i.e., extraction, steps. The wash can be performed using more than one solvent, such as more than one organic solvent, for example, two organic solvents that are not miscible with each other. For example, in the methods, the crude water-soluble vitamin E derivative mixture can be dissolved in a first solvent, for example, a polar solvent, such as an alcohol, and can be washed with a second solvent, for example, a non-polar solvent, such as a hydrocarbon solvent that is not miscible with the first solvent. The purification process, e.g., the wash, can be performed one time, two times, three times, four times, or more, depending on the desired purity level of the water-soluble vitamin E derivative mixture and the amount of impurities present. For example, the purification process, e.g., the wash, can be performed one or more times on the crude water-soluble vitamin E derivative mixture, e.g., after the crude water-soluble vitamin E derivative mixture is obtained after processing. In an exemplary method, the purification process can be performed three or more times on the crude water-soluble vitamin E derivative mixture after the further processing is complete.

The purification process, i.e., the wash, can be performed by dissolving the crude water-soluble vitamin E derivative mixture in a first solvent, for example, an organic solvent, such as a polar organic solvent. The polar organic solvent can be any solvent that can dissolve the crude water-soluble vitamin E derivative mixture, such as a polar protic solvent, for example, an alcohol, e.g., methanol, ethanol, propanol or butanol. In the methods, the amount of first solvent, e.g., polar organic solvent, used to dissolve the crude water-soluble vitamin E derivative mixture can be based on the ratio of the volume of the first solvent to the volume of the crude water-soluble vitamin E derivative mixture. The ratio of the volume of the first solvent to the volume of the crude water-soluble vitamin E derivative mixture can range from 0.1:1 to 10:1. In some embodiments, the ratio of the volume of the first solvent to the volume of the crude TPGS composition is or is about 0.1:1, 0.2:1, 0.25:1, 0.3:1, 0.4:1, 0.45:1, 0.5:1, 0.6:1, 0.7:1, 0.75:1, 0.8:1, 0.9:1, 1:1, 1.2:1, 1.25:1, 1.3:1, 1.4:1, 1.5:1, 1.6:1, 1.7:1, 1.75:1, 1.8:1, 1.9:1, 2:1, 2.5:1, 3:1, 3.5:1, 3.6:1, 4:1, 4.5:1, 5:1, 5.5:1, 6:1, 6.5:1, 7:1, 7.5:1, 8:1, 8.5:1, 9:1, 9.5:1, or 10:1 or more. For example, the ratio of the volume of the first solvent to the volume of the crude water-soluble vitamin E derivative mixture can be 2:1.

The wash can be performed using a second solvent, for example, an organic solvent, that is not miscible with the first solvent, i.e., the solvent used to dissolve the crude water-soluble vitamin E derivative mixture. The second solvent can be any solvent that is not miscible with the first solvent, for example, any solvent that is not miscible with a polar protic solvent such as an alcohol. Suitable organic solvents that can be used as a second solvent include non-polar organic solvents, such as hydrocarbons, e.g., alkanes and cycloalkanes, such as hexane and cyclohexane; halogenated hydrocarbons, e.g., chloroform and dichloromethane; ethers, e.g., diethyl ether; and aromatics, e.g., benzene and toluene. In the methods, the amount of second solvent, e.g., a non-polar organic solvent immiscible with the first solvent, used to wash the crude water-soluble vitamin E derivative mixture dissolved in the first solvent can be based on the ratio of the volume of the second solvent to the volume of the crude water-soluble vitamin E derivative mixture. The ratio of the volume of the second solvent to the volume of the crude water-soluble vitamin E derivative mixture can range from 0.1:1 to 10:1. In some embodiments, the ratio of the volume of second solvent to the volume of crude water-soluble vitamin E derivative mixture is or is about 0.1:1, 0.2:1, 0.25:1, 0.3:1, 0.4:1, 0.45:1, 0.5:1, 0.6:1, 0.7:1, 0.75:1, 0.8:1, 0.9:1, 1:1, 1.2:1, 1.25:1, 1.3:1, 1.4:1, 1.5:1, 1.6:1, 1.7:1, 1.75:1, 1.8:1, 1.9:1, 2:1, 2.5:1, 3:1, 3.5:1, 3.6:1, 4:1, 4.5:1, 5:1, 5.5:1, 6:1, 6.5:1, 7:1, 7.5:1, 8:1, 8.5:1, 9:1, 9.5:1, or 10:1 or more. For example, the ratio of the volume of the second solvent to the volume of the crude water-soluble vitamin E derivative mixture can be 3:1.

The purification process, for example, a wash with organic solvent, can be performed one or more times on the crude water-soluble vitamin E derivative mixture, for example, two times, three times, four times, or more. The wash can be performed while stirring. In an exemplary method, the crude water-soluble vitamin E derivative mixture can be dissolved in a first solvent, for example, a protic polar organic solvent, e.g., an alcohol, and washed three or more times with a second solvent, for example, a non-polar organic solvent not miscible in the first solvent, e.g., a hydrocarbon.

Exemplary is a method of purifying a crude water-soluble vitamin E derivative mixture by performing a purification process, such as a wash with an organic solvent, e.g., by dissolving the crude water-soluble vitamin E derivative mixture in methanol and washing with cyclohexane, and repeating the wash with the cyclohexane three or more times.

The crude water-soluble vitamin E derivative mixture can be further purified in order to obtain a purified water-soluble vitamin E derivative mixture, for example, a purified TPGS composition. The purified water-soluble vitamin E derivative mixture can be a purified TPGS composition that contains less TPGS monomer, i.e., less than 70 wt %, and more TPGS dimer, i.e., more than 12 wt %, than known TPGS compositions. The further purification can be performed to remove impurities from the crude water-soluble vitamin E derivative mixture. The further purification can be performed in order to isolate the purified water-soluble vitamin E derivative mixture from the first solvent. For example, the crude water-soluble vitamin E derivative mixture can be further purified by treating the crude water-soluble vitamin E derivative mixture with an adsorbent, such as activated charcoal (i.e., activated carbon). Activated charcoal can be used as a decolorizer and to remove impurities by chemical adsorption. Any activated charcoal known to those of skill in the art can be used to treat the crude water-soluble vitamin E derivative mixture. Such activated charcoal is available from commercial sources under such trade names as Calgon-Type CPG®, Type PCB®, Type SGL®, Type CAL®, and Type OL®.

Further purification of the crude water-soluble vitamin E derivative mixture, for example, treating the crude water-soluble vitamin E derivative mixture with activated charcoal, can take place for a period of time of from at or about 0.5 hours to at or about 5 hours, or longer if required. The crude water-soluble vitamin E derivative mixture to be treated can be dissolved in a solvent, for example, the first solvent used in the wash described above. Additional solvent can be added, for example, the same solvent used to dissolve the crude water-soluble vitamin E derivative mixture during the wash, e.g., a polar protic organic solvent. In the methods, the amount of additional solvent, e.g., polar protic organic solvent, added to the crude water-soluble vitamin E derivative mixture can be based on the ratio of the total volume of the solvent, e.g., the first solvent, such as a polar protic organic solvent, plus the additional solvent, to the volume of the crude water-soluble vitamin E derivative mixture. The ratio of the total volume of the first solvent plus the additional solvent to the volume of the crude TPGS composition can range from 0.1:1 to 10:1. In some embodiments, the ratio of the volume of total solvent to the volume of crude water-soluble vitamin E derivative mixture is or is about 0.1:1, 0.2:1, 0.25:1, 0.3:1, 0.4:1, 0.45:1, 0.5:1, 0.6:1, 0.7:1, 0.75:1, 0.8:1, 0.9:1, 1:1, 1.2:1, 1.25:1, 1.3:1, 1.4:1, 1.5:1, 1.6:1, 1.7:1, 1.75:1, 1.8:1, 1.9:1, 2:1, 2.5:1, 3:1, 3.5:1, 3.6:1, 4:1, 4.5:1, 5:1, 5.5:1, 6:1, 6.5:1, 7:1, 7.5:1, 8:1, 8.5:1, 9:1, 9.5:1, or 10:1 or more. For example, the ratio of the total volume of the first solvent plus additional solvent to the volume of the crude water-soluble vitamin E derivative mixture can be 5:1.

Further purification, such as treating the reaction mixture with, for example, activated charcoal, can take place for at least or about at least 0.5 hours, 1 hour, 1.5 hours, 2 hours, 3 hours, 4 hours, 5 hours, or longer. The further purification, for example, treating the reaction mixture with activated charcoal, can be done at any temperature of from at or about room temperature, i.e., at or about 20° C., to a temperature elevated from room temperature. For example, the temperature of the purification process, e.g., activated charcoal treatment, can be at or about 20° C., 30° C., 40° C., 50° C., 55° C., 60° C., 70° C., 80° C., 90° C., or 100° C., or any temperature between 20° C. and 100° C., such as between or about between 55° C. and 60° C. The treatment temperatures and times can be varied depending on the nature of the crude water-soluble vitamin E derivative mixture, the solvent, and the impurities present in the crude water-soluble vitamin E derivative mixture. In an exemplary purification process, such as an activated charcoal treatment process, the crude water-soluble vitamin E derivative mixture can be treated, e.g., with activate charcoal, for at least or about at least 1 hour ata temperature of between or about between 55° C. and 60° C., before cooling.

The crude water-soluble vitamin E derivative mixture can be filtered and washed after cooling, such as cooling to room temperature, i.e., at or about 20° C., after further purification, such as after treating the crude water-soluble vitamin E derivative mixture with activated charcoal. The crude water-soluble vitamin E derivative mixture, for example, the crude water-soluble vitamin E derivative mixture dissolved in a solvent, can be filtered and washed, for example, to remove the activated charcoal from the crude water-soluble vitamin E derivative mixture. For example, the crude water-soluble vitamin E derivative mixture, for example, the crude water-soluble vitamin E derivative mixture dissolved in a solvent, can be filtered through a filter aid, such as diatomaceous earth. Suitable filter aids for use in the methods include, for example, those sold under the trademarks Celite® and Hyflo®. After filtering through a filter aid, such as diatomaceous earth, the crude TPGS composition can be washed, for example, with the same solvent used to dissolve the crude water-soluble vitamin E derivative mixture, e.g., the first solvent. In an exemplary embodiment, after further purification, e.g., treatment with activated charcoal, and cooling, e.g., to room temperature, i.e., at or about 20° C., the crude water-soluble vitamin E derivative mixture is filtered through diatomaceous earth, e.g., Hyflo® filter aid and washed with solvent, e.g., methanol.

The crude water-soluble vitamin E derivative mixture can be further purified in order to isolate the purified water-soluble vitamin E derivative mixture from the solvent, e.g., the first solvent. For example, the crude water-soluble vitamin E derivative mixture can be further purified by removing the solvent from the water-soluble vitamin E derivative mixture dissolved in solvent, i.e., concentrating the crude water-soluble vitamin E derivative mixture, in order to obtain a purified water-soluble vitamin E derivative mixture. Any method of removing a solvent from a composition known to those of skill in the art can be used, including, for example, vacuum distillation, rotary evaporation and filtration. Removing the solvent from the water-soluble vitamin E derivative mixture can be done at any temperature, for example at room temperature, i.e., 20° C., or at a temperature elevated from room temperature. For example, the solvent can be removed at a temperature of at or about 20° C., 30° C., 40° C., 50° C., 55° C., 60° C., 70° C., 80° C., or 90° C., but below or about below 100° C., such as below or about below 60° C. In an exemplary embodiment, the solvent can be removed from the crude water-soluble vitamin E derivative mixture by distillation, e.g., vacuum distillation, at a temperature elevated from room temperature, i.e., at or about 20° C., but below or about below 60° C. After removing the solvent, the purified water-soluble vitamin E derivative mixture can be dried by any method of drying known to those of skill in the art. Suitable methods of drying include drying under an inert gas, for example, nitrogen or argon, or drying under vacuum, or any combination thereof.

Further purification of the crude water-soluble vitamin E derivative mixture produced by the exemplified method can include further purification by treating the crude water-soluble vitamin E derivative mixture to remove impurities from the reaction mixture, such as by treating the crude water-soluble vitamin E derivative mixture with activated charcoal. Further purification of the crude water-soluble vitamin E derivative mixture produced by the exemplified method can include further purification by removing the solvent from the crude water-soluble vitamin E derivative mixture, for example, a crude water-soluble vitamin E derivative mixture dissolved in a solvent, such as by removing the solvent by vacuum distillation. The further purification can include treating the crude water-soluble vitamin E derivative mixture with activated charcoal or removing the solvent from the crude water-soluble vitamin E derivative mixture or both. In an exemplary method, the further purification of the crude water-soluble vitamin E derivative mixture includes removing the impurities from the crude water-soluble vitamin E derivative mixture, e.g., treating the crude water-soluble vitamin E derivative mixture with activated charcoal, and removing the solvent from the crude water-soluble vitamin E derivative mixture, e.g., removing the solvent by vacuum distillation, in order to obtain a purified water-soluble vitamin E derivative mixture, for example, a purified TPGS composition. The purified TPGS composition can contain less TPGS monomer, i.e., less than 70 wt %, and more TPGS dimer, i.e., more than 12 wt %, than in known TPGS compositions.

The exemplified methods yield a purified water-soluble vitamin E derivative mixture, such as a purified TPGS composition, with the desired amount of dimer (greater than 12%) that can be used in any application where water-soluble vitamin E derivative mixtures are used, such as in food, beverage, pharmaceutical or nutraceutical products for human consumption, and particularly to prepare the emulsions herein that contain the water-soluble vitamin E derivative composition and a non-polar ingredient(s) and other optional ingredients. For example, a purified water-soluble vitamin E derivative mixture, such as a purified TPGS composition, for example, a TPGS composition that contains less TPGS monomer, i.e., less than 70 wt %, and more TPGS dimer, i.e., more than 12 wt %, than in known TPGS compositions, that can be used in products for human consumption, for example, food and beverage products, particularly aqueous food and beverage products, and any other application in which a water-soluble vitamin E derivative mixture can be added, is produced. Exemplary purified water-soluble vitamin E derivative mixtures (compositions) that can be prepared following the exemplified methods are those that contain less than 70 wt % monomer and more than 12 wt % dimer, such as such as compositions containing between or about between 25 wt % and 69 wt % monomer and between or about between 13 wt % and 95 wt % dimer, such as compositions containing between or about between 40 wt % and 60 wt % monomer and between or about between 25 wt % to 60 wt % dimer. For example, the methods can be followed to obtain water-soluble vitamin E derivative mixtures (compositions) that contain between or about between 25 wt % and 69 wt % monomer, for example, at or about 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68 or 69 wt % monomer and between or about between 13 wt % and 95 wt % dimer, for example, at or about 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94 or 95 wt % dimer.

These methods are described with reference to TPGS and can be adapted to produce any higher dimer-containing water-soluble vitamin E derivative composition. Other methods to produce compositions with the desired dimer or dimer and monomer concentrations can be employed, including purifying dimer from standard preparations and adding the dimer back to a standard preparation to increase its concentration. The resulting compositions can be employed in the emulsions described herein.

2. PEG-Free PEG-Derivatives of Vitamin E

It found herein that use of a pegylated derivative of vitamin E in which the free PEG moieties to have been removed to produce emulsions results in larger particles in the emulsion. The free PEG moieties can act as a co-emulsifier to thereby produces a smaller particle size. The emulsions provided herein, made with pegylated derivative of vitamin E that have free PEG moieties or in which the free PEG moieties have been removed have a particle size greater than 5 μm. The emulsion prepared using the PEG-free pegylated derivative of vitamin E have larger particles on average.

All pegylated vitamin E derivatives can be prepared or purified so that the resulting pegylated derivative of vitamin E is free or substantially free of free-PEG contaminants in the preparation. Removal of free PEG moieties can be accomplished by any suitable method, such as, but not limited to, ion exchange chromatograph (see, e.g., Yun et al. (2005) J. Biotechnology 118:67-74). For example, PEGylated protein can be separated from unPEGylated protein using SP-Sepharose Fast Flow cation-exchange media (2.6 cm×10 cm). In some examples, two consecutive ion-exchange chromatographic separation steps are used. After elution, individual fractions can be analyzed by SDS-PAGE.

3. Other Surfactants

The emulsions contain one or more surfactants. In place of or in addition to the PEG-derivative of vitamin E surfactants, other surfactants can be used. The total amount of surfactant in the composition are less than 2% by weight, generally, less than 1.5% or less than 1%, such as about 0.5-0.8%, such as 0.67% by weight. The surfactant and amount is selected so that the particle size distribution is greater than 3 such as distribution of about 5 μM to 10 μM.

In the provided methods for producing the emulsions, the surfactant is added to the water phase, the oil phase, or to the water and the oil phase. The emulsions further can contain one or more co-surfactants or emulsifiers. Typically, the surfactants are natural surfactants, for example, a surfactant that is G.R.A.S. (generally recognized as safe) by the FDA and/or Kosher certified. In an exemplary embodiment, the surfactant is a sugar-derived surfactant, for example, a sugar fatty acid ester, e.g., sucrose fatty acid ester.

The surfactants aggregate in aqueous liquids, such as in the provided emulsions to form micelles, which contain the non-polar compounds. The hydrophilic portions of the surfactant molecules are oriented toward the outside of the micelle, in contact with the aqueous medium, while the hydrophobic portions of the surfactant molecules are oriented toward the center of the micelle, in contact with the non-polar compounds, which are contained in the center of the micelle. The micelles can contain more than one surfactant and/or co-surfactant. Properties of the provided compositions, for example, the particle size of the composition and desirable properties related to the particle size, are influenced by the choice of surfactant and the relative amount (concentration) of surfactant. For example, the HLB of the surfactant can affect particle size, clarity, taste, smell, crystal formation and other properties of the emulsions, and herein are selected to provide relatively large particles, and are added to the compositions in relatively low concentration. Surfactants (and co-surfactants) are molecules that contain hydrophobic and hydrophilic portions. In one example, the hydrophobic portion is a hydrophobic tail and the hydrophilic portion is a hydrophilic head of the surfactant molecule.

The HLB value of a surfactant is derived from a semi-empirical formula; HLB values are used to index surfactants according to their relative hydrophobicity and hydrophilicity. An HLB value is a numerical representation of the relative representation of hydrophilic groups and hydrophobic groups in a surfactant or mixture of surfactants. The weight percent of these respective groups indicates properties of the molecular structure. See, for example, Griffin, W. C. J. Soc. Cos. Chem. 1:311 (1949).

Surfactant HLB values range from 1-45, while the range for non-ionic surfactants typically is from 1-20. The more lipophilic a surfactant is, the lower its HLB value. Conversely, the more hydrophilic a surfactant is, the higher its HLB value. Lipophilic surfactants have greater solubility in oil and lipophilic substances, while hydrophilic surfactants dissolve more easily in aqueous liquids. In general, surfactants with HLB values greater than 10 or greater than about 10 are called “hydrophilic surfactants,” while surfactants having HLB values less than 10 or less than about 10 are referred to as “hydrophobic surfactants.” HLB values are known for a number of surfactants.

Exemplary of surfactants that can be used in the provided methods and compositions are surfactants having an HLB value of between 12 or about 12 and 20 or about 20, for example, 12, 13, 14, 15, 16, 17, 18, 19, 20, about 12, about 13, about 14, about 15, about 16, about 17, about 18, about 19 or about 20.

The surfactants typically are, and typically have an HLB value between at or about 12 and at or about 20. Particular examples of suitable surfactants for use in the provided compositions include non-ionic surfactants, such as sugar derived surfactants, including fatty acid esters of sugars and sugar derivatives. For example, sugar fatty acid esters include fatty acid esters of sucrose, glucose, maltose and other sugars, esterified to fatty acids of varying lengths (e.g., varying numbers of carbons). The fatty acids typically have carbon chains between 8 and 28 carbons in length, and typically between 8 and 20, or between 8 and 18 or between 12 and 18, such as, but not limited to, stearic acid (18 carbons), oleic acid (18 carbons), palmitic acid (16 carbons), myristic acid (14 carbons) and lauric acid (12 carbons). Typically, the sugar ester surfactants are sucrose ester surfactants, typically sucrose fatty acid ester surfactants.

Sucrose Fatty Acid Ester Surfactants

Sucrose fatty acid ester surfactants contain one or more sucrose fatty acid esters, which are non-ionic surfactants that contain sucrose in the hydrophilic portions and fatty acids in the hydrophobic portions. The sucrose fatty acid esters can be made by well-known methods (see, for example, U.S. Pat. Nos. 3,480,616, 3,644,333, 3,714,144, 4,710,567, 4,898,935, 4,996,309, 4,995,911, 5,011,922 and 5,017,697 and International Patent Application Publication No. WO 2007/082149), typically in an esterification reaction as described below.

Because sucrose contains eight hydroxy (—OH) groups, the esterification reaction can join the sucrose molecule to one fatty acid molecule, or can join it to a plurality of, fatty acid molecules, producing different degrees of esterification, e.g., mono-, di-, tri- and poly- (up to octa-) fatty acid esters, but primarily mono-, di-, and/or tri-esters. The degree of esterification can depend on conditions of esterification. The esterification reaction can be carried out with a single type of fatty acid, or a plurality of fatty acids, such as fatty acids with varying carbon chain lengths, branched and linear fatty acids, and/or saturated or unsaturated fatty acids. The esterification reaction with a single fatty acid can produce a single ester, and typically forms more than one ester, such as mono- di-, tri- and/or poly-esters, formed from one reaction. The relative amounts of mono- di- tri- and/or poly-esters can depend on reaction conditions.

The fatty acid in the sucrose fatty acid ester can be any fatty acid, and can contain between 4 and 28 carbon atoms, typically between 8 and 28 carbon atoms, and typically between 8 and 25 carbon atoms, such as between 8 and 18 carbon atoms, such as 8, 9, 10, 11, 12, 13, 14, 15, 16, 17 and 18 carbon atoms. The fatty acid can be synthetic or naturally occurring, and include linear and branched fatty acids. The fatty acids include, but are not limited to, myristic acid, palmitic acid, stearic acid, oleic acid, caproic acid, capric acid, myristic acid, decanoic acid and pelargonic acid.

Thus, the sucrose fatty acid ester surfactants include sucrose monoesters, diesters, triesters and polyesters, and mixtures thereof, and typically contain sucrose monoesters. The sucrose fatty acid ester surfactants include single fatty acid esters and also include homogeneous mixtures of sucrose esters, containing members with different lengths of fatty acid carbon chain and/or members with different degrees of esterification. For example, the sucrose fatty acid ester surfactants include mixtures of monoesters, diesters, triesters, and/or polyesters. The sugar ester surfactants further include sucrose fatty acid ester analogs and homologs and mixtures thereof.

Sucrose fatty acid esters are compounds having the following formula shown below:

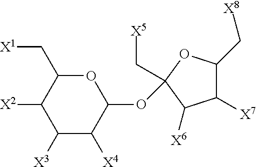

where each of X¹, X², X³, X⁴, X⁵, X⁶, X⁷ and X⁸ independently is:

a hydroxyl (—OH) group, or

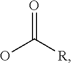

where:

each R is an alkyl group having 3-27 carbon atoms; and

when more than one of X¹, X², X³, X⁴, X⁵, X⁶, X⁷ and X⁸ is

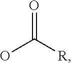

each R can be a different alkyl group (e.g., having different number of carbon atoms and/or different saturation), or can be the same alkyl group.

Typically, in the provided sucrose fatty acid ester surfactants, each R has between 7 and 27 carbon atoms, and typically between 7 and 19 atoms, such as 7, 8, 9, 10, 11, 12, 13, 14, 15, 16, 17, 18, or 19 carbon atoms or between 7 and 17 carbon atoms.

Typically, the sucrose fatty acid ester surfactants contain sucrose fatty acid monoesters, having the structure set forth below, where one of X¹, X², X³, X⁴, X⁵, X⁶, X⁷ and X⁸ (typically X¹) is

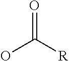

and the other seven of X¹, X², X³, X⁴, X⁵, X⁶, X⁷ and X⁸ are each, independently, —OH. An exemplary monoester has the following structure:

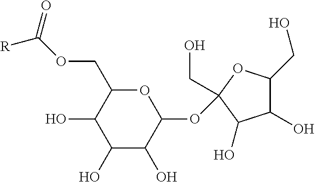

where R is an alkyl group having 3-27 carbons, and typically 7-27 carbons.

The sucrose fatty acid esters include blends of sucrose fatty acid esters, which typically include monoesters, and can also include diesters, triesters and polyesters, which have structures according to Scheme V, above, where two (diesters), three (triesters) or more (polyesters) of X¹, X², X³, X⁴, X⁵, X⁶, X⁷ and X⁸, (and typically X¹ and X⁸) independently, are

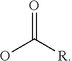

In general, sucrose fatty acid esters, including mixtures of sucrose fatty acid esters, can have varying HLB values, such as HLB values ranging from at or about 1 to at or about 20. The HLB value of the sucrose fatty acid ester generally depends on the degree of esterification (e.g., the average degree of esterification in a mixture of different esters). Typically, the lower the degree of esterification (e.g., average degree), the higher the HLB value of the sucrose fatty acid ester or mixture thereof. Exemplary sucrose esters include sucrose distearate (HLB=3), sucrose distearate/monostearate (HLB 12), sucrose dipalmitate (HLB=7.4); sucrose monostearate (HLB=15), sucrose monopalmitate (HLB>10); Sucrose monolaurate (HLB 15). Typically, the sucrose fatty acid ester surfactants in the provided compositions have an HLB value of between at or about 14 and at or about 20, such as at or about 14, 15, 16, 17, 18, 19, or 20, and typically between at or about 14 and at or about 18, such as, but not limited to, HLB values of at or about 15, 16 and 17, such as, for example, sucrose ester surfactants including sucrose monopalmitate, sucrose monolaurate and sucrose monostearate.

The sugar ester surfactants include sucrose ester blends, for example, sucrose ester mixtures containing a specified amount (e.g., percent, by weight) of sucrose monoesters. Exemplary surfactants include sucrose ester mixtures having at least at or about 50%, by weight (w/w), monoester, such as at or about or at least at or about 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100%, by weight (w/w), sucrose monoesters, and typically at least at or about 60%, by weight or at least at or about 70%, by weight (w/w), monoesters. The surfactants include mixtures of sucrose esters containing at least at or about 50% sucrose monoesters, mixtures of sucrose esters containing at least at or about 60% sucrose monoesters, mixtures of sucrose esters containing at least at or about 70% sucrose monoesters, mixtures of sucrose esters containing at least at or about 80% sucrose monoesters, and mixtures of sucrose esters containing at least at or about 90% sucrose monoesters, for example, mixtures containing at or about 72% sucrose monoesters, at or about 61% sucrose monoesters, or at or about 90% sucrose monoesters.

The sucrose fatty acid ester surfactants include sucrose fatty acid monoesters, such as sucrose monocaprylate, sucrose monodecanoate, sucrose monolaurate, sucrose monomyristate, sucrose monopalmitate, sucrose monostearate, sucrose monopelargonate, sucrose monoundecanoate, sucrose monotridecanoate, sucrose monopentadecanoate and sucrose monoheptadecanoate. The sucrose fatty acid esters further include mixtures containing varying percentages of monoesters, diesters, triesters and polyesters, such as, but not limited to, a mixture having at or about 72% monoesters, 23% diesters, 5% triesters and 0% polyesters; a mixture having at or about 61% monoesters, 30% diesters, 7% triesters, and 2% polyesters; and a mixtures having at or about 52% monoesters, 36% diesters, 10% triesters and 2% polyesters.

The sucrose fatty acid ester surfactants include sucrose fatty acid esters sold under the trade name DK Ester®, produced by Dai-Ichi Kogyo Seiyaku Co., Ltd of Japan (which, in some examples, can be produced according to the methods described in U.S. Pat. Nos. 4,898,935, 4,996,309, 4,995,911, 5,011,922 and 5,017,697, and distributed through Montello Inc., Tulsa, Okla., such as the F-160 and F-140 grade esters sold under the trade name DK Ester®, and sucrose esters sold under the trade name SURFHOPE® SE PHARMA, by Mitsubishi-Kagaku Foods Corporation, distributed by Mitsubishi Chemical Performance Polymers, Inc. These sucrose fatty acid esters are mixtures of esters with different degrees of esterification. The sucrose fatty acid esters further include Ryoto sugar esters, which are food-grade esters sold by Mitsubishi-Kagaku Foods Corporation, distributed by Mitsubishi Chemical Performance Polymers, Inc. Exemplary sucrose fatty acid esters sold under the trade name DK Ester®, and those sold under the trade name SURFHOPE® SE PHARMA and Ryoto sugar esters, are listed in the table below. The table lists the average degree of esterification or the fatty acid composition within the mixture, and the HLB of the sucrose fatty acid ester surfactant. Any of the surfactants in the table below can be used. Typically, the surfactant (e.g., a surfactant listed in the table below), has an HLB value between at or about 12 and at or about 20, typically between at or about 15 and at or about 18, e.g., but not limited to, those surfactants in the table having an HLB of 15 or 16, such as the sucrose fatty acid ester surfactant sold under the name DK ESTER® F-160, produced by Dai-Ichi Kogyo Seiyaku Co., Ltd of Japan, and distributed through Montello Inc., Tulsa, Okla. Other exemplary sucrose fatty acid ester surfactants are described in Youan et al., AAPS PharmaSci 2003; 5(2) Article 22; 1-9 and in Okamoto et al., Biol. Pharm. Bull. 28(9): 1689-1694 (2005).

Exemplary Sucrose Fatty Acid Ester (SFAE) Surfactants

| | Average | | | |
|---|---|---|---|---|
| Sucrose Fatty | Degree of | Fatty acid | | Distribution (by weight) |
| Acid Ester | Esterification | composition | H.L.B. | of Ester Mono:Di:Tri:Poly |
| DK Ester ® F-160 | 1.23 | | 16 | 72% monoester; 23% |
| | | | | diester; 5% triester |
| DK Ester ® F-140 | 1.35 | | 13 | 61% monoester; 30% |
| | | | | diester; 7% triester; 2% |
| | | | | polyester |
| DK Ester ® F-110 | 1.48 | | 11 | 52% monoester; 36% |
| | | | | diester; 10% triester; 2% |
| | | | | polyester |
| DK Ester ® F-90 | 1.53 | | 9.5 | 45% monoester; 39% |
| | | | | diester; 12% triester; 4% |
| | | | | polyester |
| DK Ester ® F-70 | 1.60 | | 8 | 39% monoester; 45% |
| | | | | diester; 12% triester; 4% |
| | | | | polyester |
| DK Ester ® F-50 | 1.69 | | 6 | 34% monoester; 46% |
| | | | | diester; 17% triester; 3% |
| | | | | polyester |
| DK Ester ® F-20W | 3.11 | | 2 | 11% monoester; 21% |
| | | | | diester; 14% triester; 54% |
| | | | | polyester |
| DK Ester ® F-10 | 4.85 | | 1 | 0% monoester; 5% diester; |
| | | | | 11% triester; 84% |
| | | | | polyester |
| SURFHOPE ® SE | | C12 (100%) | 5 | 32% monoester; |
| PHARMA | | | | 68% di-/tri-/poly-esters |
| J-1205 | | | | |
| SURFHOPE ® SE | | C12 (100%) | 16 | 81% monoester; |
| PHARMA | | | | 19% di-/tri-/poly-esters |
| J-1216 | | | | |
| SURFHOPE ® SE | | C16 (80%); | 16 | 79% monoester; |
| PHARMA | | C18 (20%) | | 21% di-/tri-/poly-esters |
| J-1616 | | | | |
| SURFHOPE ® SE | | C16 (70%); | 5 | 30% monoester; |
| PHARMA | | C18 (30%) | | 70% di-/tri-/poly-esters |
| J-1805 | | | | |
| SURFHOPE ® SE | | C16 (70%); | 7 | 41% monoester; |
| PHARMA | | C18 (30%) | | 59% di-/tri-/poly-esters |
| J-1807 | | | | |
| SURFHOPE ® SE | | C16 (70%); | 16 | 75% monoester; |
| PHARMA | | C18 (30%) | | 25% di-/tri-/poly-esters |
| J-1816 | | | | |
| SURFHOPE ® SE | | Sucrose | 3 | Approximately 20% |
| PHARMA | | stearate | | monoester; approximately |
| D-1803 | | (approximately | | 80% di-/tri-/poly-esters |
| | | 70% stearate) | | |
| SURFHOPE ® SE | | Sucrose | 3 | 20% monoester; |
| PHARMA | | stearate (70% | | 80% di-/tri-/poly-esters |
| D-1803F | | stearate) | | |
| SURFHOPE ® SE | | Sucrose | 5 | 30% monoester; |
| PHARMA | | stearate (70% | | 70% di-/tri-/poly-esters |
| D-1805 | | stearate) | | |
| SURFHOPE ® SE | | Sucrose | 7 | 40% monoester; |
| PHARMA | | stearate (70% | | 60% di-/tri-/poly-esters |
| D-1807 | | stearate) | | |
| SURFHOPE ® SE | | Sucrose | 9 | 50% monoester; |
| PHARMA | | stearate (70% | | 50% di-/tri-/poly-esters |
| D-1809 | | stearate) | | |
| SURFHOPE ® SE | | Sucrose | 11 | 55% monoester; |
| PHARMA | | stearate (70% | | 45% di-/tri-/poly-esters |
| D-1811 | | stearate) | | |
| SURFHOPE ® SE | | Sucrose | 11 | 55% monoester; |
| PHARMA | | stearate (70% | | 45% di-/tri-/poly-esters |
| D-1811F | | stearate) | | |
| SURFHOPE ® SE | | Sucrose | 15 | 70% monoester; |
| PHARMA | | stearate (70% | | 30% di-/tri-/poly-esters |
| D-1815 | | stearate) | | |
| SURFHOPE ® SE | | Sucrose | 16 | 75% monoester; |
| PHARMA | | stearate (70% | | 25% di-/tri-/poly-esters |
| D-1816 | | stearate) | | |
| SURFHOPE ® SE | | Sucrose | 15 | 70% monoester; |
| PHARMA | | palmitate (80% | | 30% di-/tri-/poly-esters |
| D-1615 | | palmitate) | | |
| SURFHOPE ® SE | | Sucrose | 16 | 80% monoester; |
| PHARMA | | palmitate (80% | | 20% di-/tri-/poly-esters |
| D-1616 | | palmitate) | | |
| SURFHOPE ® SE | | Sucrose | 16 | 80% monoester; |
| PHARMA | | laurate (95% | | 20% di-/tri-/poly-esters |
| D-1216 | | laurate) | | |
| Ryoto S-970 | | Sucrose | 9 | 50% monoester |
| | | stearate | | |
| Ryoto S-1170 | | Sucrose | 11 | 55% monoester |
| | | stearate | | |
| Ryoto S-1570 | | Sucrose | 15 | 70% monoester |
| | | stearate | | |
| Ryoto S-1670 | | Sucrose | 16 | 75% monoester |
| | | stearate | | |
| Ryoto P-1570 | | Sucrose | 15 | 70% monoester |
| | | palmitate | | |
| Ryoto P-1670 | | Sucrose | 16 | 80% monoester |
| | | palmitate | | |
| Ryoto LWA-1570 | | Sucrose | 15 | 70% monoester |
| | | laurate | | |
| Ryoto L-1695 | | Sucrose | 16 | 80% monoester |
| | | laurate | | |
| Ryoto OWA-1570 | | Sucrose oleate | 15 | 70% monoester |

In all instances, the amount of surfactant is low, less than 2%, 1.5%, 1% by weight as described above. The goal is to produce large particles in a stable emulsion. This is achieved using the low amount of surfactant and the nut butter/whey proteins.

### E. OILS

The oils for use in the compositions include any oil obtained from a natural or synthetic source that is suitable for consumption by a subject. Oils suitable for administration to subjects, including humans, are known. Any such oil can be used. The oil can be of vegetable or animal origin. The oil phase also can be synthetic or semisynthetic oils that are nontoxic to a subject Exemplary of oils for use herein include, but are not limited to mono-, di- and triglycerides, fatty acids, such as oleic, linoleic, palmitic, stearic, conjugated forms thereof and their esters, ethers and esters of propylene glycol and other polyols. The oil phase in the emulsion provided herein can contain any nontoxic oil, biocompatible oil, which includes, but is not limited to mono-, di- and triglycerides, fatty acids and their esters, ethers and esters of propylene glycol or other polyols. The fatty acids and esters (used as such or where they form part of a glyceride) can be short chain, medium chain or long chain. Exemplary oils include, but are not limited to, vitamin E oil, flaxseed oil, CLA, borage oil, rice bran oil, d-limonene, canola oil, corn oil, MCT oil, and oat oil. Other oils also can be used.

In certain embodiments, the oils are short, medium or long chain triglycerides. In certain embodiments, the oils are medium chain triglycerides (MCTs). In certain embodiments, the MCT is tricaprylic triglyceride ester (also known as Neobee® M5). Exemplary sources for oils contemplated herein include, but are not limited to All Spice, Almond, Anise, Apple, Apricot, Avocado, Basil, Bayberry, Benzoin, Bergamot, Borage Seed, Cajeput, Calendula, Canola, Carnation, Carrot seed, Cassia bark, Castor, Cayenne, Cedarwood, Chamomile, Cinnamon, Citronella, Conjugated Linolenic Acid, Clary sage, Clove bud, Coconut, Cod Liver, Corn, Cranberry, Cypress, Evening Primrose, Eucalyptus, Evergreen, Fir, Fish 18:12, Flax Seed, Frangipani, Frankincense, Freesia, Gardenia, Ginger, Grape Seed, Grapefruit, Heather, Honeysuckle, Hyacinth, Jasmine, Jojoba, Juniper berry, Lavender, Lecithin, Lemon, Lemon balm, Lemon, verbena, Lemongrass, Lilac, Lily of the valley, Lime, Magnolia, MCT, Menthol, Mulberry, Musk, Myrrh Oat, Olive, Orange, Oregano, Palm, Patchouli, Peach, Pennyroyal, Peppermint, Petitgrain, Pine, Pumpkin Seed, Rice Bran, Rose, Rosemary, Rosewood, Safflower, Sage, Salmon, Sandalwood, Sesame, Shark Liver, Soy Bean, Spearmint, Squalene, Strawberry, Sunflower, Tangerine, Tea tree, Thuja (Cedar leaf), Thyme, Tuna, Vanilla, Vitamin E, Wheat Germ, Wintergreen and Ylang ylang. In certain embodiments, the oil phase contains oat oil and tri caprylic triglyceride ester (also known as Neobee® M5).

The oil is present in an amount sufficient to dissolve the oil soluble ingredients in the composition, and is generally in an amount of about, by weight, of 10%-45%, such as 12% to 36%, or 15%-45%, or 10%-35%.

The oil phase ingredients, such as those used in the Examples (below), include medium-chain triglycerides (MCT) Oil or Conjugated Linoleic Acids (CLA) and additional oil phase ingredients, such as: CBD oil, pH Adjuster 1, edible acid such as citric acid, organic sunflower oil, TPGS, Canola Oil, potassium bicarbonate (pH adjuster), Hemp Oil, fish oil, and/or algal oil, where indicated.

### F. NON-POLAR COMPOUNDS

The emulsions provided herein contain one or more non-polar ingredients, where the ingredient is a non-polar compound or contains one or more non-polar compounds. The non-polar active compounds are present in an amount generally less than 5%, such as less than 1%, 2%, 3%, 4%, by weight, particularly in the emulsions intended for direct consumption. They are among the oil component, which constitutes about 10%-40%, generally of the emulsion. Non-polar active compounds include, for example, nutraceuticals, supplements and pharmaceuticals, such as vitamins and CBD oil. Exemplary of non-polar ingredients, is a fish oil which contains a plurality of different non-polar compounds, including compounds that have desirable activity, such as omega-3 fatty acids. Non-polar ingredients include any lipophilic or lipid-soluble compound that has greater solubility in organic solvents (e.g., ethanol, methanol, ethyl ether, acetone, and benzene) and in fats and oils, than in polar solvents, for example, water. Typically, the non-polar ingredients are poorly water-soluble, for example, water insoluble, or are compounds that have low water solubility. The non-polar ingredients include, but are not limited to, drugs, hormones, vitamins, nutrients and other lipophilic compounds. Exemplary non-polar ingredients include, but are not limited to, omega-3 EPA and DHA, resveratrol, sesamin, curcumin, Boswellia (Boswellic acids), lipoic acid, such as alpha lipoic acids, capsaicinoids, PQQ, carotenoids, such as astaxanthin, zeaxanthin, lutein, beta-carotene, and lycopene, and vitamins, such as vitamin A, vitamin D, and vitamin E complexes, vitamin K1 and vitamin K as MK7. Exemplary non-polar ingredients are listed herein below. The provided methods and compositions can be used to dilute (e.g., dissolve/disperse) any non-polar ingredient in aqueous medium, such as water. The non-polar ingredient can differ from the surfactant, polyalkylene glycol derivative of vitamin E, for example, the non-polar ingredient is not a polyalkylene glycol vitamin E derivative. Exemplary of non-polar ingredients that can be used in the provided emulsions are:

non-polar ingredients containing essential fatty acids, such as polyunsaturated fatty acids (PUFAs), for example, gamma-linolenic acid (GLA), e.g., borage oil and evening primrose (Oenothera biennis) oil, blackcurrant seed oil, hemp seed oil and spirulina extract; compounds containing omega-3 fatty acids, such as natural and synthetic omega-3 fatty acids, for example, compounds containing omega-3 polyunsaturated long-chain fatty acids, including eicosapentaenoic acid (EPA) (20:5ω3); docosahexaenoic acid (DHA) (22:6ω3); eicosatetraenoic acid (24:4ω3); docosapentaenoic acid (DPA, clupanodonic acid) (22:5ω3); 16:3 ω3; 24:5 ω3 and/or nisinic acid (24:6ω3), e.g., fish oil, algae oil, krill oil, canola oil, flaxseed oil, soybean oil and walnut oil; compounds containing short-chain omega-3 fatty acids, for example, alpha-linolenic acid (α-linolenic acid; ALA; 18:3ω3) and stearidonic acid (18:4ω3), esters of an omega-3 fatty acid and glycerol, for example, monoglycerides, diglycerides and triglycerides, esters of omega-3 fatty acid and a primary alcohol, for example, fatty acid methyl esters and fatty acid esters, precursors of omega-3 fatty acid oils, for example, EPA precursor, DHA precursor, derivatives such as polyglycolized derivatives or polyoxyethylene derivatives, oils containing the omega-3 fatty acids, for example, fish oil (marine oil), e.g., highly purified fish oil concentrates, perilla oil, krill oil, and algae oil, e.g., microalgae oil; compounds containing omega-6 fatty acids, such as compounds containing linoleic acid (18:2ω6) (a short-chain fatty acid); gamma-linolenic acid (GLA; 18:3ω6); dihomo gamma linolenic acid (DGLA; 20:3ω6); eicosadienoic acid (20:2ω6); arachidonic acid (AA; 20:4ω6); docosadienoic acid (22:2ω6); adrenic acid (22:4ω6); and/or docosapentaenoic acid (22:5ω6), for example, borage oil, corn oil, cottonseed oil, grapeseed oil, peanut oil, primrose oil, e.g., evening primrose (Oenothera biennis) oil, blackcurrant seed oil, hemp seed oil, spirulina extract, safflower oil, sesame oil, coconut oil and soybean oil;

other fatty acids, such as triglycerides, including medium chain triglycerides, polar lipids, for example, ether lipids, phosphoric acid, choline, fatty acids, glycerol, glycolipids, triglycerides, and phospholipids (e.g., phosphatidylcholine (lecithin), phosphatidylethanolamine, and phosphatidylinositol); saw palmetto extract; ethyl linoleate; herb oils, for example, garlic oils and scordinin; short-chain saturated fatty acids (4:0-10:0), lauric acid (12:0), myristic acid (14:0), pentadecanoic acid (15:0), palmitic acid (16:0), palmitoleic acid (16:1 ω7), heptadecanoic acid (17:0), stearic acid (18:0), oleic acid (18:1 ω9), and arachidic acid (20:0);

micronutrients, such as vitamins, minerals, co-factors, for example, coenzyme Q10 (coQ10, also called ubiquinone), ubiquinol, turmeric extract (curcuminoids), saw palmetto lipid extract (saw palmetto oil), echinacea extract, hawthorn berry extract, ginseng extract, lipoic acid (thioctic acid), e.g., alpha-lipoic acid, ascorbyl palmitate, kava extract, St John's Wort (hypericum, Klamath weed, goat weed), extract of quercitin, dihydroepiandrosterone, and indol-3-carbinol;

carotenoids, including hydrocarbons and oxygenated, alcoholic derivatives of hydrocarbons, for example, beta carotene, mixed carotenoid complex, lutein, lycopene, zeaxanthin, cryptoxanthin, for example, beta-crytoxanthin, beta carotene, astaxanthin, bixin, canthaxanthin, capsanthin, capsorubin, apo-carotenal, beta-12′-apo-carotenal, “Carotene” (mixture of alpha- and beta-carotene), gamma carotene, ciolerythrin, and esters of hydroxyl- or carboxyl-containing members thereof;

fat-soluble vitamins, for example, vitamins A, D, E and K, and corresponding pro-vitamins and vitamin derivatives, such as esters, with an action resembling that of vitamin A, D, E or K, for example; retinol (vitamin A) and pharmaceutically acceptable derivatives thereof, such as palmitate ester of retinol and other esters of retinol, calciferol (vitamin D) and its pharmaceutically acceptable derivatives thereof and precursors of vitamin D, d-alpha tocopherol (vitamin E) and derivatives thereof, including pharmaceutical derivatives thereof, for example, tocotrienols, d-alpha tocopherol acetate and other esters of d-alpha tocopherol, and ascorbyl palmitate, a fat-soluble version of vitamin C;

phytochemicals, including phytoestrogens, for example, genistein and daidzein, such as isoflavones, e.g., soy isoflavones, flavonoids, phytoalexins, for example, resveratrol (3,5,4′-trihydroxystilbene), red clover extract, and phytosterols;

lipid-soluble drugs, including natural and synthetic forms of immunosuppressive drugs, such as cyclosporin, protease inhibitors such as ritonavir, macrolide antibiotics and oil soluble anesthetics such as propofol, natural and synthetic forms of steroidal hormones, for example, estrogens, estradiols, progesterone, testosterone, cortisone, phytoestrogens, dehydroepiandrosterone (DHEA), growth hormones and other hormones; and oil-soluble acids and alcohols, for example, tartaric acid, lactylic acid, butylated hydroxyanisole, butylated hydroxytoluene, lignin, sterols, polyphenolic compounds, oryzanol, cholesterol, phytosterols, flavonoids, such as quercetin and resveratrol, and diallyl disulfides;

cannabinoids, including natural, synthetic, and semi-synthetic compounds, for example, phytocannabinoids, endocannabinoids, and synthetic cannabinoids; and

hops-containing compounds, including compounds isolated or derived from hops (Humulus lupulus L.), such as extracts of hops cones, for example, hops oils, hops resins or hops resin derivatives, hops acids or hops acid derivatives, or mixtures thereof.

1. Polyunsaturated Fatty Acid (PUFA)-Containing Non-Polar Compounds

Exemplary of the non-polar ingredients contained in the emulsions are compounds containing fatty acids, for example, non-polar ingredients containing the non-polar compounds polyunsaturated fatty acids (PUFAs). Fatty acids are straight-chain hydrocarbon molecules with a carboxyl (COOH) group at one end of the chain.

PUFAs are fatty acids that contain more than one carbon-carbon double bond in the carbon chain of the fatty acid. PUFAs, particularly essential fatty acids, are useful as dietary supplements.

Different nomenclature is used to describe fatty acid molecules. Lipid nomenclature, for example, 18:3 ω-3, indicates the carbon chain length, number of double bonds and the position along the carbon chain of the first carbon-carbon double bond in a fatty acid. Using this nomenclature, each carbon along the chain is labeled according to its position relative to one end of the chain. For example, the first carbon away from the carboxylate end is named α, the second is named β, and so forth. The last carbon in the molecule (furthest from the carboxy group) always is labeled co (or omega, or n). The number of carbons and the number of double bonds are listed first in the lipid name of a fatty acid, separated by a colon. For example, the name “18:3” indicates that the molecule has eighteen (18) carbons and three (3) double bonds. Following these numbers, the position at which the first double bond appears, relative to the last (ω) carbon, is listed. For example, the nomenclature, 18:3 ω-3 (or 18:3 omega-3; or 18:3 n-3), describes a fatty acid with eighteen (18) carbons and three (3) double bonds, the first of which occurs at the third carbon away from the omega carbon.

Alternatively, chemical nomenclature can be used. The chemical name of a fatty acid describes the position of each double bond. In the chemical naming, the carbons are numbered, beginning with 1, starting with the carbon that is part of the carboxy (COOH) group. Thus, with this numbering system, the a carbon is labeled “2.” The chemical name of the fatty acid lists the first carbon (from the COOH end) to participate in each double bond.

Certain PUFAs are called essential fatty acids because they are required for biological processes and mammals, including humans, cannot synthesize them using any known chemical pathway, and therefore must obtain them from diet or by supplementation (U.S. Pat. No. 6,870,077; Covington (2004) Am. Fam. Phys. 70(1):133-140). The essential PUFAs are the omega-3 (ω3; n-3) fatty acids and the omega-6 (ω-6; n-6) fatty acids. Omega-3 and omega-6 fatty acids are methylene interrupted polyenes which have two or more cis double bonds separated by a single methylene group. Exemplary of omega-3 fatty acids are alpha-linolenic acid (α-linolenic acid; ALA; 18:3ω3) (a short-chain fatty acid); stearidonic acid (18:4ω3) (a short-chain fatty acid); eicosapentaenoic acid (EPA; 20:5ω3); docosahexaenoic acid (DHA; 22:6ω3); eicosatetraenoic acid (24:4ω3); docosapentaenoic acid (DPA; clupanodonic acid; 22:5ω3); 16:3 ω3; 24:5 ω3 and nisinic acid (24:6ω3). Longer chain omega-3 fatty acids can be synthesized from ALA (the short-chain omega-3 fatty acid). Exemplary of omega-6 fatty acids are linoleic acid (18:2ω6) (a short-chain fatty acid); gamma-linolenic acid (GLA; 18:3ω6); dihomo gamma linolenic acid (DGLA; 20:3ω6); eicosadienoic acid (20:2ω6); arachidonic acid (AA; 20:4ω6); docosadienoic acid (22:2ω6); adrenic acid (22:4ω6); and docosapentaenoic acid (22:5ω6).

While the longer chain omega-3 and omega-6 essential fatty acids can be synthesized from ALA (the short-chain omega-3 fatty acid) and linolenic acid (LA), respectively, evidence suggests that conversion of these short chain fatty acids in humans is slow. Thus, a major source of long chain essential PUFAs is dietary (see, e.g., Ross et al. (2007) Lipids Health Dis. 6:21; Lands (1992) FASEB J. 6(8):2530). Dietary supplements containing PUFAs, particularly essential PUFAs, are desirable for protection against cardiovascular disease, inflammation and mental illnesses (see, e.g., Ross et al. (2007) Lipids Health Dis. 6:21; Lands (1992) FASEB J. 6(8):2530; and U.S. Pat. No. 6,870,077). Evidence suggests that essential fatty acids, particularly EPA and DHA, in the form of food and nutritional supplements, play a role in preventing a number of disease states, including cardiovascular diseases, inflammation, mental health and behavioral diseases and disorders (see, e.g., Ross et al. (2007) Lipids Health Dis. 6:21; Lands (1992) FASEB J. 6(8):2530; U.S. Pat. No. 6,870,077; and Covington (2004) Am. Fam. Phys. 70(1):133-140).

Omega-9 fatty acids are non-essential PUFAs. Exemplary of omega-9 fatty acids are oleic acid (which is monounsaturated) (18:1 ω9); eicosenoic acid (20:1 ω9); mead acid (20:3 ω9); erucic acid (22:1 ω9); and nervonic acid (24:1 ω9).

Conjugated fatty acids are PUFAs with two or more conjugated double bonds. Conjugated fatty acids can be used as nutritional supplements. Exemplary of conjugated fatty acids are conjugated linoleic acid (CLA), for example, 18:2 ω7, 18:2 ω6; conjugated linolenic acid, for example, 18:3ω6, 18:3ω5; and other conjugated fatty acids, for example, 18:3 ω3, 18:4 ω3, and 20:5 ω6.

(a) Omega-3 Fatty Acid Compounds

Exemplary of the PUFA-containing non-polar ingredients that can be used in the provided emulsions are non-polar ingredients that contain one or more of the non-polar compound omega-3 (ω3; n-3) fatty acids, for example, compounds containing DHA and/or EPA fatty acids, for example, marine oils, e.g., fish oil, krill oil and algae oil; and compounds containing ALA fatty acids, for example, flaxseed oil.

Typically, oils and aqueous compositions containing long-chain polyunsaturated fatty acids (PUFAs) are susceptible to oxidation, making them unstable and giving them an unpleasant taste. The ingredients and relative concentrations thereof, as well as the methods for making the emulsions, contribute to desirable properties of DHA/EPA-containing compositions. For example, the ingredients and methods used to make compositions provided herein minimize the “fishy” odor and/or taste of DHA/EPA compositions and increase their stability over time. For example, the compounds in the compositions can have low oxidation, contributing to these desirable properties.

(i) DHA/EPA

Exemplary of non-polar ingredients that contain one or more omega-3 fatty acids which can be used in the provided emulsions are compounds containing DHA and/or EPA, for example, marine oil, e.g., fish oil, krill oil and algae oil. Any oil containing DHA and/or EPA can be used. Exemplary non-polar ingredients that can be used in the emulsions provided herein include non-polar ingredients that contain only DHA, for example, non-polar ingredients that contain between 10% or about 10% and 40% or about 40% DHA, between 25% or about 25% and 45% or about 45% DHA, or between 60% or about 60% and 90% or about 90% DHA, for example, at least 35% or about 35%, at least 50% or about 50%, at least 65% or about 65%, at least 80% or about 80%, at least 85% or about 85%, or at least 90% or about 90%, by weight (wt %), DHA. Exemplary non-polar ingredients that can be used in the emulsions provided herein include non-polar ingredients that contain only EPA, for example, non-polar ingredients that contain between 5% or about 5% and 15% or about 15% EPA, or non-polar ingredients that contain not more than 10% or about 10% EPA. Exemplary non-polar ingredients that contain a mixture of DHA and EPA are suitable for use in the emulsions provided herein, for example, compositions containing at least 20% or about 20% DHA and not more than 13% or about 13% EPA, by weight, of the non-polar ingredient; at least 35% or about 35% DHA and not more than 13% or about 13% EPA; at least 70% or about 70% DHA and not more than 13% or about 13% EPA; or the total amount of DHA and EPA represents at least 30% or about 30% of the non-polar ingredient, or at least 50% or about 50% of the non-polar ingredient, or at least 61% or about 61% of the non-polar ingredient.

(ii) Fish Oils

Exemplary of the PUFA-containing non-polar ingredients that can be used in the provided emulsions are oils derived from fish which contain DHA, EPA or both DHA and EPA. Particularly, cold water marine fish are a known source of omega-3 fatty acids (U.S. Pat. No. 4,670,285). Suitable fish oils containing DHA, EPA or both DHA and EPA can be obtained from any of a number of commercial sources, for example, fish oils available from Jedwards International, Inc., any of which can be used with the provided compositions.

Fish oils typically are extracted from fish tissue, for example, frozen fish tissue. For example, the fish oil can be a tasteless fish oil, for example, a cod liver oil, which has been isolated from fish, for example, from cod liver, and then refined and deodorized, or in some other way treated so its taste becomes neutral, such as described in International Patent Publication Nos. WO 00/23545 and WO 2004/098311. In one example, these fish oils are isolated from frozen fish tissue by a process that minimizes oxidation. Exemplary of such a tasteless fish oil is a fish oil sold under the trademark Denomega™ 100 (Borregaard Ingredients, Sarpsborg, Norway; distributed by Denomega Nutritional Oils AS, Boulder, Colo.). Typically, the tasteless fish oil, for example, cod liver oil, contains between or between about 25% and 35% omega-3 fatty acids, for example, 34% omega-3 fatty acids. In one example, the fish oil, for example, the Denomega™ 100 oil, contains 13% or about 13% DHA and 13% or about 13% EPA.

Also exemplary of the fish oils that can be included in the provided emulsions are fish oils containing high amounts of omega-3 fatty acids, for example, high amounts of DHA. One example of such a fish oil contains at least or about at least 85% DHA, typically greater than 85% DHA, and at least or about at least 90% omega-3 fatty acids, typically greater than 90% omega-3 fatty acids. In another example, the fish oil can contain 98% PUFA, 89% omega-3 fatty acids, about 70% DHA, about 10% EPA, 8.9% omega-6 fatty acids and 0.7% omega-9 fatty acids.

Exemplary of a fish oil containing high amounts of omega-3 fatty acids that can be used as the non-polar ingredient in the emulsions is an omega-3 fish oil EE (O3C Nutraceuticals; supplied by Jedwards International Inc., Quincy, Mass.), which contains a total of 98% polyunsaturated fatty acids (PUFAs), including 89% omega-3 fatty acids, 8.9% omega-6 fatty acids, and 0.7% omega-9 fatty acids, made up of 0.1% saturated fatty acids, 1.0% monounsaturated fatty acids, 74.5% docosahexanoic (DHA) fatty acids, and 9.3% eicosapentaenoic (EPA) fatty acids. This fish oil also contains 0.1% (16:0) palmitic acid, 0.1% (16:1 ω-7) palmitoleic acid, 0.1% (18:0) stearic acid, 0.6% (18:1 ω-9) oleic acid, 0.1% (18:1 ω-7) oleic acid, 0.3% (18:2 ω-6) linoleic acid, 0.2% (18:3 ω-3) linolenic acid, 0.2% (18:4 ω-3) octadecatetraenoic acid, 0.1% (20:1 ω-9) eicosanoic acid, 0.1% (20:2 ω-6) eicosadienoic acid, 0.2% (20:3 ω-6) eicosatrienoic acid, 2.4% (20:4 ω-6) arachidonic acid, 0.6% (20:4 ω-3) arachidonic acid, 0.1% (22:1 ω-11) erucic acid, 0.6% (21:5 ω-3) uncosapentaenoic acid, 0.5% (22:4 ω-6) docosatetraenoic acid, 5.4% (22:5 ω-6) docosapentaenoic acid, 3.6% (22:5 ω-3) docosapentaenoic acid and 0.9% other fatty acids.

Also exemplary of a fish oil containing high amounts of omega-3 fatty acids that can be used in the provided emulsions is Omega Concentrate 85 DHA TG Ultra (O3C Nutraceuticals AS, Oslo, Norway), which contains greater than 85% DHA (C22:6n-3) and greater than 90% total omega-3 fatty acids and is isolated from fatty fish species in the Engraulidae, Clupeidae and Scombridae families. This fish oil is produced by purifying and concentrating the oils from these fish with gentle technologies to increase the concentration of omega-3 fatty acid DHA. Also exemplary of the fish oils are other fish oils made by O3C Nutraceuticals, AS and other fish oils supplied by Jedwards International, Inc.

Any fish oil containing DHA and/or EPA can be used as the non-polar ingredient in the provided emulsions. Exemplary of a fish oil that can be included in the provided emulsions is Eterna™ Omegasource™ Oil (supplied by Hormel Foods Specialty Products Division, Austin, Minn.), which contains at least 30% omega-3 fatty acids (DHA, EPA and ALA), is odorless, virtually free of cholesterol, and bland in flavor. This fish oil contains about 28% DHA and EPA, typically 17% EPA and 11% DHA, and additionally contains 4.5% omega-6 fatty acids. Also exemplary of the fish oils that can be included in the provided compositions are Omega 30 TG Food Grade (Non-GMO) MEG-3™ Fish Oil (supplied by Ocean Nutrition Canada, Dartmouth, Nova Scotia, Canada), a kosher fish oil which contains about 30% DHA/EPA and Marinol C-38 (supplied by Lipid Nutrition B.V., Channahon, Ill.), which contains about 52% omega-3 fatty acids, including at least 38% DHA/EPA, more specifically includes about 22% EPA and 14% DHA. Also exemplary of fish oils are Marinol D-40 (supplied by Lipid Nutrition B.V., Channahon, Ill.), which contains about 40% DHA and 7% EPA; VivoMega 3322 TG fish oil that contains 50% of the non-polar ingredients DHA/EPA (GC Rieber Oils, Kristiansund, Norway); an omega-3 fish oil 70TG that is 61% by weight DHA/EPA; fish oils sold by GC Rieber Oils (Kristiansund, Norway) that contain 30% or 65% DHA; ONC TG fish oil sold by Ocean Nutrition Canada (Dartmouth, Nova Scotia); Omevital™ 30% MP Gold, a fish oil that contains 30% DHA/EPA (Cognis, Monheim am Rhein, North Rhine-Westphalia, Germany); and a fish oil containing 60% DHA (sold by FINA LLC, Cincinnati, Ohio). Also exemplary of the fish oils are krill oils, such as those made according to International Patent Publication No. WO 2007/080515.

(iii) Algae Oil

Also exemplary of non-polar ingredients containing omega-3 PUFAs, particularly DHA (and optionally EPA), that can be used as the non-polar ingredient in the provided emulsions are oils derived from microorganisms, for example, oils derived from marine dinoflagellates, such as microalgae, e.g., Crypthecodinium sp., particularly Crypthecodinium cohnii. Microalgae oils, like fish oils, are an excellent source of omega-3 fatty acids, particularly DHA (U.S. Pat. Nos. 5,397,591; 5,407,957; 5,492,938; and 5,711,983). Exemplary of oils derived from microalgae are the oils disclosed in (and oils made according to the methods described in) U.S. Pat. Nos. 5,397,591; 5,407,957; 5,492,938; and 5,711,983 and U.S. Patent Publication No. 2007/0166411, including DHASCO® and DHASCO-S® (Martek Biosciences Corporation).

For example, U.S. Pat. No. 5,397,591 describes, inter alia, single-cell edible oils (algae oils) (and methods for making the oils), which contain at least 70% triglycerides, which contain about 20-35% DHA and lack EPA, isolated from Crypthecodinium cohnii, preferably containing more than 70% triglycerides, having 15-20% myristic acid; 20-25% palmitic acid; 10-15% oleic acid; 30-40% DHA; and 0-10% other triglycerides. U.S. Pat. No. 5,407,957 describes, inter alia, algae oils (and methods for making the oils) derived from Crypthecodinium cohnii, preferably containing greater than about 90% triglycerides, at least 35% DHA by weight (w/w), in one example, having 15-20% myristic acid; 20-25% palmitic acid; 10-15% oleic acid; 40-45% DHA; and 0-5% other oils. U.S. Pat. No. 5,492,938 describes, inter alia, single cell edible oils (and methods for making the oils) containing at least 70% triglycerides, which contain about 20-35% DHA and lack EPA, isolated from Crypthecodinium cohnii, in one example containing more than 70% triglycerides, having 15-20% myristic acid; 20-25% palmitic acid; 10-15% oleic acid; 30-40% DHA; and 0-10% other triglycerides. U.S. Pat. No. 5,711,983 describes, inter alia, single cell edible oils (and methods for making the oils) containing at least 70% triglycerides, which contain about 20-35% DHA and lack EPA, isolated from Crypthecodinium cohnii, in one example, containing more than 70% triglycerides, having 15-20% myristic acid; 20-25% palmitic acid; 10-15% oleic acid; 30-40% DHA; and 0-10% other triglycerides.

Exemplary of suitable algal oils for use in the emulsions provided herein are an algal oil that contains 40% of the non-polar ingredient DHA (sold by GC Rieber Oils, Kristiansund, Norway) and an algal oil that contains 35% of the non-polar ingredient DHA and contains 350 mg DHA/g oil (life'sDHA™ S35-0300, sold by DSM Nutritional Products Inc., Kaiseraugst, Switzerland).

Also exemplary of suitable microalgae oils are those disclosed, for example, in U.S. Pat. No. 6,977,166 and U.S. Patent Publication No. US 2004/0072330. Any oil derived from dinoflagellate, for example, microalgae, which contains DHA, and optionally EPA, is suitable as an algae oil for use with the provided compositions, for example, V-Pure algae oil (Water4Life, Switzerland), which contains EPA and DHA, and Martek DHA™-S(supplied by Martek Biosciences Corporation, Columbia, Md.), derived from the marine alga Schizochytrium sp., containing not less than 35% DHA and 16.1% (22:5 ω-6) docosapentaenoic acid, 1.3% (20:5 ω-3) eicosapentaenoic acid, 0.6% (20:4 ω-6) arachidonic acid, 1.6% (18:2 ω-6) linoleic acid, 16.9% (18:1 ω-9) oleic acid, and 19.8% other fatty acids.

(iv) Flaxseed Oil—Omega 3 (ALA)

Also exemplary of the omega-3-containing non-polar ingredient used in the provided emulsions is flaxseed oil (linseed oil). Flaxseed oils, which are good sources of omega-3 fatty acids, particularly alpha-linolenic acid (ALA), have been used as nutritional supplements. Flaxseed oils are produced by pressing the flax seed and refining the oil from the flax seeds. Exemplary of flaxseed oil that can be used as the non-polar ingredient in the provided compositions is flaxseed oil derived from Linum usitatissimum L. Exemplary of flaxseed oils suitable for use in the emulsions provided herein include flaxseed oil supplied by Sanmark LLC (Greensboro, N.C.; Sanmark Limited, Dalian, Liaoning Province, China), which contains not less than (NLT) 50% C18:3 alpha-linolenic acid, and further contains other fatty acids, for example, 3-8% C16:0 palmitic acid, 2-8% C18:0 stearic acid, 11-24% C18:1 oleic acid, 11-24% C18:2 linoleic acid and 0-3% other fatty acids. Also exemplary of suitable flaxseed oil is a flaxseed oil containing 6% palmitic acid, 2.5% stearic acid, 0.5% arachidic acid, 19% oleic acid, 24.1% linoleic acid, 47.4% linolenic acid, and 0.5% other fatty acids. The fatty acid composition of flaxseed oil can vary. Any flaxseed oil can be used as the non-polar ingredient in the provided compositions. For example, the flaxseed oil can contain at least or about at least 50%, at least or about at least 65%, or at least or about at least 70% ALA. Exemplary of a flaxseed oil containing greater than 65% alpha-linolenic acid content (of total fatty acid content), for example, 70-80% or 70-75%, is the flaxseed oil described in U.S. Pat. No. 6,870,077.

(b) Omega-6 Compounds

Also exemplary of the non-polar ingredients used in the provided emulsions are compounds containing omega-6 PUFAs, for example, gamma-linolenic acid (GLA), for example, borage oil and evening primrose (Oenothera biennis) oil, blackcurrant seed oil, hemp seed oil, fungal oil and spirulina extract. Any oil containing omega-6 fatty acids can be used in the provided compositions.

Exemplary of the omega-6-containing non-polar ingredients are compounds containing GLA, for example, borage oil. GLA is an omega-6 PUFA, which primarily is derived from vegetable oils, for example, evening primrose (Oenothera biennis) oil, blackcurrant seed oil, hemp seed oil, and spirulina extract. GLA has been used as a nutritional supplement. It has been proposed that GLA has a role in treating various chronic diseases and in particular that it has anti-inflammatory effects (Fan and Chapkin (1998) J. Nutr. 128(9):1411-1414). In one example, the non-polar ingredient contains at least or about at least 22 wt % of GLA, for example, 22, 23, 24, 25, 26, 27, 28, 29, 30, 31, 32, 33, 34, 35, 36, 37, 38, 39, 40, 50, 60 wt % or more, by weight of GLA.

Borage (Borago officinalis), also known as “starflower,” is an herb with seeds containing high amounts of GLA. Exemplary of borage oils that can be used as a non-polar ingredient in the provided compositions are borage oils supplied by Sanmark LLC (Greensboro, N.C.; Sanmark Limited, Dalian, Liaoning Province, China), derived by pressing and isolating oil from the seeds of Borago officinalis L. This oil contains not less than (NLT) 22% C18:3 gamma-linolenic acid (GLA), between 9 and 12% C16:0 palmitic acid, between 3% and 5% C18:0 stearic acid, between 15% and 20% C18:1 oleic acid, between 35% and 42% C18:2 linoleic acid, between 3% and 5% C20:1 ocosenoic acid, between 1% and 4% C22:1 docosenoic acid and between 0% and 4% other fatty acids. Other borage oils can be used. Other GLA-containing oils also can be used as the non-polar ingredient.

(c) Saw Palmetto Extract

Also exemplary of the non-polar ingredients used in the provided emulsions is saw palmetto extract, a lipophilic extract of the ripe berries of the American dwarf palm (also called Serenoa repens or Sabal serrulata), which has been used to treat genitourinary and other diseases and to enhance sperm production, breast size and libido, as a mild diuretic, a nerve sedative, an expectorant and a digestive tract tonic, and particularly to treat benign prostate hyperplasia (BHP) (Ernst (2002) Acad. Clin. 136:42-53; Gordon and Shaughnessy (2003) Comp. Alt. Med. 76(6):1281-1283). Saw palmetto extract is commercially available from a number of sources. Any saw palmetto lipid extract can be used in the provided emulsions. Exemplary of a saw palmetto extract that can be used in the provided emulsions is Saw Palmetto, Lipophilic Extract, commercially available from Natural Medicinals, Inc. (Felda, Fla.). This saw palmetto lipophilic extract is carbon dioxide extracted and, in one example, contains 85.9% total fatty acids, including 0.8% caproic acid, 2% caprylic acid, 2.4% capric acid, 27.% lauric acid, 10.3% myristic acid, 8.1% palmitic acid, 0.2% palmitoleic acid, 2% stearic acid, 26.7% oleic acid, 4.9% linoleic acid, 0.7% linolenic acid, 0.42% phytosterols, including 0.42% beta sitosterol, 0.09% campesterol, 0.03% stigmasterol; and 0.2% moisture. Other sources of saw palmetto extract can be used.

(d) Conjugated Linoleic Acid (CLA)

Also exemplary of the PUFA-containing non-polar ingredients that can be used in the provided emulsions are non-polar ingredients containing conjugated fatty acids. Conjugated fatty acids are PUFAs with two or more conjugated double bonds. Conjugated fatty acids can be used as nutritional supplements. Exemplary of the ingredients containing conjugated fatty acids are compounds containing conjugated linoleic acid (CLA), for example, 18:2 ω-7 and 18:2 ω-6; conjugated linolenic acid, for example, 18:3ω-6 and 18:3ω-5; and other conjugated fatty acids, for example, 18:3 ω-3, 18:4 ω-3 and 20:5 ω-6. CLA refers to a family of linoleic acid isomers found primarily in meat and dairy products of ruminants. Typically, the CLA compounds contain a mixture of different CLA isomers, for example, C18:2 CLA, c9, t11 CLA, t10, c12 CLA, and other CLA isomers. Exemplary of a CLA that can be used as a non-polar ingredient in the provided compositions is the CLA oil (70% CLA) commercially available from Sanmark, LTD (Dalian, Liaoning Province, China; product code 01057-A80). This CLA oil is a clear white to pale yellow oil that has a fatty acid composition of NMT (not more than) 9.0% C16:0 palmitic acid, NMT 4.0% stearic acid, NMT 15.0% C18:1 oleic acid, NMT 3.0% C18:2 linoleic acid, NLT (not less than) 80% C18:2 CLA (including the following isomers: NLT 37.5% C18:2 c9, t11 CLA, 37.5% C18:2 t10, c12 CLA, and NMT 5.0% other CLA isomers); and NMT 5.0% other fatty acids. Other exemplary CLA compounds are a CLA compound that contains 74.5% CLA (Clarinol® CLA) and a CLA compound that contains 79.6% CLA (Clarinol® G-80), both sold by Stepan Lipid Nutrition, Maywood, N.J. Other CLA-containing compounds can be used.

2. Phytochemical-Containing Non-Polar Compounds

Exemplary of the non-polar ingredients that contain non-polar compounds that can be used in the provided emulsions are phytochemical-containing compounds, for example, phytosterols (plant sterols), phytoestrogens, for example, genistein and daidzein, flavonoids, for example, quercetin, isoflavones, for example, soy isoflavones, phytoalexins, for example, resveratrol (trans-3,5,4′-trihydroxystilbene), and red clover extract.

(a) Phytosterols

Exemplary of the phytochemical-containing compounds that contain non-polar ingredients that can be used in the provided emulsions are phytosterols (plant sterols). Plant sterols are structurally similar to cholesterol and have been found to reduce the absorption of dietary cholesterol, which can affect the levels of serum cholesterol. According to the U.S. Food and Drug Administration (FDA), two servings per day, each containing 0.4 grams of plant sterols, for a total daily intake of at least 0.8 grams, as part of a diet low in saturated fat and cholesterol, is reported to reduce the risk of heart disease. Thus, plant sterols are used in nutritional supplements.

Any phytosterol-containing compound can be used as a non-polar ingredient in the provided compositions. Exemplary of the phytosterol-containing compounds that can be used as non-polar ingredients in the provided compositions are compounds containing plant sterols, for example, the compound sold under the name CardioAid™, distributed by B&D Nutrition and manufactured by ADM Natural Health and Nutrition (Decatur, Ill.). This compound contains kosher, pareve, and halal plant sterols that are produced under current food good manufacturing practices (GMPs). The sterols are PCR negative and the material is derived from genetically modified organisms (GMOs). This phytosterol compound contains a minimum of 95% plant sterols, which can include up to 5 plant sterols. The compound can contain, for example, 40-58% beta sitosterol, 20-30% campesterol, 14-22% stigmasterol, 0-6% brassicasterol and 0-5% sitostanol. The compound further can contain tocopherols, for example, 0-15 mg/g tocopherols. The compound is tested and is negative for microorganisms, such as Salmonella, E. coli and Staphylococcus aureus.

(b) Flavonoids

Exemplary of the phytochemical-containing compounds that can be used as in the provided emulsions are flavonoids. Flavonoids are a class of plant secondary metabolites that have a general structure of a 15-carbon skeleton, which consists of two phenyl rings and a heterocyclic ring, that can be abbreviated C6-C3-C6. Exemplary flavonoid compounds include bioflavonoids, isoflavonoids, and neoflavonoids.

Exemplary of a flavonoid is resveratrol, or trans-resveratrol (trans-3,5,4′-trihydroxystilbene), a phytoalexin that is naturally produced by several plants, such as the Japanese knotweed, and also is found in the skin and seeds of grapes, numerous berries, including mulberries, blueberries, bilberries and cranberries, and in peanuts. This polyphenolic compound can act as an antioxidant and additionally, can aid in cancer prevention and reduction of cardiovascular disease.

Any resveratrol-containing compound can be used as a non-polar ingredient in the provided compositions. Exemplary of resveratrol-containing compounds that can be used as non-polar ingredients in the provided compositions are compounds containing trans-resveratrol, for example the compound sold under the name ReserveNature™, sold by Jiaherb, Shaanxi, China. This compound contains trans-resveratrol from the botanical source Polygonum cuspidatum (Japanese knotweed). This resveratrol compound contains a minimum of 98.5% trans resveratrol and does not contain emodin. The compound is tested and is negative for microorganisms, such as Salmonella, E. coli, yeast and mold. Another exemplary resveratrol compound is the resveratrol sold by Maxsun Industries (Walnut, Calif.).

An exemplary flavonoid that can be used in the emulsions provided herein is quercetin. Quercetin is a plant pigment that is found in fruits, vegetables, leaves, and grains. Quercetin can act as an antiviral agent, reduce asthma symptoms, minimize eczema, and may have anti-inflammatory properties. An exemplary quercetin compound is the quercetin sold by Pure Assay Ingredients (Walnut, Calif.).

3. Micronutrient-Containing Compounds

Exemplary of the non-polar ingredients that are or contain non-polar compounds in the provided compositions are micronutrient-containing compounds, for example, vitamins, including vitamins A, B, C, D, E, and K, and corresponding provitamins and vitamin derivatives with an action resembling that of vitamin A, B, C, D, E, or K, and yerba mate, ginseng and Ginkgo biloba.

(a) Vitamins

Exemplary of the vitamins included in the provided emulsions are fat-soluble vitamins, for example, vitamins A, B, C, D, E and K, and corresponding provitamins and vitamin derivatives, such as esters, with an action resembling that of vitamin A, B, C, D, E or K. Exemplary vitamins include retinol (vitamin A) and pharmaceutically acceptable derivatives thereof, for example, palmitate ester of retinol and other esters of retinol, for example, vitamin A palmitate; B vitamins, for example, thiamin (vitamin B1), riboflavin (vitamin B2), niacin (vitamin B3), pantothenic acid (vitamin B5), pyridoxine (vitamin B6), biotin (vitamin B7), folic acid or folate (vitamin B9), and cyanocobalamin, cobalamin, or reduced forms of cobalamin (vitamin B12); calciferol (vitamin D) and its pharmaceutically acceptable derivatives thereof, for example, for example, cholecalciferol (vitamin D3), and precursors of vitamin D; d-alpha tocopherol (vitamin E) and derivatives thereof, including pharmaceutical derivatives thereof, for example, tocotrienols, d-alpha tocopherol acetate and other esters of d-alpha tocopherol; K vitamins, for examples, phylloquinone or phytonadione (vitamin K1) and menaquinone (vitamin K2), including the MK-4, MK-7, MK-8, and MK-9 forms; and ascorbyl palmitate, a fat-soluble version of vitamin C.

Any vitamin can be used as a non-polar ingredient in the provided emulsions. Exemplary of the vitamins that can be used in the provided emulsions are vitamin A palmitate, for example, vitamin A palmitate containing 1.7 mIU/g, produced by DSM Nutritional Products, Inc., Belvidere, N.J., and distributed through Stauber Performance Ingredients, Inc., Fullerton, Calif.; vitamin D3, for example, vitamin D3 in corn oil, containing about 1 mIU/g, produced by DSM Nutritional Products, Inc., Parsippany, N.J.; vitamin K2, for example, vitamin K2 (as MK-7), such as MenaQ7® sold by NattoPharma®, Metuchen, N.J.; vitamin E (d-alpha-tocopherol), for example vitamin E oil containing 1000 IU/g vitamin E, sold as Novatol™ 5-67 by ADM Natural health and Nutrition, Decatur, Ill.; vitamin E acetate, for example, a vitamin E acetate compound that includes 1360 IU tocopheryl/g vitamin E oil (sold by DSM Nutritional Products Inc., Kaiseraugst, Switzerland); vitamin B12; vitamin B1; vitamin B3; vitamin B5; and vitamin B6. Vitamin non-polar ingredients are typically added to the emulsions in amounts such that one serving of the water-soluble powder provides an amount of the vitamin that corresponds to the dietary reference intakes.

4. Alkaloids

Exemplary of non-polar ingredients used in the provided emulsions are non-polar ingredients containing an alkaloid, for example, any edible or food-approved alkaloid or any synthetic or semi-synthetic alkaloid. Exemplary of suitable alkaloids include caffeine, synephrine, γ-aminobutyric acid (GABA) derivatives, e.g., 4-amino-3-phenylbutyric acid (i.e., phenibut), and vinpocetine. Vinpocetine is a semi-synthetic derivative of the vinca alkaloid vincamine, an extract from the lesser periwinkle plant. Vinpocetine is reported to have cerebral blood-flow enhancing and neuroprotective effects. An exemplary vinpocetine compound is the vinpocetine sold by Cyvex Nutrition (Irvine, Calif.). Suitable alkaloids for inclusion in the provided emulsions are a matter of design choice and well within the skill of the skilled artisan. The alkaloid-containing non-polar ingredients include caffeine that is added in the form of caffeine anhydrous, such as the Caffeine Anhydrous powder, a white crystalline powder sold by Pacific Rainbow International, Inc. (City of Industry, CA). Other exemplary non-polar ingredients containing alkaloids include herbal extracts, medicinal extracts and compounds from plants and drugs.

5. Cannabinoids

Cannabinoids are a class of chemicals that can act on cannabinoid receptors. Cannabinoid receptor ligands include endocannabinoids, which can be found naturally occurring in humans and other animals, phytocannabinoids, which can be found in cannabis and other plants, other plants, and lichens, and synthetic cannabinoids. Cannabinoids include tetrahydrocannabinol (THC), such as delta-9-tetrahydrocannabinol, and cannabidiol (CBD). At least 85 different cannabinoids have been isolated from cannabis.

Cannabidiol (CBD) is a major phytocannabinoid; it has a wide scope of medical and palliative applications. Cannabis plants produce CBD-carboxylic acid via the same metabolic pathway as THC, aside from the last step of the pathway, which for CBD is performed by CBDA synthase rather than THCA synthase.

Cannabinoids and cannabinoid-containing compounds are exemplary of non-polar ingredients suitable for use in the emulsions provided herein. Cannabinoids include phytocannabinoids (found in the Cannabis sativa plant and some other plants), endocannabinoids (produced naturally in the body by humans and animals), and synthetic cannabinoids. Cannabinoids that can be included in the emulsions provided herein can be natural cannabinoids, synthetic cannabinoids, semi-synthetic cannabinoids, or mixtures thereof. Actual or potential therapeutic applications for cannabinoids include the treatment of multiple sclerosis and other forms of muscular spasm, migraine headache, glaucoma, asthma, inflammation, insomnia, high blood pressure, nausea and vomiting, and the stimulation of appetite. Other potential therapeutic applications include the use of cannabinoids as oxytoxic, anxiolytic, anti-convulsive, anti-depressive, anti-psychotic, and anti-cancer agents.

Exemplary phytocannabinoids derived from the Cannabis sativa plant (commonly known as marijuana) are the terpenophenolic compounds Δ9-tetrahydrocannabinol (THC), Δ8-tetrahydrocannabinol (Δ8-THC) and other compounds structurally related to THC, cannabidiol (CBD), cannabigerol (CBG), cannabichromene (CBC), cannabinol (CBN), cannabicyclo (CBL), cannabivarin (CBV), tetrahydrocannabivarin (THCV), cannabidivarin (CBDV), cannabielsoin (CBE), cannabicitran (CBT), cannabinodiol (CBDL), cannabichromevarin (CBCV), cannabigerovarin (CBGV), cannabigerol monoethyl ether (CBGM), and mixtures and derivatives thereof, for example, nabiximols (Sativex®), a mixture of THC and CBD. Suitable phytocannabinoids also include those derived from plants other than Cannabis sativa, such as, for example, lipophilic alkamides (alkylamides) derived from Echinacea plants, and other cannabinoids derived from plants including, but not limited to, Echinacea purpurea, Echinacea angustifolia, Echinacea pallida, Acmela oleracea, Helichrysum umbraculigerum, and Radula marginata plants.

Endogenous cannabinoids are lipid-like substances produced in the brain and peripheral tissues that bind to and activate cannabinoid receptors present in the cell membrane, including, but not limited to, arachidonate acid-based lipids such as anandamide (N-arachidonoylethanolamide, AEA), 2-arachidonoylglycerol (2-AG), noladin ether (2-arachidonyl glyceryl ether), N-arachidonoyl dopamine (NADA), and virodhamine (OAE).

Also suitable for use in the emulsions provided herein are synthetic cannabinoids. Synthetic cannabinoids include any compound having a cannabinoid-like structure or that produces effects similar to those of cannabinoids that is manufactured using chemical means, including, for example, synthetic Δ9-THC; dronabinol (Marinol®; (6aR-trans)-6a,7,8,10a-tetrahydro-6,6,9-trimethyl-3-pentyl-6H-dibenzo[b,d]pyran-1-01); nabilone (Cesamet™; (±)-trans-3-(1,1-dimethylheptyl)-6,6a,7,8,10,10a-hexahydro-1-hydroxy-6-6-dimethyl-9H-dibenzo[b,d]pyran-9-one); dexanabinol ((6a5,10a5)-9-(hydroxymethyl)-6,6-dimethyl-3-(2-methyloctan-2-yl)-6a,7,10,10a-tetrahydrobenzo[c]chromen-1-ol); ajulemic acid (Resunab™; (6aR,10aR)-3-(1,1-dimethylheptyl)-6a,7,10,10a-tetrahydro-1-hydroxy-6,6-dimethyl-6H-dibenzo(b,d)pyran-9-carboxylic acid); cannabinor ((E)-4-(2-((1R,2R,5R)-6,6-dimethyl-4-oxobicyclo[3.1.1]heptan-2-yl)-3-hydroxy-5-(2-methyloctan-2-yl)phenoxy)-4-oxobut-2-enoic acid); HU 308 ([(1R,2R,5R)-2-[2,6-dimethoxy-4-(2-methyloctan-2-yl)phenyl]-7,7-dimethyl-4-bicyclo[3.1.1]hept-3-enyl]methanol); rimonabant (Acomplia™; 5-(4-chlorophenyl)-1-(2,4-dichloro-phenyl)-4-methyl-N-(piperidin-1-yl)-1H-pyrazole-3-carboxamide); taranabant (MK-0364; N-[(2S,3S)-4-(4-chlorophenyl)-3-(3-cyanophenyl)-2-butanyl]-2-methyl-2-{[5-(trifluoromethyl)-2-pyridinyl]oxy}propanamide); levonantradol ([(6S,6aR,9R,10aR)-9-hydroxy-6-methyl-3-[(2R)-5-phenylpentan-2-yl]oxy-5,6,6a,7,8,9,10,10a-octahydrophenanthridin-1-yl] acetate); WIN55212-2 ((R)-(+)-[2,3-dihydro-5-methyl-3-(4-morpholinylmethyl) pyrrolo[1,2,3-de]-1,4-benzoxazin-6-yl]-1-napthalenylmethanone); HU 331 (3-hydroxy-2-[(1R)-6-isopropenyl-3-methyl-cyclohex-2-en-1-yl]-5-pentyl-1,4-benzoquinone); and any other compound having a cannabinoid-based structure or that produces effects similar to those of cannabinoids that is manufactured using chemical means.

6. Hops-Containing Compounds

Exemplary of non-polar ingredients that can be used in the provided emulsions are compounds that contain hops (Humulus lupulus L.), including compounds isolated or derived from hops, such as extracts of hops cones, for example, hops oils, hops resins or hops resin derivatives, hops acids or hops acid derivatives, or mixtures thereof. Hops oils include, but are not limited to, humulene, beta-caryophyllene, mycrene, farnescene, gamma-cadinene, alpha-selinene, and alpha-cadinene. Hops contain alpha-acids, such as humulone (α-lupulic acid), cohumulone, adhumulone, hulupone, and isoprehumulone, and beta-acids, such as lupulone, colupulone, adlupulone, tetrahydroisohumulone, and hexahydrocolupulone. Both alpha- and beta-acids have demonstrated antibacterial, antioxidant, and antiinflammatory properties. An exemplary non-polar ingredient containing hops is Perluxan™, a compound containing a supercritical extract of hops cones that includes a minimum of 30% alpha-acids (including humulone, cohumulone, adhumulone, iso-cohumulone and iso-adhumulone) and 10% beta-acids (including lupulone and colupulone), such as sold by Pharmachem Laboratories, Kearny, N.J.

7. Antioxidants

Exemplary of non-polar ingredients that can be included in the emulsions provided herein are compounds that contain an antioxidant or have antioxidant properties, for example, a molecule that is capable of inhibiting the oxidation of other molecules. Antioxidants include molecules that scavenge free radicals. Suitable antioxidants include those that are used as ingredients in dietary supplements. The antioxidant can be a natural antioxidant or a synthetic antioxidant.

Examples of antioxidants include, but are not limited to hormones, carotenoids, carotenoid terpenoids, non-carotenoid terpenoids, flavonoids, flavonoid polyphenolics (e.g., bioflavonoids), flavonols, flavones, lignans, such as sesamin, phenols, polyphenols, esters of phenols, esters of polyphenols, nonflavonoid phenolics, isothiocyanates, vitamins and vitamin cofactors, such as vitamin A, vitamin C, vitamin E, vitamin E phosphate and ubiquinone (ubidecarenone, coenzyme Q, coenzyme Q10), ubiquinol, pyrroloquinoline quinone (PQQ), ascorbic acid, citric acid, rosemary oil, minerals, such as mineral selenium and manganese, melatonin, α-carotene, β-carotene, lycopene, lutein, zeanthin, crypoxanthin, resveratrol, eugenol, quercetin, catechin, gossypol, hesperetin, curcumin, turmeric, turmeric/curcumin blend, ferulic acid, thymol, hydroxytyrosol, thyme, olive oil, lipoic acid, including alpha-lipoic acid, glutathione, oxalic acid, tocopherol, tocopherol-derived compounds, di-alpha-tocopheryl phosphate, tocotrienols, butylated hydroxyanisole, butylated hydroxytoluene, ethylenediaminetetraacetic acid, tert-butylhydroquinone, acetic acid, pectin, zeaxanthin, astaxanthin, canthaxanthin, saponins, limonoids, kaempferol, myricetin, isorhamnetin, proanthocyanidins, quercetin, rutin, luteolin, apigenin, tangeritin, naringenin, eriodictyol, flavan-3-ols (e.g., anthocyanadins), gallocatechins, epicatechin and its gallate forms, epigallocatechin and its gallate forms, theaflavin and its gallate forms, thearubigins, isoflavone phytoestrogens, genistein, daidzein, glycitein, anythocyanins, delphinidin, malvidin, pelargonidin, peonidin, and hops (Humulus lupulus L.)-containing compounds. In one example, the antioxidant includes ubiquinol. In another example, the antioxidant includes alpha-lipoic acid. In another example, the antioxidant includes pyrroloquinoline quinone (PQQ). In yet another example, the antioxidant includes a turmeric/curcumin composition.

Any non-polar ingredient that is an antioxidant or has antioxidant properties can be included in the provided emulsions. Exemplary of an antioxidant that can be used in the provided emulsions is alpha-lipoic acid, for example, the alpha-lipoic acids sold by NutriChem Resources Company (Walnut, Calif.), Zhejiang Medicines & Health Products Import & Export Co., Ltd (Hangzhou, China), Pure Assay Ingredients (Walnut, Calif.), and any other alpha-lipoic acid. Another exemplary antioxidant that can be used in the provided emulsions is pyrroloquinoline quinone (PQQ), such as PureQQ, sold by Nascent Health Science (Allentown, N.J.). Exemplary of a non-polar ingredient that contains antioxidants that can be included in the provided emulsions is a turmeric/curcumin composition, for example, the turmeric/curcumin composition that is 95% curcumin, sold by Siddharth International, Mumbai, India. Another exemplary antioxidant that can be used in the provided emulsions is sesamin, such as the sesamin sold by KEB Nutraceutical USA, Inc. (Minneapolis, Minn.).

8. Coenzyme Q Compounds

Exemplary of the non-polar ingredients that can be included in the emulsions provided herein are compounds containing the non-polar ingredient coenzyme Q, for example, coenzyme Q10 (also called coQ10, ubiquinone, ubidecarenone, ubiquinol and vitamin Q10). Coenzyme Q compounds are benzoquinone compounds containing isoprenoid units. The number of isoprenoid units in each of the different CoQ species is indicated with a number following CoQ. For example, coQ10 contains 10 isoprenoid units. Coenzyme Q10 is a predominant coenzyme Q species. CoQ10 has electron-transfer ability and is present in cellular membranes, such as those of the endoplasmic reticulum, peroxisomes, lysosomes, vesicles and the mitochondria. A decrease in natural coQ10 synthesis has been observed in sick and elderly people. Because of this observation and its potent antioxidant properties, coQ10 is used as a dietary supplement and a treatment for diseases such as cancer and heart disease. CoQ10, however, exhibits relatively poor bioavailability.

Coenzyme Q can exist in two different forms: an oxidized form and a reduced form. When the oxidized form of a coenzyme Q species is reduced by one equivalent, i.e., partially reduced, it becomes a ubisemiquinone (semiquinone), denoted QH, which contains a free radical on one of the oxygens in the benzene ring of the benzoquinone. Further oxidation of QH results in ubiquinol, the fully reduced, active form of coQ10. Both oxidized and reduced coenzyme Q-containing compounds can be used as non-polar ingredients in the provided emulsions. CoQ10 typically refers to the oxidized form of coQ10, which also is referred to as ubidecarenone, as opposed to the partially reduced form of coQ10, referred to as ubisemiquinone, and the fully reduced form of coQ10, referred to as ubiquinol. Both the reduced (i.e., coQ10, ubiquinone, ubidecarenone) and oxidized forms (i.e., ubisemiquinone and ubiquinol) of coQ10 are exemplary of the coenzyme Q species that can be used as non-polar ingredients in the provided emulsions.

CoQ10-containing compounds are available commercially. Any coQ10 compound or oxidized coQ10 compound can be used with the provided emulsions. Exemplary of the coQ10 compounds that can be used are coenzyme Q10 compounds containing greater than 98% or greater than about 98% ubidecarenone, for example, the compound sold under the name Kaneka Q10™ (USP Ubidecarenone) by Kaneka Nutrients, L.P. (Pasadena, Tex.). The compound sold under the name Kaneka Q10™ is fermented entirely from yeast and is identical to the body's own coQ10 and free from the cis isomer found in some synthetically produced coQ10 compounds. Another exemplary compound includes non-polar ingredients containing the reduced form of coQ10, ubiquinol, for example, the compound Kaneka Ubiquinol® sold by Kaneka Nutrients (Pasadena, Tex.). Any coQ10 compound containing the reduced or oxidized form of coQ10 can be used in the provided emulsions provided herein.

9. Carotenoid-Containing Compounds

Exemplary of the non-polar ingredients used in the provided emulsions are carotenoid-containing compounds, for example, carotenoids, including hydrocarbons (carotenes) and oxygenated, alcoholic derivatives of hydrocarbons (xanthophylls), for example, beta-carotene, mixed carotenoids complex, lutein, zeaxanthin, cryptoxanthin, for example, beta-crytoxanthin, lycopene, astaxanthin, bixin, canthaxanthin, capsanthin, capsorubin, apo-carotenal, beta-12′-apo-carotenal, “carotene” (mixture of alpha- and beta-carotene), gamma-carotene, ciolerythrin and esters of hydroxyl- or carboxyl-containing members thereof. Carotenoids are efficient free-radical scavengers, or anti-oxidants, and are capable of enhancing the vertebrate immune system.

(a) Carotenes

Exemplary of the carotenoid-containing compounds used as non-polar ingredients containing non-polar compounds in the provided emulsions are carotenes, for example, alpha-carotene, beta-carotene, lycopene, and mixtures thereof. Any carotene-containing compound can be used as a non-polar ingredient in the provided compositions. Exemplary of a carotene-containing compound that can be used in the provided emulsions is lycopene, sold by Zhejiang Medicine CO., LTD (Xinchang Pharmaceutical Factory, Xinchang, China), a purple or red crystalline powder containing not less than 70% all E-lycopene, not more than 23% 5-Z-lycopene and not more than 9% related substances.

(b) Xanthophylls

Exemplary of the carotenoid-containing compounds used as non-polar ingredients containing non-polar compounds in the provided emulsions are xanthophylls, for example, astaxanthin, neoxanthin, violaxanthin, α- and β-cryptoxanthins, lutein and zeaxanthin. Xanthophylls, or phylloxanthins, are oxygen-containing carotenoids that are typically yellow pigments. Any xanthophyll can be used as a non-polar ingredient in the provided emulsions. An exemplary xanthophyll included in the emulsions provided herein is astaxanthin, for example, the astaxanthins AstaREAL® (sold by Fuji Health Science, Burlington, N.J.), AstaPure® (sold by Alga Technologies, Hevel Eilot, Israel), and BioAstin® (sold by Cyanotech, Kailua-Kona, Hi.). Unlike other carotenoids, astaxanthin is not converted to vitamin A (retinol) in the human body, but has potent antioxidant activity and can be beneficial in cardiovascular, immune, inflammatory and neurodegenerative diseases. Other exemplary xanthophyll compounds that can be included in the provided emulsions are lutein and zeaxanthin, sold under the name Xanmax®-80 (Lutein crystals), by Katra Phytochem (India) Private Limited, Bangalore, India, containing 80% lutein and 4.5% zeaxanthin.

10. Boswellia Extracts

Exemplary of non-polar ingredients used in the provided emulsions are non-polar ingredients containing extracts of a Boswellia plant or a boswellic acid or derivative thereof. Extracts of the Boswellia family of plants, including, for example, Boswellia Serrata, exhibit anti-inflammatory, anti-arthritic and anti-ulcerogenic activity (see, e.g., U.S. Pat. No. 6,589,516). Extracts derived from Boswellia plants and suitable for use in the emulsions provided herein include extracts derived from Boswellia Cartenii, Boswellia Frereana, Boswellia Bhau-dajaina, Boswellia Serrata, and Boswellia Thurifera. The extracts derived from Boswellia plants can be gums, oleo-gums, resins, essential oils and residues, or mixtures thereof. A typical extract of a Boswellia plant suitable for use herein includes at least one boswellic acid, for example, acetyl-11-keto-ß-boswellic acid (AKBA). Exemplary of a Boswellia extract-containing compound that can be used as the non-polar ingredient in the provided emulsions is ApresFLEX®, a compound that includes a Boswellia serrata extract that contains acetyl-11-keto-ß-boswellic acid (AKBA), sold by PLT Health Solutions, Morristown, N.J.

11. Phospholipids

Exemplary of the non-polar ingredients that can be used in the provided emulsions are phospholipids. Phospholipids are amphipathic lipid-like molecules, typically containing a hydrophobic portion at one end of the molecule and a hydrophilic portion at the other end of the molecule. A number of phospholipids can be used as ingredients in the provided emulsions, for example, lecithin, including phosphatidylcholine (PC), phosphatidylethanolamine (PE), distearoylphosphatidylcholine (DSPC), phosphatidylserine (PS), phosphatidylglycerol (PG), phosphatidic acid (PA), phosphatidylinositol (PI), sphingomyelin (SPM), and combinations thereof. Exemplary of the phospholipids that can be used in the provided compositions are the phospholipids sold by Lipoid, LLC (Newark, N.J.), for example, sunflower lecithins, Purified Egg Lecithins, Purified Soybean Lecithins, Hydrogenated Egg and Soybean Lecithins, Egg Phospholipids, Soybean Phospholipids, Hydrogenated Egg and Soybean Phospholipids, Synthetic Phospholipids, PEG-ylated Phospholipids and phospholipid blends. Exemplary of a phosphatidylserine that can be used in the provided emulsions is a phosphatidylserine (PS) composition that contains 40% phosphatidylserine and lesser amounts of phosphatidylinositol, phosphatidylethanolamine and phosphatidylserine (sold by Doosan Corporation and distributed by Perrimondo LLC).

### G. PRESERVATIVES AND STERILIZERS

The emulsions provided herein can contain one or more preservatives (or preservativers) and/or sterilizers. The preservative or sterilizer can be included to improve the stability. Preservatives can be added to preserve the ingredients, for example, in order to prevent oxidation of the ingredients, for example, the non-polar ingredients, for example, the omega-3 containing compounds, for example, the DHA. Preservatives, particularly food and beverage preservatives, are well known. Any known preservative can be used in the provided emulsions. Exemplary of the preservatives that can be used in the provided emulsions are oil soluble preservatives, for example, benzyl alcohol, benzyl benzoate, methyl paraben, propyl paraben, and antioxidants, for example, vitamin E, vitamin A palmitate and beta carotene. Typically, a preservative is selected that is safe for human consumption, for example, in foods and beverages, for example, a GRAS certified and/or Kosher-certified preservative, for example, benzyl alcohol.

Any preservative typically represents less than 1%, less than about 1%, 1% or about 1%, by weight (w/w), of the emulsion or liquid concentrate or between 0.1% or about 0.1% and 1% or about 1%, by weight (w/w), of the concentrate, for example, 0.1%, 0.2%, 0.3%, 0.4%, 0.5%, 0.6%, 0.7%, 0.725%, 0.75%, 0.8%, 0.9%, 1%, about 0.1%, about 0.2%, about 0.3%, about 0.4%, about 0.5%, about 0.6%, about 0.7%, about 0.8%, about 0.9%, about 1%, by weight (w/w), of the concentrate.

### H. POLAR PROTIC SOLVENTS

The emulsions provided herein include one or more polar protic solvents. The polarity of a solvent generally indicates which compounds are soluble in the solvent, and with which other solvents/liquids the solvent is miscible. Polar compounds are more readily solubilized in water and other polar solvents than are non-polar ingredients and ingredients. The emulsions provided herein generally contains between about 10%, 11%, 12%, 13%, 14% or 15% and 50%, by weight of the resulting emulsion, of one or more polar protic solvents, such as water and/or glycerin.

Polar protic solvents, include, but not limited to, water; alcohols, such as dihydric alcohols which contain two hydroxyl groups (for example, glycols, e.g., propylene glycol, ethylene glycol, tetraethylene glycol, triethylene glycol, trimethylene glycol), trihydric alcohols which contain three hydroxyl groups (e.g., glycerin, butane-1,2,3-triol, pentane-1,3,5-triol, 2-amino-2-hydroxymethyl-propane-1,3-diol), monohydric alcohols, such as ethanol. For use herein, the polar protic solvent is non-toxic.

The polar protic solvent is present in a moderate concentration, for example, the total amount of polar solvent in the emulsion as a percentage (%) by weight is between or between about 10% and 60%, such as between or between about 10%, 11%, 12%, 13% or 14% and 50%, such as 10% to 50%, 12% to 50%, 13%-50%, 15% to 20%, 15% to 25%, 15% to 30%, 15% to 35%, 15% to 40%, 15% to 45%, 15% to 50%, 20% to 25%, 20% to 30%, 20% to 35%, 20% to 40%, 20% to 45%, 20% to 50%, 25% to 30%, 25% to 35%, 25% to 40%, 25% to 45%, 25% to 50%, 30% to 35%, 30% to 40%, 30% to 45%, 30% to 50%, 35% to 40%, 10% to 35%, 10% to 45%, 35% to 45%, 35% to 50%, 40% to 45%, and 40% to 50%, polar solvent, by weight, of the emulsion. Exemplary concentrations of the polar protic solvent in the emulsions are at least or are at least about 12%, 13%, 14%, 15%, 17%, 20%, 24%, 25%, 2%, 27%, 28%, 29%, 30%, 31%, 32%, 33%, 34%, 35%, 36%, 37%, 38%, 39%, 40%, 41%, 42%, 43%, 44%, 45%, 48%, 50%, 52%, 55%, 56%, 57%, 58%, and 60% (w/w) of the emulsion.

In the provided methods for making the emulsions, the polar solvent is added to the polar phase. In one example, the polar solvent is water, e.g., purified water, such as water that is purified prior to use, for example, by charcoal filter, ion exchange, reverse osmosis, UV sterilization and/or filtering using a filter, for example, a 50-100 micron filter. Typically, when a filter is used, it is an end point of use filter, which filters the water before it reaches the tank in the provided process. Alternatively, previously filtered water can be used.

### I. OPTIONAL INGREDIENTS

The compositions provided herein can further contain one or more other additives such as taste modifying agents, a buffering agent, a chelating agent, a colorant, an osmotic modifier, a solubilizer, a tonicifier, a trace element, and a viscomodulator. The compositions can contain suitable sweeteners and flavorings. The compositions can contain additional active ingredients.

Taste modifying agents for use herein include, but are not limited to flavoring agents, sweetening agents and taste masking agents and are exemplified by: the essential oils or water soluble extracts of menthol, wintergreen, peppermint, sweet mint, spearmint, juices or juice concentrates, natural and artificial vanilla, cherry, chocolate, fudge, butterscotch, cinnamon, clove, lemon, orange, raspberry, tangerine, grapefruit, blueberry, peach, rose, spice, violet, herbal, fruit, strawberry, grape, pineapple, peach, kiwi, papaya, mango, coconut, apple, coffee, plum, watermelon, nuts, durean, green tea, grapefruit, banana, butter, cream custard, camomile, sugar, dextrose, lactose, mannitol, sucrose, xylitol, maltitol, acesulfame potassium, talin, glycyrrhizin, sucralose, aspartame, saccharin, sodium saccharin, sodium cyclamate and honey. In certain embodiments, the taste modifying agent is selected from natural and artificial vanilla, cream custard, banana, fudge, butterscotch, strawberry, coconut and chocolate. Many such agents are commercially available.

Buffering agents and pH adjusters include, but are not limited to acidulants and alkalizing agents exemplified by citric acid, fumaric acid, lactic acid, tartaric acid, malic acid, as well as sodium citrate, sodium bicarbonate, and carbonates, including KHCO₃, sodium or potassium phosphate and magnesium oxide. pH adjuster-1 is triethanolamine or potassium bicarbonate, pH adjuster-2 is soda ash or sodium bicarbonate. The particular pH at which the compositions are formulated depends upon the selected agent(s). Coloring agents for use in the compositions include, but are not limited to FD & C coloring agents, natural coloring agents, and natural juice concentrates, pigments such as titanium oxide, silicon dioxide and zinc oxide.

Stabilizers as used in the compositions provided herein, include, but are not limited to anti-oxidants, chelating agents, and enzyme inhibitors as exemplified by ascorbic acid, vitamin E, butylated hydroxyanisole (BHA), butylated hydroxytoluene (BHT), propyl gallate, dilauryl thiodipropionate, thiodiproprionic acid, gum guaiac, citric acid, edetic acid and its salts and glutathione.

The compositions can contain preservatives which include, but are not limited to benzyl alcohol, sodium benzoate, potassium sorbate, parabens and derivatives, such as methyl paraben, propyl paraben, sorbic acid and its salts, propionic acids and its salts, sulfur dioxide and sulfites, acetic acid and acetates, and nitrites and nitrates.

The compositions can contain additional active ingredients which include, but are not limited to, L-theanine (L-γ-glutamylethylamide or N⁵-ethyl-L-glutamine), Grifola frondosa (e.g., maitake mushrooms, king of mushrooms, dancing mushrooms, cloud mushrooms, hen of the woods), lions mane mushroom mycelia (Hericium erinaceus), reishi mushrooms (e.g., Basidiomycetes Mushroom), citicholine (e.g., 5′-Cytidine diphosphate choline, CDPC, CDP Choline, CDP-Choline, Citicholine, Citicolina, Cytidine 5-Diphosphocholine, Cytidine 5′-diphosphocholine, Cytidine (5′) diphosphocholine, Cytidine Diphosphate Choline, Cytidine Diphosphocholine, Cytidinediphosphocholine), cordyceps (e.g., cordyceptin, 3-deoxyadenosine), silk fibroin (e.g., Cera-Q), BF-7, Mangifera indica Leaf Extract (e.g., zynamite), and/or theobromine (e.g., Chocomine®).

### J. EXEMPLARY METHODS FOR PREPARING THE EMULSIONS

Those of skill in the art know how to prepare emulsions; methods are described in the Examples below. The ingredients in the emulsions prepared as described above and in the examples, contain whey protein, nut butter, and/or collagen; an edible oil, such as canola oil, flaxseed oil, coconut oil, conjugated linoleic acid (CLA), borage oil, rice bran oil, D-limonene, canola oil, corn oil, MCT (medium chain triglycerides) oil and/or oat oil; a surfactant, such as a polyalkylene glycol derivative of vitamin E, such as a tocopheryl polyethylene glycol succinate (TPGS); stabilizers, including potassium bicarbonate; pH adjuster or an edible acid, such as citric acid; non-polar nutraceutical compounds, such as fish oil and cannabidiol (CBD) oil and/or hemp oil; phospholipids, such as where the phospholipip is a phosphatidylcholine; sweeteners, such as sugar; flavorings; a polar solvent(s), such as water or water and glycerin; and, optionally, other active ingredients.

### K. EXAMPLES

The following examples are exemplary only and are not intended to limit the scope of the subject matter claimed herein.

### Example 1

### Materials and Methods

### A. Tocopheryl Polyethylene Glycol Succinate (TPGS)

TPGS can be purchased from commercial sources, such as Eastman. Alternatively, the TPGS can be a high dimer form, described in U.S. Pat. No. 9,351,517, now commercialized as ELSOV (Virun), that contains a higher percentage of dimer form than the commercially available TPGS.

D-α-Tocopheryl polyethylene glycol 1000 succinate (TPGS 1000) was synthesized from vitamin E succinate according to the following general procedure. See also, U.S. patent application Ser. No. 14/207,310 and International Patent Application No. PCT/US14/25006. Polyethylene glycol (PEG) 1000 (168.7 kg) was added to a reaction flask containing 1430 L of toluene, followed by the addition of 71.5 kg of vitamin E (α-tocopheryl acid) succinate and 2.86 kg of p-toluene sulfonic acid. The reaction mixture was heated to 110-112° C. and refluxed for up to 6.5 hours, removing the water formed during the esterification reaction by azeotropic distillation. The reaction was terminated when the desired amounts of TPGS monomer and TPGS dimer were formed, as indicated by high performance liquid chromatography (HPLC) and thin layer chromatography (TLC), resulting in the TPGS compositions set forth in Table 1 below. Each TPGS composition in Table 1 was formed by terminating the reaction at a different time point, up to 6.5 hours, and contained various amounts of TPGS monomer and TPGS dimer. The remainder of the TPGS composition was made up of unreacted starting materials, such as vitamin E and PEG. The reaction was terminated by cooling the reaction mixture to room temperature, followed by washing with 25 L of a 10% solution of NaHCO₃. The solution stirred for 10 minutes, and after stirring was allowed to separate into layers. The organic (toluene) layer was removed, 6 kg of activated carbon (charcoal) was added, and the solution was heated to 55-60° C. and maintained at this temperature for 1 hour. The solution was then cooled to room temperature, filtered through 10 kg of Celite® Hyflo® filter aid (Sigma Aldrich, St Louis, Mo.) and then washed with 100 L of toluene. The filtered toluene solution was concentrated by vacuum distillation below 60° C. to remove the toluene. Water (140 L) was added to remove traces of toluene and was then removed via vacuum distillation below 60° C. to obtain ˜180 kg of a crude α-tocopheryl polyethylene glycol 1000 succinate composition that contained a mixture of TPGS monomer and TPGS dimer, along with unreacted PEG 1000 and α-tocopherol.

TABLE 1
Exemplary Amounts of TPGS monomer and TPGS dimer reaction

| | | | Total |
|---|---|---|---|
| TPGS | Monomer | Dimer | (% monomer + |
| composition | (%) | (%) | % dimer) |
| 1 | 43.90 | 53.90 | 97.80 |
| 2 | 42.80 | 48.80 | 91.60 |
| 3 | 40.95 | 53.15 | 94.10 |
| 4 | 43.52 | 49.80 | 93.32 |
| 5 | 55.88 | 29.27 | 85.15 |
| 6 | 52.92 | 33.70 | 86.62 |
| 7 | 42.76 | 51.10 | 93.86 |
| 8 | 40.39 | 54.90 | 95.29 |
| 9 | 57.70 | 40.40 | 98.10 |
| 10 | 39.35 | 35.56 | 74.91 |
| 11 | 60.00 | 38.10 | 98.10 |

A series of extractions were performed on the crude TPGS composition. The crude TPGS composition (˜180 kg) was dissolved in 360 L of methanol and then 540 L of cyclohexane was added. The solution was stirred and then allowed to separate into layers. The cyclohexane layer was removed and an additional 540 L of cyclohexane was added to the remaining methanol layer. The solution was stirred and then allowed to separate into layers. The cyclohexane layer was again removed and an additional 540 L of cyclohexane was added to the remaining methanol layer. The solution was again stirred and allowed to separate into layers. The cyclohexane layer was removed, and the remaining methanol layer was further diluted with an additional 270 L of methanol. Activated carbon (18 kg) was added and the solution was heated to 55-60° C. and maintained at this temperature for 1 hour. The solution was then cooled to room temperature, filtered through 30 kg of Celite® Hyflo® filter aid, and washed with 100 L of methanol. The methanol solution was passed through a micron filter, then concentrated via vacuum distillation below 60° C. to obtain ˜98-102 kg of a TPGS composition. All traces of solvent were then removed by purging with nitrogen at 55° C. for two hours to obtain ˜98-102 kg of a purified TPGS composition that contained TPGS monomer and TPGS dimer.

One typical batch of TPGS prepared to contain a high dimer concentration, and used in the Examples below, had the following components:

TPGS monomer: 48%
TPGS dimer: 51%

### Vitamin E: 0.42%

Vitamin E succinate: 0.46%.
Other typical batches contained:
TPGS monomer: 46.09%-43.15% w/w
TPGS dimer: 39.07%-50.28% w/w
Other: up to about 3%-3.2% w/w
For example, the batches used in Example 11, below, contained:
TPGS monomer: 46.55%-48.72% w/w
TPGS dimer: 46.88%-47.33% w/w
Other: up to about 3.95%-6.55% w/w
The resulting product is commercialized and sold under the trademark ESOLV®. TPGS

Any preparation of TPGS, standard commercially available TPGS, and the high dimer form, can be further purified to remove any free PEG moieties. This can be accomplished by any suitable method, such as ion exchange chromatograph (see, e.g., Yun et al. (2005) J. Biotechnology 118:67-74). For example, PEGylated protein can be separated from unPEGylated protein using SP-Sepharose Fast Flow cation-exchange media (2.6 cm×10 cm). In some examples, two consecutive ion-exchange chromatographic separation steps are necessary. After elution, individual fractions can be analyzed by SDS-PAGE.

Removal of substantially all or substantially all of the free PEG produces a larger particle size in the resulting emulsion. The free PEG present in typical TPGS products acts as a co-emulsifier and produces a much smaller particle size. The emulsions provided herein, have a particle size greater than 5 μm. Also, the water activity is low, 0.86 or less, which helps produce large particle size than g higher levels of water activity. Using TPGS that contains free PEG, however, permits addition of more protein to the emulsions; the addition of more protein compensates to further increase the particle size.

### B. Water/Glycerin Phase Ingredients

Various nut butters, such as almond, hazelnut, brazil nut, peanut and others, for addition to the emulsions provided herein, are prepared by grinding the nuts. Sugar or other sweetener, optionally, can be added. The nut butters for use herein should not contain hydrogenated oils or preservative.

For example, almond butter for addition to the water/glycerin phase is produced only with dry roasted almonds with no other added ingredients. Nut butters are commercially available (such as commercially available almond butter such as Valley Harvest Almond Butter by the Valley Harvest Nut Co., Inc. (Modesto, Calif.) or commercially available almond butter products produced by Spread the Love (Los Angeles, Calif.)), and should be those that contain ground nuts, and, optionally some sugar. Almond butters can be produced by grinding the nuts, pulverizing the nuts and preferably by pulverizing and then grinding the nuts.

Cashew butter for addition to the water/glycerin phase is produced only with dry roasted cashews or raw cashews with no other added ingredients, including no added sugar, salt, hydrogenated oils or preservatives. Steamed pasteurized cashews also may be used. Cashew butter used in the examples below is commercially available (such as roasted cashew butter produced by Fitjars™ (London, England; Product No. W180)). Cashew butter also may be prepared by grinding the nuts, pulverizing the nuts and preferably by pulverizing and then grinding the nuts. Cashew butter produced from raw cashews also can be used. Cashew butter from raw cashews used in the examples below is commercially available cashew butter from Artisana Foods (Oakland, Calif.).

Whey protein concentrate for addition to the water/glycerin phase in Examples below is 80% whey protein concentrate obtained from, for example, Marquez Brothers (Hanford, Calif.), which contains at least 80% pure whey protein by weight of the powder. The whey protein concentrate contains no added preservatives or artificial fillers such as sweeteners, flavors, fructose, L-Tryptophan, salt or acid-treated whey.

When analyzed, the whey protein concentrate used in the Examples (below) adhered to the following specifications: 82.03% protein; 4.77% moisture; 810% fat; pH of 5% solution at 20° C. of 6.52. Microbiological assessment results are as follows: <10 APCC/g of coliform count: 1100 PAC/g aerobic plate count; <10/g yeast and mold; negative for salmonella per 375 g; and negative for B. cereus.

Whey protein isolate for addition to the water/glycerin phase in the Examples (below) is 90% whey protein concentrate obtained from, for example, Southwest Cheese Co. LLC (Clovis, N. Mex.) which contains approximately 90% pure whey protein by weight of the powder. Whey protein isolate has higher protein content and lower fat, lactose and carbohydrate content than the whey protein concentrate. Whey protein isolate also contains no added preservatives or artificial fillers such as sweeteners, flavors, fructose, L-Tryptophan, salt or acid-treated whey. When analyzed, the whey protein isolate used in the Examples (below) adhered to the following specifications: 88.29% protein (As is percentage); 92.07% protein dry basis; 4.11% moisture; 6.28 pH; acceptable level of scorched particles per 25 g; 0.67% fat; 2.25% Ash; 300 cfu/g by standard plate count; <1 cfu/g of coliforms; <10 cfu/g of yeasts and molds; negative for salmonella per 375 g; and <1 cfu/g of S. aureus.

BioCell® Collagen (containing hydrolyzed collagen type II, hyaluronic acid, and Chondroitin Sulfate; see, U.S. Pat. No. 6,780,841) for addition to the water phase in the Examples (below) was obtained from BioCell. It is prepared as described in U.S. Pat. No. 6,780,841. Whole cartilage is suspended in an aqueous solution, generally water, for about one hour at about 35° C. at a pH of between about 6 and 7. The water is removed, and the cartilage is incubated with one or more proteases obtainable from a natural source (i.e., papain, ficin, bromelain) for between about 2 and 10 hours, generally about 6 hours, at about 35-55° C. ata pH of between about 4 and 8, depending upon the pH optimum of the selected enzyme, to form a hydrolysate. The hydrolysates then is sterilized for about 30 minutes ata temperature between about 95 and 105° C. The sterilized hydrolysate is filtered through diatomaceous earth, concentrated, such as under vacuum, and dried to form a fine powder, which is water soluble, and packed. The powder contains ˜60% hydrolyzed type II collagen, ˜20% depolymerized chondroitin sulfate, ˜10% hyaluronic acid, and other proteoglycans. BioCell® Collagen contains no genetically modified organisms, gluten, soy, shellfish, fish, egg, milk, peanuts, or sugar.

Chocolate powder for addition to the water phase in the Examples (below) was obtained, for example, Ghiradelli® chocolate powder or raw organic cacao powder (Ecuador sample). Chocolate powder can be prepared by grinding cocoa beans, and processed using water extraction and filtration. Chocolate powder may be prepared by a process of “dry mixing” in which a chocolate powder is produced from a mixture of milk powder, sugar, cocoa mass and cocoa butter to form a chocolate mixture which can be ground into a resulting powder. The resulting powder can be refined. The chocolate powder may contains cocoa and generally contains cocoa powder and sugar. Chocolate powder may optionally contain unsweetened chocolate, soy lecithin (an emulsifier) and/or vanilla. Cocoa powder is untreated, ground cacao beans, with all of the natural fat of the beans removed.

Chocolate syrup for addition to the water phase in the Examples (below) was prepared, for example, by combining Ghiradelli® chocolate powder or raw organic cacao powder (Ecuador sample) with water wherein the final composition was 30% chocolate powder and 70% water. The chocolate syrup may contain cocoa alone, cocoa powder and sugar, and, optionally, unsweetened chocolate, soy lecithin (an emulsifier) and/or vanilla.

### C. Oil Phase Ingredients

The oil phase contains an oil, such as MCT oil. The oil phase is typically about 10% to 40%, but can be 5%-55%, 10%-50%, 10%-35%, 5%-30%, by weight of the emulsions. The oil phase can include a non-polar active ingredient, such as a fish oil, algal oil, and/or CBD oil, and/or vitamins and other such nutraceuticals. The fish oil or other oil can constitute the entire oil phase, but generally is mixed with another edible oil, such as MCT oil and/or CLA oil.

MCT oil as used in the Examples primarily contains caprylic and capric fatty acids, and is a light-yellow, odorless, translucent liquid at room temperature. MCT oil occurs naturally in coconut oil and other foods. MCT oil used in the following examples was 92% MCT oil isolated from Coconut Oil and obtained from Stepan Specialty products (Northfield, Ill.) or from ABITEC. Capric (C10) and caprylic acid (C8) also are used. In other examples, the MCT oil is obtained from Arista Industries, Inc. (Wilton, Conn.). In one example, the MCT oil from Arista Industries conforms to the following parameters: specific gravity at 20° C. of 0.948 g/mL; refractive index at 20° C. of 1.449; saponification value of 332 mg KOH/g; unsaponifiable matter value ata maximum of 0.5%; moisture of 0.03%; acid value of 0.02 mg KOH/g; iodine value of 0.2 g I/100 g; peroxide value of 0.2 mEq/kg; hydroxyl value of 2.9 mg/KOH/g; ash value of a maximum of 0.1%; viscosity at 20° C. of 31 mPn/s; alkaline impurities of less than 0.15 mL 0.01N HCl; Total C8:0 and C10:0 percent area of 99.8. Fatty Acid compositions of the MCT oil obtained from Arista Industries, Inc. were as follows: Caproic acids C 6:0 of 0.0 percent area; Caproic acids C 8:0 of 56.1 percent area; Capric acids C 10:0 of 43.7 percent area; Lauric acid C 12:0 of 0.1 percent area; and Myristic acid C 14:0 at or below 1.0 percent area. Contaminants in the MCT oil obtained from Arista Industries, Inc. fell below maximum values as follows: lead value below max of 0.1 ppm; arsenic value below max of 0.5 ppm; cadmium level of less than 0.1 ppm; mercury level of less than 0.1 ppm; and a total level of heavy metals less than 10 ppm.

In some of the Examples (below), conjugated Linoleic Acids (CLA) (78% or 80%) was added to the oil phase. In the examples, below, 80% CLA, obtained from Stepan Specialty products (CLARINOL® G-80 CLA), is mainly in triglyceride form made from natural safflower oil. CLA also was obtained from Cognis Corporation, sold under the trade name Tonalin® (Cincinnati, Ohio) which contained 1.7%, by weight (w/w), C16:0 Palmitic acid, 2.6%, by weight (w/w), C:18 Stearic acid, 13.00% C18:1 C9 Oleic acid, 0.20%, by weight (w/w), C18:2 C9 C12 Linoleic acid and 81.00%, by weight (w/w), conjugated linoleic acid (CLA), which included 39.70% Conjugated C9, T11 isomer and 39.50% Conjugated T10, C12 isomer.

In some of the Examples (below), the non-polar active ingredient was CBD. CBD oil was 60% phytocannabinoid-Rich (PCR) oil. The CBD oil used in the examples below has no detectable levels of THC. CBD oil was 60% phytocannabinoid-Rich (PCR) oil obtained from Centuria Natural Foods (Carson City, Nev.) as a concentrate of 302 mg/g or approximately 30.2% CBD. In some of the Examples (below), the non-polar active ingredient was hemp oil, which is used interchangeably with CBD oil. The hemp oil was HempCHOICE® 60% phytocannabinoid-Rich (PCR) Oil (10 mg PCR per 4 mL and 63.75 mg PCR per 15 ml is 10.2 mg per 4 mL).

In some of the Examples (below), the non-polar active ingredient was a fish oil, containing about 30% DHA/EPA (sold under the name Omega 30 TG Food Grade (Non-GMO) MEG-3™ Fish Oil by Ocean Nutrition Canada Limited, Nova Scotia, Mass.). The fish oil non-polar active ingredient was added, for example, in an amount of 18.33%, by weight of the final emulsion, whereby the concentrate contained 5.5% EPA+DHA.

In some of the Examples (below), the non-polar active ingredient was algal oil (40%). The algal oil was obtained from Algarithm (Saskatoon, Saskatchewan) which is sold as AlphaMega³™. The algal oil is vegetarian and is not genetically modified. DHA rich triglycerides are extracted in an aqueous based process; no chemical solvents are used. The resulting oil is then refined, bleached and deodorized to meet the following quality parameters: EPA of 1.85%, 17.0 mg/g); DHA of 42.4%; 400.6 mg/g; and total Omega 3 of 45.4%; 428.9 mg/g. The bleached and deodorized algal oil contains at least 40% DHA (400 mg/g). The algal oil exhibited the following properties: peroxide value of 0.36 meq/kg oil; p-Anisidine value of 5.56; acid value of 0.28 mg KOH/g; moisture and insoluble impurities of less than 0.03%; free fatty acids of 0.14%; and color (Gardner) of 5.2. The algal oil also was assessed for heavy metal content and the following results were established: arsenic of <0.5 ppm; cadmium of <0.01 ppm; lead of <0.01 ppm; and mercury of <0.005 ppm. The microbial content of the algal oil was established as follows: total microbial count of <5; E. Coli count of <5; negative for Salmonella; Staphylococcus aureus count of <5; yeast count of <5; and mold count of <5. Mixed tocopherol levels were also calculated as 1840 ppm.

In the Examples (below) the potassium bicarbonate was obtained from Vivion, Inc. (San Carlos, Calif.). The potassium bicarbonate adhered to the following specifications: 100% potassium bicarbonate; 38.4% potassium; 0.007% water insoluble; 0.008% K2504; 2 ppm heavy metals (e.g., As, Pb); 0.9 ppm lead; 0.4 ppm arsenic; 0.007% KCl; 0.0007% Fe₂O₃; 0.16% moisture; pH=8.4; passable range of normal carbonate; particle size such that the composition had 100% pass through 35 mesh; and the potassium bicarbonate tested negative for TPC, E. coli, mold and yeast.

In the Examples (below), the pH adjuster was triethanolamine (C₆H₁₅NO₃) obtained from VWR International (Radnor, Pa.) and was originally produced by Alfa Aesar (Tewksbury, Mass.). Any suitable edible pH adjuster can be used. The triethanolamine adhered to the following specifications: total alkanolamines of 99.94%; 1.123 specific gravity at 25° C. (allowable range 1.120-1.128); 1.484 refractive index at 20° C. (allowable range 1.481-1.486); 0.02% water determination (maximum allowable 0.5%); <0.05% residue on ignition (maximum allowable 0.05%); elemental impurities that complies with standards; and no residual solvents were used. pH of the compositions generally is adjusted to between about 7.2 and 8.2, but can be lower, such as between 6 and 8, or between 4 and 8, such as between or about between pH 4.6 and 6. It is shown herein, the stability can be improved by lowering the pH or preparing emulsions with a pH between or between about 4.61 and 6.0, such as at or about pH 4.7 or pH 5.6.

### D. General Protocol Used to Make Emulsions in the Examples

Tables 2 through 23 below, set forth ingredients that were used to make the exemplary liquid emulsions described in Examples 2-12, below. Each of these emulsions contained non-polar ingredients, a polar solvent(s), and CBD oil, Hemp Seed oil, algal oil or Conjugated Linoleic Acid (CLA). Each emulsion was produced, according to this general method, in a 150 gram (g) to 2700 kg batch (batch sizes indicated in Tables).

Each of the applicable Tables below, set forth the milligrams (mg) per 15 mL or 2 mL serving of each ingredient in the exemplary mixture, the percentage, by weight (of the total mixture), for each ingredient and the amount in grams (g) or kilograms (kg) of each ingredient per 150 gram (g) to 2700 kg batch. Also indicated in each table, in the “phase” column, is whether each ingredient was added to the water phase (“water/glycerin”), the oil phase (“oil”) or was added later, to the emulsion formed after combining the oil and water phases in the emulsification step (“emulsion/flavoring”).

Each of the liquid emulsions set forth in the Examples was made using a bench-top process of the provided methods. To make larger batch sizes, the bench-top process can be scaled up to make any of these exemplary emulsions in the Examples, using a scaled-up manufacturing process of the provided methods as described herein.

The bench-top process for making the emulsions can be performed using the following general steps (further details are provided in the individual examples). To make the emulsions, the indicated amount of each ingredient was weighed using a Toledo Scale (Model GD13x/USA), Sartorius Basic Analytical Scale (Model BA110S) or an OHAUS Scale (Model C52000). Selection of scale(s) depended on the weight of the particular ingredient(s). To generate the water phase, the water phase ingredients (indicated by “water/glycerin” in each table in the “phase” column), were added, in the indicated amount (g/batch), to a water phase vessel (a Pyrex® beaker), and mixed using a reversible homogenizer (Arde Barinco, Inc.; Model CJ-4E or Lightnin Mixer (Model XJC-117)), at 32 RPM. During mixing, the water phase ingredients were heated until the ingredients reached the desired temperature of 71° C.−75° C. (detailed below in the particular examples), using a hot plate as the heating apparatus (a Thermolyne Hot Plate Model # SP46615, Barnstead International, Dubuque, Iowa). The temperature of the water phase and speed of mixing was maintained until combining and emulsifying the water and oil phases. A temperature meter (temperature probe (Model # DPP400W, Cooper-Atkins) or Hanna Instruments pH and Temperature Meter (model HI 8314)) was used to evaluate (measure) the temperature of the water phase. The water phase ingredients included a polar solvent (water and/or glycerin) and additional water phase ingredients, such as sugar, almond butter, cashew butter, whey protein isolate and/or whey protein isolate, where indicated. In other examples, the water/glycerin phase included, pH Adjuster-1 (triethanolamine or potassium bicarbonate), chocolate powder, potassium bicarbonate, and/or BioCell® Collagen.

The oil phase ingredients (indicated by “oil” in each table in the “phase” column) were added to an oil phase vessel (a Pyrex® beaker), and mixed using a standard mixer (IKA® model No. RE-16 1S), which is an overhead mixer (laboratory stirrer) compatible with the bench-top process or Lightnin mixer (manufactured by Lightnin (Rochester, N.Y.); model ND-2)). The oil phase ingredients included a non-polar active ingredient and other oil ingredients as indicated in the Examples.

As the oil phase ingredients were mixed, they were heated using a hot plate as a heating apparatus (a Thermolyne hot Plate Model #5P46615, Barnstead International, Dubuque, Iowa), to a desired temperature of 60° C., or a temperature as indicated in the examples, and generally mixed (such as with an Lightnin mixer (model ND-2)) at this temperature until ingredients had dissolved, and maintained at the temperature before mixing with the water phase. A temperature meter (temperature probe (Model # DPP400W, Cooper-Atkins) or Hanna Instruments pH and Temperature Meter (model HI 8314)) was used to evaluate (measure) the temperature of the oil phase.

After both phases had reached the appropriate temperatures and the oil phase components had dissolved, the phases were combined and emulsified. Emulsification was effected with a reversible homogenizer (Arde Barinco, Inc.; Model CJ-4E). The reversible homogenizer that was being used to mix the water phase ingredients was maintained at 30 RPM for mixing during the emulsification step.

While mixing with the homogenizer at this speed, the oil phase was transferred to the water phase vessel by pouring it from the oil phase vessel into the water phase vessel. Mixing with the homogenizer was continued, with adjustment of the baffle plate on the homogenizer to achieve and maintain an emulsion, for example, by moving the baffle plate further into the forming emulsion and/or out of the forming emulsion. During emulsification, the forming emulsion was rapidly cooled by placing the water phase vessel (beaker) in a water bath, until the temperature of the liquid reached a desired temperature, as indicated in the Examples, between 30° C. and 43° C., (typically taking between about 30 and about 60 minutes).

In some examples, after emulsifying and rapidly cooling, additional ingredients were added, where indicated in the individual Examples/Tables. In some examples, flavoring was added after combining and emulsifying the oil and water phases (indicated by “emulsion/flavoring” in the phase column) while mixing with the reversible homogenizer (Arde Barinco, Inc.; Model CJ-4E).

As a final step, the emulsions were filtered using a 100 micron end-product filter, before further evaluation, dilution, and/or use. pH in each phase, and for the final compositions is adjusted to about 7 to about 8, generally 7.3 to 8.1, with a target of 7.6. In other examples, the pH of the emulsions is between 4 and 8, such as between and 4.6 and 6.0, such as at or about pH 4.7 or at or about pH 5.6. Appropriate amounts of water, glycerin, 80% whey protein concentrate (if applicable), 90% whey protein isolate (as applicable), potassium bicarbonate and pH adjuster were measured. Next, water and glycerin were heated to 65° C. Once the water phase reached 65° C., the 80% whey protein concentrate was added (if applicable). The resulting mixture was vigorously mixed and the 90% whey protein isolate was added (if applicable) with continued vigorous mixing. Once the whey protein was dissolved, pH adjuster was added to the water/glycerin phase. Potassium bicarbonate was added just prior to emulsion.

The oil phase was prepared by first weighing the appropriate amounts of TPGS, sunflower lecithin, MCT oil, canola oil, and/or algal oil. The Vitamin E TPGS was heated to 60° C. and dissolved in the Oil Phase Tank. The MCT Oil was added and mixed with the TPGS. The temperature was maintained at 40° C. Next, the canola oil and then algal oil were added to the TPGS/MCT oil mixture and mixed. The temperature was maintained at 40° C.

The emulsion was prepared by adding the oil phase at 40° C. to the polar phase slowly while mixing at low to medium (1000-15000 RPM) using an Arde Barinco Mixer Type 74D (Serial No. L-1274) until the mixture is homogeneous, or approximately 5 minutes. Next, flavorings (i.e., Nat Graham cracker and Nat S'mores) were added and mixed. The emulsion was allowed to cool in a cooler with mixing to 25° C. and filled into new totes.

### Example 2

### Liquid Emulsions Containing Nut Butter and CBD Oil

Appropriate quantities of the raw materials were weighed for the 150 g batch (15 mL serving size) as shown below:

TABLE 2
“Chocolate Brownie” coffee creamer with a final composition
of approximately 30 mg CBD per 15 mL serving

| Ingredient | Phase | mg/serving | %/serving | g/batch |
|---|---|---|---|---|
| Water | Water/Glycerin | 2993.70 | 19.958 | 29.937 |
| Glycerin | Water/Glycerin | 900.00 | 6.00 | 9.00 |
| Almond Butter | Water/Glycerin | 4050.00 | 27.00 | 40.50 |
| Sugar * | Water/Glycerin | 3650.00 | 24.33 | 36.50 |
| Ph Adjuster-1 (DI Systems and | Water/Glycerin | 100.00 | 0.67 | 1.00 |
| water purification) | | | | |
| TPGS | Oil | 100.80 | 0.672 | 1.01 |
| MCT Oil (92% MCT from Coconut | Oil | 1600.00 | 10.67 | 16.00 |
| Oil CS) | | | | |
| Sunflower Lecithin | Oil | 50.00 | 0.33 | 0.50 |
| 60% CBD Oil | Oil | 52.50 | 0.35 | 0.525 |
| Ph Adjuster-1 (DI Systems and | Oil | 30.00 | 0.20 | 0.30 |
| water purification) | | | | |
| Nat Chocolate Brownie | Emulsion/Flavor | 723.00 | 4.82 | 7.23 |
| Chocolate syrup (30% chocolate | Emulsion/Flavor | 750.00 | 5.00 | 7.50 |
| powder, 70% hot water) | | | | |
| Totals | | 15000.00 | 100.00 | 150.00 |

* sugar is optional, and can be replaced with additional almond butter and/or water/glycerin

The water/glycerin phase was prepared by weighing the appropriate amounts of water, glycerin, almond butter, sugar and pH adjuster. Next, the water and glycerin were heated together to 75° C. Once the water/glycerin reach 75° C., the almond butter was slowly added and mixed. The resulting mixture was re-heated to 72° C. Next, sugar was added and mixed until dissolved. After the almond butter and sugar were dissolved, pH Adjuster-1 was added and temperature was maintained. When is sugar included, it is added before addition of the nut butter.

The oil phase was prepared by first weighing the appropriate amounts of Sunflower Lecithin, TPGS, MCT oil, 60% CBD oil, and pH adjuster. The Vitamin E TPGS was heated to 60° C. and dissolved in the Oil Phase Tank. The MCT Oil was added and mixed with the TPGS. The temperature was maintained at 40° C. The CBD oil was added, and the TPGS, MCT oil and CBD oil were mixed together. Finally, the pH Adjuster-1 was added and temperature was maintained at 40° C.

The emulsion was prepared by adding the oil phase at 40° C. to the polar phase slowly while mixing at low to medium (1000-15000 RPM) using an Arde Barinco Mixer Type 74D (Serial No. L-1274) until the mixture is homogeneous, or approximately 5 minutes. Next, Natural Chocolate brownie flavoring (supplied by Gold Coast Ingredients, Inc.; Product No. 347174) and chocolate syrup were added. The emulsion was allowed to cool in a cooler with mixing to 25° C. and filled into new totes.

### Example 3

### Liquid Emulsions Containing Nut Butter and CBD Oil

Appropriate quantities of the raw materials were weighed for the 150 g batch (15 mL serving size) (Table 3) or 300 g batch (15 mL serving size) (Table 4) as shown below:

TABLE 3
“Churros/Ginger bread cookie” coffee creamer with a final
composition of approximately 30 mg CBD per 15 mL serving

| Ingredient | Phase | mg/serving | %/serving | g/batch |
|---|---|---|---|---|
| Water | Water/Glycerin | 3046.70 | 20.31 | 30.47 |
| Glycerin | Water/Glycerin | 900.00 | 6.00 | 9.0 |
| Almond Butter | Water/Glycerin | 4650.00 | 31.00 | 46.50 |
| Sugar* | Water/Glycerin | 3650.00 | 24.33 | 36.50 |
| Ph Adjuster-1 (DI Systems and | Water/Glycerin | 100.00 | 0.67 | 1.00 |
| water purification) | | | | |
| TPGS | Oil | 100.80 | 0.672 | 1.01 |
| Sunflower Lecithin | Oil | 50.00 | 0.33 | 0.50 |
| MCT Oil (92% MCT from Coconut | Oil | 1600.00 | 10.67 | 16.00 |
| Oil CS) | | | | |
| 60% CBD Oil | Oil | 52.50 | 0.350 | 0.525 |
| Ph Adjuster-1 (DI Systems and | Oil | 30.00 | 0.200 | 0.3 |
| water purification) | | | | |
| Nat. Churros (Gold Coast) (603563) | Emulsion/Flavor | 320.00 | 2.13 | 3.20 |
| Nat. Cinnamon (Gold Coast) | Emulsion/Flavor | 50.00 | 0.33 | 0.50 |
| (381096) | | | | |
| Nat. Vanilla Powder (Gold Coast) | Emulsion/Flavor | 450.00 | 3.00 | 4.50 |
| (652378) | | | | |
| Totals | | 15000.00 | 100.00 | 150.00 |

*sugar is optional, and can be replaced with additional nut butter and/or water/glycerin

TABLE 4
“French vanilla” coffee creamer with a final composition
of approximately 30 mg CBD per 15 mL serving

| Ingredient | Phase | mg/serving | %/serving | g/batch |
|---|---|---|---|---|
| Water | Water/Glycerin | 2866.70 | 19.11 | 57.34 |
| Glycerin | Water/Glycerin | 900.00 | 6.00 | 18.00 |
| Almond Butter | Water/Glycerin | 5200.00 | 34.67 | 104.00 |
| Sugar* | Water/Glycerin | 3650.00 | 24.33 | 73.00 |
| Ph Adjuster-1 (DI Systems | Water/Glycerin | 100 | 0.67 | 2.00 |
| and water purification) | | | | |
| TPGS | Oil | 100.8 | 0.67 | 2.02 |
| MCT Oil (92% MCT from | Oil | 1600.00 | 10.67 | 32.00 |
| Coconut Oil CS) | | | | |
| Sunflower Lecithin | Oil | 50.00 | 0.333 | 1.00 |
| 60% CBD Oil | Oil | 52.50 | 0.35 | 1.05 |
| Ph Adjuster-1 (DI Systems | Oil | 30.00 | 0.20 | 0.600 |
| and water purification) | | | | |
| Nat. Vanilla Powder (Gold | Emulsion/Flavor | 450 | 3.00 | 9.00 |
| Coast)(603498) | | | | |
| Totals | | 15000.00 | 100.00 | 300.00 |

*sugar is optional, and can be replaced with additional almond butter and/or water/glycerin

The water/glycerin phase was prepared by first weighing the appropriate amounts of water, glycerin, almond butter, sugar and pH adjuster-1. Next, the water and glycerin were heated together to 75° C. Once the water/glycerin reach 75° C., the almond butter was slowly added and mixed. The optional sugar is added prior to addition of the nut butter. The resulting mixture was re-heated to 72° C. After the almond butter and sugar were dissolved, pH Adjuster-1 was added and temperature was maintained.

The oil phase was prepared by first weighing the appropriate amounts of Sunflower Lecithin, MCT oil, pH adjuster, TPGS and 60% CBD oil. The Vitamin E TPGS was heated to 60° C. and dissolved in in the Oil Phase Tank. The MCT Oil was added and mixed with the TPGS. The temperature was maintained at 40° C. The CBD oil was added. The TPGS, MCT oil and CBD oil composition, and mixed. Sunflower lecithin then was added to the oil phase. The pH Adjuster-1 was added and temperature was maintained at 40° C.

The emulsion was prepared by adding the oil phase at 40° C. to the polar phase slowly while mixing at low to medium (1000-15000 RPM) using an Arde Barinco Mixer Type 74D (Serial No. L-1274) until the mixture is homogeneous, or approximately 5 minutes. Next, flavorings (i.e., Natural Churros, Natural Cinnamon and Natural Vanilla Powder or Natural Vanilla Powder) were added and mixed. The emulsion was allowed to cool in a cooler with mixing to 25° C. and filled into new totes.

### Example 4

### Spreadable Emulsions Containing Nut Butter and CBD Oil

Appropriate quantities of the raw materials were weighed for the 150 g batch (15 mL serving size) (Table 5) or 300 g batch (15 mL serving size) (Table 6) as shown below:

TABLE 5
“French vanilla” spreadable composition with
approximately 30 mg CBD per 15 mL serving

| Ingredient | Phase | mg/serving | %/serving | g/batch |
|---|---|---|---|---|
| Water | Water/Glycerin | 1166.70 | 7.78 | 11.67 |
| Glycerin | Water/Glycerin | 1500.00 | 10.00 | 15.00 |
| Almond Butter | Water/Glycerin | 4725.00 | 31.50 | 47.25 |
| Cashew Butter | Water/Glycerin | 1575.00 | 10.50 | 15.75 |
| Sugar* | Water/Glycerin | 3650.00 | 24.33 | 36.50 |
| Ph Adjuster-1 (DI Systems and | Water/Glycerin | 100.00 | 0.67 | 1.00 |
| water purification) | | | | |
| TPGS -1 | Oil | 100.80 | 0.672 | 1.01 |
| MCT Oil | Oil | 1600.00 | 10.67 | 16.00 |
| Sunflower Lecithin | Oil | 50.00 | 0.33 | 0.50 |
| 60% CBD Oil | Oil | 52.50 | 0.35 | 0.525 |
| Ph Adjuster-1 (DI Systems and | Oil | 30.00 | 0.20 | 0.30 |
| water purification) | | | | |
| Nat Vanilla (GOLD | Emulsion/Flavor | 450.00 | 3.00 | 4.50 |
| COAST)(603498) | | | | |
| Totals | | 15000.00 | 100.00 | 150.00 |

*sugar is optional, and can be replaced with additional nut butter and/or water/glycerin

TABLE 6
“Plain flavor” spreadable composition with
approximately 30 mg CBD per 15 mL serving

| Ingredient | Phase | mg/serving | %/serving | g/batch |
|---|---|---|---|---|
| Water | Water/Glycerin | 1616.70 | 10.78 | 32.33 |
| Glycerin | Water/Glycerin | 1500.00 | 10.00 | 30.00 |
| Almond Butter | Water/Glycerin | 4725.00 | 31.50 | 94.50 |
| Cashew Butter | Water/Glycerin | 1575.00 | 10.50 | 31.50 |
| Sugar * | Water/Glycerin | 3650.00 | 24.33 | 73.00 |
| Ph Adjuster-1 (DI Systems and | Water/Glycerin | 100.00 | 0.67 | 2.00 |
| water purification) | | | | |
| TPGS -1 | Oil | 100.80 | 0.67 | 2.02 |
| Sunflower Lecithin | Oil | 50.00 | 0.33 | 1.00 |
| MCT Oil | Oil | 1600.00 | 10.67 | 32.00 |
| 60% CBD Oil | Oil | 52.50 | 0.35 | 1.05 |
| Ph Adjuster-1 (DI Systems and | Oil | 30.00 | 0.20 | 0.60 |
| water purification) | | | | |
| Totals | | 15000.00 | 100.00 | 300.00 |

* sugar is optional, and can be replaced with additional nut butter and/or water/glycerin

The water/glycerin phase was prepared by first weighing the appropriate amounts of water, glycerin, almond butter, cashew butter, sugar and pH adjuster-1. Next, the water and glycerin were heated together to 75° C. Once the water/glycerin reached 75° C., the almond butter and then cashew butter was slowly added and mixed. The optional sugar is added prior to adding the nut butter. The resulting mixture was re-heated to 72° C. After the cashew and almond butter were dissolved, pH adjuster-1 was added and the temperature was maintained.

The oil phase was prepared by first weighing the appropriate amounts of TPGS, Sunflower Lecithin, MCT oil, 60% CBD oil, and pH adjuster. The Vitamin E TPGS was heated to 60° C. and dissolved in the Oil Phase Tank. The MCT Oil was added and mixed with the TPGS. The temperature was maintained at 40° C. The CBD oil was added. The TPGS, MCT oil and CBD oil composition were mixed. The sunflower lecithin was the last ingredient added to the oil phase. pH Adjuster-1 was added and temperature was maintained at 40° C.

The emulsion was prepared by adding the oil phase at 40° C. to the polar phase slowly while mixing at low to medium (1000-15000 RPM) using an Arde Barinco Mixer Type 74D (Serial No. L-1274) until the mixture is homogeneous, or approximately 5 minutes. Next, flavoring (i.e., Natural Vanilla), if included, was added and mixed. The emulsion was allowed to cool in a cooler with mixing to 25° C. and filled into new totes.

### Example 5

### Liquid Emulsions Containing Whey Protein and CBD Oil

Appropriate quantities of the raw materials were weighed for the 450 g batch (15 mL serving size) as shown below:

TABLE 7
“S'mores smoothie” composition with approximately 400 mg
DHA, 10 mg CBD, 3 g MCT, and 2 g protein per 15 mL serving

| Ingredient | Phase | mg/serving | %/serving | g/batch |
|---|---|---|---|---|
| Water | Water/Glycerin | 3921.63 | 26.144 | 117.649 |
| Glycerin | Water/Glycerin | 2672.57 | 17.817 | 80.20 |
| 80% Whey Protein | Water/Glycerin | 800.00 | 5.33 | 24.00 |
| Concentrate | | | | |
| 90% Whey Protein Isolate | Water/Glycerin | 1600.00 | 10.67 | 48.00 |
| Ph Adjuster-1 (DI Systems | Water/Glycerin | 100.00 | 0.67 | 2.00 |
| and water purification) | | | | |
| CBD 60% (PCR OIL) | Oil | 20.00 | 0.13 | 0.60 |
| Algal Oil (40%) | Oil | 1100.00 | 7.33 | 33.00 |
| MCT Oil (92% MCT from | Oil | 3400.00 | 22.67 | 102.00 |
| Coconut Oil CS) | | | | |
| TPGS -1 | Oil | 100.80 | 0.672 | 3.02 |
| Canola Oil | Oil | 930.00 | 6.20 | 27.90 |
| Ph Adjuster-1 (DI Systems | Oil | 30.00 | 0.20 | 0.90 |
| and water purification) | | | | |
| Potassium Bicarbonate | Emulsion/Flavor | 90.00 | 0.60 | 2.70 |
| Nat. Graham Cracker | Emulsion/Flavor | 150.00 | 1.00 | 4.50 |
| (605185)(Gold Coast) | | | | |
| Nat Smores (605188)(Gold | Emulsion/Flavor | 85.00 | 0.567 | 2.55 |
| Coast) | | | | |
| Totals | | 15000.00 | 100.00 | 450.00 |

The water/glycerin phase was prepared by first weighing the appropriate amounts of water, glycerin, 80% Whey Protein Concentrate, 90% whey protein isolate, and pH Adjuster-1. Next, the water and glycerin were heated together to 65° C. Once the water/glycerin reach 65° C., the 80% whey protein was added and the water jacket was turned off. Next, the mixer speed was increased and the water/glycerin phase was mixed with the 80% whey protein. Subsequently, the 90% whey protein isolate was added and dissolved. After the whey protein was dissolved, the pH adjuster was added.

The oil phase was prepared by first weighing the appropriate amounts of TPGS, 92% MCT oil, canola oil, 40% algal oil, and 60% CBD oil. The Vitamin E TPGS was heated to 60° C. and dissolved in the Oil Phase Tank. The MCT Oil was added and mixed with the TPGS. The temperature was maintained at 40° C. Next, the canola oil was added to the TPGS/MCT oil mixture and mixed. Next, the algal oil was added and mixed into the oil phase while ensuring that the temperature did not exceed 40° C. The CBD oil was then added. Sunflower lecithin then was added to the oil phase, and the oil composition was mixed. Finally, pH Adjuster-1 was added and temperature was maintained at 40° C.

The emulsion was prepared by adding the oil phase at 40° C. to the polar phase slowly while mixing at low to medium (1000-15000 RPM) using an Arde Barinco Mixer Type 74D (Serial No. L-1274) until the mixture is homogeneous, or approximately 5 minutes. Next, potassium bicarbonate and flavoring (i.e., Nat. Graham Cracker and Nat S'mores) were added and mixed. The emulsion was allowed to cool in a cooler with mixing to 25° C. and filled into new totes.

### Example 6

### Liquid Emulsions Containing Whey Protein and Phytocannabinoid-Rich (PCR) Hemp Oil

Appropriate quantities of the raw materials were weighed for the 450 g (4 mL serving size) batch as shown below:

TABLE 8
“Chocolate Caramel Mocha smoothie” composition

| Ingredient | Phase | mg/serving | %/serving | g/batch |
|---|---|---|---|---|
| Water | Water/Glycerin | 2455.00 | 16.37 | 180.03 |
| Glycerin | Water/Glycerin | 3073.20 | 20.488 | 225.40 |
| Chocolate Powder | Water/Glycerin | 500.00 | 3.3333 | 36.67 |
| 80% Whey Protein Concentrate | Water/Glycerin | 800.00 | 5.33 | 58.67 |
| 90% Whey Protein Isolate | Water/Glycerin | 1600.00 | 10.67 | 117.33 |
| Ph Adjuster-1 (DI Systems and | Water/Glycerin | 100.00 | 0.667 | 7.33 |
| water purification) | | | | |
| MCT Oil | Oil | 5386.25 | 35.908 | 162 |
| HempCHOICE 60% | Oil | 63.75 | 0.425 | 4.675 |
| Phytocannabinoid-Rich (PCR) | | | | |
| Hemp Oil | | | | |
| TPGS -1 | Oil | 100.8 | 0.672 | 7.39 |
| Ph Adjuster-1 (DI Systems and | Oil | 30.00 | 0.200 | 2.20 |
| water purification) | | | | |
| Nat Vanilla (GOLD | Emulsion/Flavor | 300 | 2.00 | 22.00 |
| COAST)(603498) | | | | |
| Nat. Banana (Mission) (BA-184) | Emulsion/Flavor | 62.00 | 0.413 | 4.547 |
| Nat Strawberry (Mission)(ST- | Emulsion/Flavor | 400.00 | 2.667 | 29.33 |
| 276) | | | | |
| Caramel Coffee (Gold Coast) | Emulsion/Flavor | 129.00 | 0.86 | 9.46 |
| (600464) | | | | |
| Totals | | 15000.00 | 100.00 | 867 |

The water/glycerin phase was prepared by first weighing the appropriate amounts of water, glycerin, 80% Whey Protein Concentrate, 90% Whey Protein Isolate, chocolate powder and pH adjuster. Next, water and glycerin were heated to 40° C. Once the water phase reached 40° C., preparation of the oil phase began in a separate container (detailed below). Next, the chocolate powder was added to the water/glycerin mixture and mixed. Next, the 80% whey protein concentrate was added. The resulting mixture was vigorously mixed and the 90% whey protein isolate was added with continued vigorous mixing. The mixture was not subsequently re-heated. Finally, the pH adjuster was added to the water/glycerin phase.

The oil phase was prepared by first weighing the appropriate amounts of MCT oil, HempCHOICE® 60% Phytocannabinoid-Rich (PCR) Hemp Oil, TPGS, and pH adjuster. The Vitamin E TPGS was heated to 60° C. and dissolved in the Oil Phase Tank. The MCT Oil was added and mixed with the TPGS. The temperature was maintained at 40° C. Next, the HempCHOICE® 60% Phytocannabinoid-Rich (PCR) Hemp Oil was added to the TPGS/MCT oil mixture and mixed. Finally, pH Adjuster-1 was added and temperature was maintained at 40° C.

The emulsion was prepared by adding the oil phase at 40° C. to the polar phase slowly while mixing at low to medium (1000-15000 RPM) using an Arde Barinco Mixer Type 74D (Serial No. L-1274) until the mixture is homogeneous, or approximately 5 minutes. Next, flavorings (i.e., Nat Vanilla, Nat Banana, Nat. Strawberry and Caramel Coffee) were added and mixed. The emulsion was allowed to cool in a cooler with mixing to 25° C. and filled into new totes.

### Example 7

Liquid emulsions Containing Whey Protein and Hemp Seed Oil Appropriate quantities of the raw materials were weighed for the 450 g batch (15 mL serving size) or 150 g batch (15 mL serving size) as shown below in Table 9 and

Table 10:

TABLE 9
“Caramel Omega MCT smoothie S'mores flavor” composition with
approximately 700 mg DHA, 1 g Hemp oil, 1 g MCT and 2 g protein per 15 mL serving

| Ingredient | Phase | mg/serving | %/serving | g/batch |
|---|---|---|---|---|
| Water | Water/Glycerin | 3847.13 | 25.65 | 38.47 |
| Glycerin | Water/Glycerin | 2672.57 | 17.82 | 26.73 |
| 80% Whey Protein Concentrate | Water/Glycerin | 800.00 | 5.33 | 8.00 |
| 90% Whey Protein Isolate | Water/Glycerin | 1600.00 | 10.67 | 16.00 |
| Ph Adjuster-1 (DI Systems and | Water/Glycerin | 48.00 | 0.32 | 0.48 |
| water purification) | | | | |
| Potassium Bicarbonate | Water/Glycerin | 90.00 | 0.60 | 0.90 |
| ONC Fish Oil | Oil | 2750.00 | 18.33 | 27.50 |
| MCT Oil | Oil | 1200.00 | 8.00 | 12.00 |
| TPGS -1 | Oil | 100.80 | 0.67 | 1.01 |
| Canola oil | Oil | 400.00 | 2.67 | 4.00 |
| Hemp Seed oil | Oil | 1160.00 | 7.73 | 11.60 |
| Nat. Graham Cracker (Gold | Emulsion/Flavor | 206.00 | 1.37 | 2.06 |
| Coast)(605185) | | | | |
| Nat. S'mores (Gold | Emulsion/Flavor | 125.50 | 0.84 | 1.26 |
| Coast)(605188) | | | | |
| Totals | | 15000.00 | 100.00 | 450.00 |

TABLE 10
“Caramel Omega MCT smoothie Strawberry French Toast
Flavor” composition with approximately 700 mg DHA,
1 g Hemp oil, 1 g MCT and 2 g protein per 15 mL serving

| Ingredient | Phase | mg/serving | %/serving | g/batch |
|---|---|---|---|---|
| Water | Water/Glycerin | 3722.13 | 24.81 | 37.22 |
| Glycerin | Water/Glycerin | 2672.57 | 17.82 | 26.73 |
| 80% Whey Protein | Water/Glycerin | 800.00 | 5.33 | 8.00 |
| Concentrate | | | | |
| 90% Whey Protein Isolate | Water/Glycerin | 1600.00 | 10.67 | 16.00 |
| Ph Adjuster-1 (DI Systems and | Water/Glycerin | 48.00 | 0.32 | 0.48 |
| water purification) | | | | |
| Potassium Bicarbonate | Water/Glycerin | 90.00 | 0.60 | 0.90 |
| ONC Fish Oil | Oil | 2750.00 | 18.33 | 27.50 |
| MCT Oil | Oil | 1200.00 | 8.00 | 12.00 |
| Hemp Seed oil | Oil | 1160.00 | 7.73 | 11.60 |
| TPGS-1 | Oil | 100.80 | 0.67 | 1.01 |
| Canola oil | Oil | 400.00 | 2.67 | 4.00 |
| Nat Strawberry French Toast | Emulsion/Flavor | 145.00 | 0.97 | 1.45 |
| (Gold Coast)(605202) | | | | |
| Nat. French Toast (Gold | Emulsion/Flavor | 79.50 | 0.53 | 0.80 |
| Coast)(602201) | | | | |
| Nat. Strawberry (Mission)(ST- | Emulsion/Flavor | 232.00 | 1.55 | 2.32 |
| 276) | | | | |
| Totals | | 15000.00 | 100.00 | 150.00 |

The water/glycerin phase was prepared by first weighing the appropriate amounts of water, glycerin, 80% whey protein concentrate, 90% whey protein isolate, potassium bicarbonate and pH adjuster. Next, water and glycerin were heated to 65° C. Once the water phase reached 65° C., the 80% whey protein concentrate was added. The resulting mixture was vigorously mixed and the 90% whey protein isolate was added with continued vigorous mixing. Once the whey protein was dissolved, pH adjuster and potassium bicarbonate were added to the water/glycerin phase.

The oil phase was prepared by first weighing the appropriate amounts of TPGS, MCT oil, canola oil, ONC Fish Oil and hemp seed oil. The Vitamin E TPGS was heated to 60° C. and dissolved in the Oil Phase Tank. The MCT Oil was added and mixed with the TPGS. The temperature was maintained at 40° C. Next, the canola oil, ONC Fish Oil and hemp seed oil were added to the TPGS/MCT oil mixture and mixed.

The emulsion was prepared by adding the oil phase at 40° C. to the polar phase slowly while mixing at low to medium (1000-15000 RPM) using an Arde Barinco Mixer Type 74D (Serial No. L-1274) until the mixture is homogeneous, or approximately 5 minutes. Next, flavorings (i.e., Nat Graham Cracker and Nat S'mores or Nat Strawberry French Toast, Nat French Toast, and Nat Strawberry) were added and mixed. The emulsion was allowed to cool in a cooler with mixing to 25° C. and filled into new totes.

### Example 8

### Liquid Emulsions Containing Whey Protein

Appropriate quantities of the raw materials were weighed for the 27000 g (15 mL serving size) batch as shown below:

TABLE 11
“MCT Omega protein smoothie” composition with approximately
400 mg DHA, 3 g MCT and 2 g protein per 15 mL serving

| Ingredient | Phase | mg/serving | %/serving | g/batch |
|---|---|---|---|---|
| Water | Water/Glycerin | 3949.33 | 26.329 | 7108.794 |
| Glycerin | Water/Glycerin | 2672.57 | 17.817 | 4810.6 |
| 80% Whey Protein | Water/Glycerin | 800.00 | 5.33 | 1440.00 |
| Concentrate | | | | |
| 90% Whey Protein Isolate | Water/Glycerin | 1600.00 | 10.67 | 2880.00 |
| Ph Adjuster-1 (DI Systems and | Water/Glycerin | 75.00 | 0.50 | 135.00 |
| water purification) | | | | |
| Potassium Bicarbonate | Water/Glycerin | 90.00 | 0.60 | 162.00 |
| Algal Oil (40%) | Oil | 1100.00 | 7.33 | 1980.00 |
| MCT Oil (92% MCT from | Oil | 3400.00 | 22.67 | 6120.00 |
| Coconut Oil CS) | | | | |
| TPGS -1 | Oil | 100.80 | 0.67 | 181.44 |
| Canola Oil | Oil | 950.00 | 6.33 | 1710.00 |
| Nat. Graham Cracker | Emulsion/Flavor | 206.00 | 1.37 | 370.80 |
| (605185)(Gold Coast) | | | | |
| Nat Smores (605188)(Gold | Emulsion/Flavor | 56.30 | 0.38 | 101.34 |
| Coast) | | | | |
| Totals | | 15000.00 | 100.00 | 27000.00 |

The water/glycerin phase was prepared by first weighing the appropriate amounts of water, glycerin, 80% whey protein concentrate, 90% whey protein isolate, potassium bicarbonate and pH adjuster. Next, water and glycerin were heated to 65° C. Once the water phase reached 65° C., the 80% whey protein concentrate was added. The resulting mixture was vigorously mixed and the 90% whey protein isolate was added with continued vigorous mixing. Once the whey protein was dissolved, pH adjuster and potassium bicarbonate were added to the water/glycerin phase.

The oil phase was prepared by first weighing the appropriate amounts of TPGS, MCT oil, canola oil, and algal oil. The Vitamin E TPGS was heated to 60° C. and dissolved in the Oil Phase Tank. The MCT Oil was added and mixed with the TPGS. The temperature was maintained at 40° C. Next, the canola oil and then algal oil were added to the TPGS/MCT oil mixture and mixed. The temperature was maintained at 40° C.

The emulsion was prepared by adding the oil phase at 40° C. to the polar phase slowly while mixing at low to medium (1000-15000 RPM) using an Arde Barinco Mixer Type 74D (Serial No. L-1274) until the mixture is homogeneous, or approximately 5 minutes. Next, flavorings (i.e., Nat Graham cracker and Nat S'mores) were added and mixed. The emulsion was allowed to cool in a cooler with mixing to 25° C. and filled into new totes.

### Example 9

### Liquid Emulsions Containing Collagen and Whey Protein

Appropriate quantities of the raw materials were weighed for the 2700 kg (15 mL serving size) batches as shown below:

TABLE 12
“Chocolate Mocha” composition with approximately
3400 mg CLA, and 500 mg Collagen per 15 mL serving

| Ingredient | Phase | mg/serving | %/serving | kg/batch |
|---|---|---|---|---|
| Water | Water/Glycerin | 3893.63 | 25.958 | 700.85 |
| Glycerin | Water/Glycerin | 2792.570 | 18.617 | 502.66 |
| BioCell ® Collagen | Water/Glycerin | 550.00 | 3.667 | 99.00 |
| 80% Whey Protein | Water/Glycerin | 1230.00 | 8.200 | 221.40 |
| Concentrate | | | | |
| Chocolate Powder | Water/Glycerin | 500 | 3.3333 | 90.00 |
| Ph Adjuster-1 (DI Systems | Water/Glycerin | 150 | 1.00 | 27.00 |
| and water purification) | | | | |
| TPGS-1 | Oil | 100.8 | 0.672 | 18.14 |
| CLA 78% | Oil | 4800.00 | 32.00 | 864.00 |
| Sunflower Oil Organic | Oil | 650.00 | 4.333 | 117.00 |
| Ph Adjuster-1 (DI Systems | Oil | 42.00 | 0.280 | 7.56 |
| and water purification) | | | | |
| Nat Chocolate (Gold | Emulsion/Flavor | 291 | 1.9400 | 52.38 |
| Coast)(600356) | | | | |
| Totals | | 15000.00 | 100.00 | 2700.00 |

TABLE 13
“French Vanilla” composition with approximately
3400 mg CLA, and 500 mg Collagen per 15 mL serving

| Ingredient | Phase | mg/serving | %/serving | kg/batch |
|---|---|---|---|---|
| Water | Water/Glycerin | 4184.63 | 27.898 | 753.23 |
| Glycerin | Water/Glycerin | 2792.570 | 18.617 | 502.66 |
| BioCell ® Collagen | Water/Glycerin | 550.00 | 3.67 | 99.00 |
| 80% Whey Protein | Water/Glycerin | 1430.00 | 9.53 | 257.40 |
| Concentrate | | | | |
| Ph Adjuster-1 (DI Systems | Water/Glycerin | 150 | 1.00 | 27.00 |
| and water purification) | | | | |
| CLA Stepan G-80 | Oil | 4800.00 | 32.00 | 864.00 |
| Sunflower Oil Organic | Oil | 650.00 | 4.333 | 117.00 |
| Ph Adjuster-1 (DI Systems | Oil | 42.00 | 0.280 | 7.56 |
| and water purification) | | | | |
| TPGS-1 | Oil | 100.80 | 0.672 | 1.814 |
| Vanilla Powder | Emulsion/Flavor | 300 | 2.00 | 54.00 |
| Totals | | 15000.00 | 100.00 | 2700.00 |

TABLE 13b
“Chocolate Mocha” composition with approximately
4800 mg CLA and 500 mg Collagen per 15 mL serving

| | phase | mg/serving | % | g/batch |
|---|---|---|---|---|
| Water | Water/glycerin | 3893.63 | 25.958 | 700853.4 |
| Glycerin | Water/glycerin | 2792.570 | 18.617 | 502662.6 |
| BioCell ® Collagen | Water/glycerin | 550.000 | 3.667 | 99000.000 |
| 80% Whey Protein | Water/glycerin | 1230.000 | 8.200 | 221400.000 |
| Concentrate | | | | |
| Ph Adjuster-1 (DI Systems | Water/glycerin | 150 | 1.000 | 27000.00 |
| and water purification) | | | | |
| (Glycerin Phase) | | | | |
| Nat Chocolate (Gold | Emulsion/Flavor | 291 | 1.9400 | 52380.0000 |
| Coast) (600356) | | | | |
| Chocolate powder | Emulsion/Flavor | 500 | 3.3333 | 90000.000 |
| CLA 78% | Oil | 4800.000 | 32.000 | 864000.0000 |
| Sunflower Oil Organic | Oil | 650.000 | 4.333 | 117000.0000 |
| Ph Adjuster-1 (DI Systems | Oil | 42.000 | 0.280 | 7560.000 |
| and water purification) | | | | |
| (Oil phase) | | | | |
| TPGS (Oil Phase) -1 | Oil | 100.8 | 0.672 | 18144.00 |
| | | 15000.00 | 100.000 | 2700000.00 |

The water/glycerin phase was prepared by first weighing the appropriate amounts of water, glycerin, collagen, 80% whey protein concentrate, and pH adjuster. Next, water and glycerin were heated to 45° C. Once the water phase reached 40° C., the collagen was added and mixed. The mixture was then reheated to 75° C. the 80% whey protein concentrate was added and mixed. Once the whey protein was dissolved, pH adjuster was added to the water/glycerin phase.

The oil phase was prepared by first weighing the appropriate amounts of TPGS, sunflower oil, CLA and pH adjuster. The Vitamin E TPGS was heated to 60° C. and dissolved in the Oil Phase Tank. The sunflower oil was added and mixed with the TPGS. The temperature was maintained at 40° C. Next, the CLA was added to the TPGS/sunflower oil mixture and mixed. Finally, the pH adjuster was added to the water/glycerin phase. The temperature was maintained at 40° C.

The emulsion was prepared by adding the oil phase at 40° C. to the polar phase slowly while mixing at low to medium (1000-15000 RPM) using an Arde Barinco Mixer Type 74D (Serial No. L-1274) until the mixture is homogeneous, or approximately 5 minutes. Next, flavoring (i.e., Nat Chocolate or Vanilla Powder) was added and mixed. The emulsion was allowed to cool in a cooler with mixing to 30° C. and filled into new totes.

### Example 10

### Liquid Emulsions Containing Nut Butter and Whey Protein

Appropriate quantities of the raw materials were weighed for the 150 g batches (15 mL serving size) as shown below:

TABLE 14
Emulsion with Almond butter and Whey Protein Isolate

| Ingredient | Phase | mg/serving | %/serving | g/batch |
|---|---|---|---|---|
| Water | Water/Glycerin | 2719.20 | 18.128 | 27.192 |
| Glycerin | Water/Glycerin | 2800.00 | 18.67 | 28.00 |
| Almond Butter | Water/Glycerin | 1950.00 | 13.00 | 19.50 |
| Whey Protein Isolate | Water/Glycerin | 2000.00 | 13.33 | 20.00 |
| Ph Adjuster-1 (DI Systems and | Water/Glycerin | 48.00 | 0.32 | 0.48 |
| water purification) | | | | |
| Potassium Bicarbonate | Water/Glycerin | 200.00 | 1.33 | 2.00 |
| TPGS-1 | Oil | 100.80 | 0.67 | 1.01 |
| MCT Oil (92% MCT from | Oil | 3400.00 | 22.67 | 34.00 |
| Coconut Oil CS) | | | | |
| Algal Oil | Oil | 1100.00 | 7.33 | 11.00 |
| Canola Oil | Oil | 450.00 | 3.00 | 4.50 |
| Nat. Strawberry (Mission) (ST- | Emulsion/Flavor | 232.00 | 1.55 | 2.32 |
| 276) | | | | |
| Totals | | 15000.00 | 100.00 | 150.00 |

TABLE 15
Emulsion with Almond butter and Whey Protein Concentrate

| Ingredient | Phase | mg/serving | %/serving | g/batch |
|---|---|---|---|---|
| Water | Water/Glycerin | 2719.20 | 18.128 | 27.192 |
| Glycerin | Water/Glycerin | 2800.00 | 18.667 | 28.0 |
| Almond Butter | Water/Glycerin | 2950.00 | 19.667 | 29.500 |
| Whey Protein Concentrate | Water/Glycerin | 1000.00 | 6.667 | 10.00 |
| Ph Adjuster-1 (DI Systems and | Water/Glycerin | 48.00 | 0.320 | 0.48 |
| water purification) | | | | |
| Potassium Bicarbonate | Water/Glycerin | 200.00 | 1.3333 | 2.00 |
| TPGS-1 | Oil | 100.80 | 0.672 | 1.01 |
| MCT Oil (92% MCT from | Oil | 3400.00 | 22.667 | 34.00 |
| Coconut Oil CS) | | | | |
| Algal Oil | Oil | 1100.00 | 7.333 | 11.00 |
| Canola Oil | Oil | 450.0 | 3.00 | 4.50 |
| Nat. Strawberry (Mission) (ST- | Emulsion/Flavor | 232 | 1.5467 | 2.3200 |
| 276) | | | | |
| Totals | | 15000.00 | 100.00 | 150.00 |

TABLE 16
Emulsion with Almond butter, Whey Protein Concentrate and Whey Protein Isolate

| Ingredient | Phase | mg/serving | %/serving | g/batch |
|---|---|---|---|---|
| Water | Water/Glycerin | 2919.20 | 19.461 | 29.192 |
| Glycerin | Water/Glycerin | 2600.00 | 17.33 | 26.0 |
| Almond Butter | Water/Glycerin | 3150.00 | 21.00 | 31.50 |
| Whey Protein Isolate | Water/Glycerin | 600.00 | 4.00 | 6.00 |
| Whey Protein Concentrate | Water/Glycerin | 200.00 | 1.333 | 2.00 |
| Ph Adjuster-1 (DI Systems and | Water/Glycerin | 48 | 0.320 | 0.48 |
| water purification) | | | | |
| Potassium Bicarbonate | Water/Glycerin | 200 | 1.33 | 2.00 |
| TPGS-1 | Oil | 100.8 | 0.672 | 1.01 |
| MCT Oil (92% MCT from Coconut | Oil | 3400.00 | 22.667 | 34.00 |
| Oil CS) | | | | |
| Algal Oil | Oil | 1100.00 | 7.33 | 11.00 |
| Canola Oil | Oil | 450.0 | 3.00 | 4.50 |
| Nat Strawberry (Mission) (ST- | Emulsion/Flavor | 232 | 1.5467 | 2.3200 |
| 276) | | | | |
| Totals | | 15000.00 | 100.00 | 150.00 |

The water/glycerin phase was prepared by first weighing the appropriate amounts of water, glycerin, almond butter, whey protein isolate (if applicable), whey protein concentrate (if applicable), pH adjuster and potassium bicarbonate. Next, water and glycerin were heated to 75° C. Once the water phase reached 75° C., the almond butter was added and mixed. The mixture was heated for 2 hours at 55° C. The mixture temperature was maintained at 55° C. If applicable, the 80% whey protein concentrate was added and mixed until the whey protein concentrate was dissolved. The resulting mixture was vigorously mixed and, if applicable, the 90% whey protein isolate was added with continued vigorous mixing. Once the whey protein was dissolved, pH adjuster was added to the water/glycerin phase. Just prior to emulsion, potassium bicarbonate was added to the water/glycerin phase.

The oil phase was prepared by first weighing the appropriate amounts of TPGS, MCT Oil, Algal Oil, and Canola Oil. The Vitamin E TPGS was heated to 60° C. and dissolved in the Oil Phase Tank. The MCT oil was added and mixed with the TPGS. The temperature was maintained at 40° C. Next, the canola oil was added to the TPGS/MCT oil mixture and mixed. Finally, the algal oil was added. The temperature was maintained at 40° C.

The emulsion was prepared by adding the oil phase at 40° C. to the polar phase slowly while mixing at low to medium (1000-15000 RPM) using an Arde Barinco Mixer Type 74D (Serial No. L-1274) until the mixture is homogeneous, or approximately 5 minutes. Next, flavoring (i.e., Nat Strawberry) was added and mixed. The emulsion was allowed to cool in a cooler with mixing to 30° C. and filled into new totes.

### Example 11

### Liquid Emulsions Containing Nut Butter

Appropriate quantities of the raw materials were weighed for the 150 g batches (15 mL serving size) as shown in Table 17 and Table 18 below:

TABLE 17
Emulsion with Almond butter containing approximately
400 mg DHA and 3 g MCT per 15 ml

| Ingredient | Phase | mg/serving | %/serving | g/batch |
|---|---|---|---|---|
| Water | Water/Glycerin | 2719.20 | 18.13 | 27.19 |
| Glycerin | Water/Glycerin | 1800.00 | 12.00 | 18.00 |
| Almond Butter | Water/Glycerin | 4950.00 | 33.00 | 49.50 |
| Ph Adjuster-1 (DI Systems and | Water/Glycerin | 48.00 | 0.32 | 0.48 |
| water purification) | | | | |
| Potassium Bicarbonate | Water/Glycerin | 200.00 | 1.33 | 2.00 |
| TPGS-1 | Oil | 100.80 | 0.67 | 1.01 |
| MCT Oil (92% MCT from Coconut | Oil | 3400.00 | 22.67 | 34.00 |
| Oil CS) | | | | |
| Canola Oil | Oil | 450.00 | 3.00 | 4.50 |
| Algal Oil | Oil | 1100.00 | 7.33 | 11.00 |
| Nat. Strawberry (Mission) (ST- | Emulsion/Flavor | 232.00 | 1.547 | 2.32 |
| 276) | | | | |
| Totals | | 15000.00 | 100.00 | 150.00 |

TABLE 18
Emulsion with Almond butter without Glycerin containing
approximately 400 mg DHA and 3 g MCT per 15 ml

| Ingredient | Phase | mg/serving | %/serving | g/batch |
|---|---|---|---|---|
| Water | Water | 2719.20 | 18.128 | 27.192 |
| Almond Butter | Water | 6750.00 | 45.00 | 67.50 |
| Ph Adjuster-1 (DI Systems and | Water | 48 | 0.320 | 0.48 |
| water purification) | | | | |
| Potassium Bicarbonate | Water | 200 | 1.33 | 2.00 |
| TPGS-1 | Oil | 100.8 | 0.672 | 1.01 |
| MCT Oil (92% MCT from Coconut | Oil | 3400.00 | 22.667 | 34.00 |
| Oil CS) | | | | |
| Canola Oil | Oil | 450.0 | 3.00 | 4.50 |
| Algal Oil | Oil | 1100.00 | 7.33 | 11.00 |
| Nat. Strawberry (Mission) (ST- | Emulsion/Flavor | 232 | 1.5467 | 2.3200 |
| 276) | | | | |
| Totals | | 15000.00 | 100.00 | 150.00 |

The polar phase was prepared by first weighing the appropriate amounts of water, glycerin (if applicable), almond butter, pH adjuster and potassium bicarbonate. Next, water and glycerin or water alone, were heated to 75° C. Once the water phase reached 75° C., the almond butter was added and mixed. The mixture was heated for 2 hours at 55° C. The mixture temperature was maintained at 55° C. Next, pH adjuster was added to the water/glycerin phase. Just prior to emulsion, potassium bicarbonate was added to the water/glycerin phase.

The oil phase was prepared by first weighing the appropriate amounts of TPGS, MCT Oil, Canola Oil, and Algal Oil. The Vitamin E TPGS was heated to 60° C. and dissolved in the Oil Phase Tank. The MCT oil was added and mixed with the TPGS. The temperature was maintained at 40° C. Next, the canola oil was added to the TPGS/MCT oil mixture and mixed. Finally, the algal oil was added. The temperature was maintained at 40° C.

The emulsion was prepared by adding the oil phase at 40° C. to the polar phase slowly while mixing at low to medium (1000-15000 RPM) using an Arde Barinco Mixer Type 74D (Serial No. L-1274) until the mixture is homogeneous, or approximately 5 minutes. Next, flavoring (i.e., Nat Strawberry) was added and mixed. The emulsion was allowed to cool in a cooler with mixing to 30° C. and filled into new totes.

### Example 12

### Liquid Emulsions Containing Whey Protein

Appropriate quantities of the raw materials were weighed for the 150 g batches (15 mL serving size) as shown in Tables 19-23 below:

TABLE 19
“S'mores” Emulsion with Whey Protein Isolate and Whey Protein
Concentrate containing approximately 400 mg DHA, 2 g protein and 3 g MCT per 15 ml

| Ingredient | Phase | mg/serving | %/serving | g/batch |
|---|---|---|---|---|
| Water | Water/Glycerin | 3894.33 | 25.962 | 38.9433 |
| Glycerin | Water/Glycerin | 2672.570 | 17.817 | 26.7 |
| 80% Whey Protein | Water/Glycerin | 400.00 | 2.667 | 4.00 |
| Concentrate | | | | |
| 90% Whey Protein Isolate | Water/Glycerin | 2000.00 | 13.333 | 20.00 |
| Ph Adjuster-1 (DI Systems | Water/Glycerin | 100 | 0.667 | 1.00 |
| and water purification) | | | | |
| Potassium Bicarbonate | Water/Glycerin | 90 | 0.6000 | 0.900 |
| Ph Adjuster-1 (DI Systems | Oil | 30.00 | 0.200 | 0.3 |
| and water purification) | | | | |
| MCT Oil (92% MCT from | Oil | 3400.00 | 22.667 | 34.00 |
| Coconut Oil CS) | | | | |
| TPGS-1 | Oil | 100.8 | 0.672 | 1.01 |
| Algal Oil | Oil | 1100.00 | 7.333 | 11.00 |
| Canola Oil | Oil | 950.0 | 6.333 | 9.50 |
| Nat Graham Cracker | Emulsion/Flavor | 206 | 1.3733 | 2.06 |
| (605185)(Gold Coast) | | | | |
| Nat S'mores | Emulsion/Flavor | 56.3 | 0.3753 | 0.563 |
| (605188)(Gold Coast) | | | | |
| Totals | | 15000.00 | 100.00 | 150.00 |

TABLE 20
“S'mores” Emulsion with Whey Protein Isolate and Whey Protein
Concentrate containing approximately 400 mg DHA, 2 g protein and 3 g MCT per 15 ml

| Ingredient | Phase | mg/serving | %/serving | g/batch |
|---|---|---|---|---|
| Water | Water/Glycerin | 3894.33 | 25.962 | 38.9433 |
| Glycerin | Water/Glycerin | 2672.570 | 17.817 | 26.7 |
| 80% Whey Protein | Water/Glycerin | 800.00 | 5.333 | 8.00 |
| Concentrate | | | | |
| 90% Whey Protein Isolate | Water/Glycerin | 1600.00 | 10.667 | 16.00 |
| Ph Adjuster-1 (DI Systems | Water/Glycerin | 100 | 0.667 | 1.00 |
| and water purification) | | | | |
| Potassium Bicarbonate | Water/Glycerin | 90 | 0.6000 | 0.900 |
| Ph Adjuster-1 (DI Systems | Oil | 30.00 | 0.200 | 0.3 |
| and water purification) | | | | |
| MCT Oil (92% MCT from | Oil | 3400.00 | 22.667 | 34.00 |
| Coconut Oil CS) | | | | |
| TPGS-1 | Oil | 100.8 | 0.672 | 1.01 |
| Algal Oil (40%) | Oil | 1100.00 | 7.333 | 11.00 |
| Canola Oil | Oil | 950.00 | 6.33 | 9.50 |
| Nat Graham Cracker | Emulsion/Flavor | 206 | 1.3733 | 2.06 |
| (605185)(Gold Coast) | | | | |
| Nat. Smores (605188)(Gold | Emulsion/Flavor | 56.3 | 0.3753 | 0.563 |
| Coast) | | | | |
| Totals | | 15000.00 | 100.00 | 150.00 |

TABLE 21
“S'mores” Emulsion with Whey Protein Concentrate containing
approximately 400 mg DHA, 2 g protein and 3 g MCT per 15 ml

| Ingredient | Phase | mg/serving | %/serving | g/batch |
|---|---|---|---|---|
| Water | Water/Glycerin | 3894.33 | 25.962 | 38.9433 |
| Glycerin | Water/Glycerin | 3072.570 | 20.484 | 30.7 |
| 80% Whey Protein | Water/Glycerin | 2000.00 | 13.333 | 20.00 |
| Concentrate | | | | |
| Ph Adjuster-1 (DI Systems | Water/Glycerin | 100 | 0.667 | 1.00 |
| and water purification) | | | | |
| Potassium Bicarbonate | Water/Glycerin | 90 | 0.6000 | 0.900 |
| Ph Adjuster-1 (DI Systems | Oil | 30.00 | 0.200 | 0.3 |
| and water purification) | | | | |
| MCT Oil (92% MCT from | Oil | 3400.00 | 22.667 | 34.00 |
| Coconut Oil CS) | | | | |
| TPGS-1 | Oil | 100.8 | 0.672 | 1.01 |
| Algal Oil (40%) | Oil | 1100.00 | 7.333 | 11.00 |
| Canola Oil | Oil | 950.00 | 6.33 | 9.50 |
| Nat Graham Cracker | Emulsion/Flavor | 206 | 1.3733 | 2.06 |
| (605185)(Gold Coast) | | | | |
| Nat S'mores | Emulsion/Flavor | 56.3 | 0.3753 | 0.563 |
| (605188)(Gold Coast) | | | | |
| Totals | | 15000.00 | 100.00 | 150.00 |

TABLE 22
“S'mores” Emulsion with Whey Protein Isolate containing
approximately 400 mg DHA, 2 g protein and 3 g MCT per 15 ml

| Ingredient | Phase | mg/serving | %/serving | g/batch |
|---|---|---|---|---|
| Water | Water/Glycerin | 3894.33 | 25.962 | 38.9433 |
| Glycerin | Water/Glycerin | 2072.570 | 13.817 | 20.7 |
| 90% Whey Protein Isolate | Water/Glycerin | 3000.00 | 20.00 | 30.00 |
| Ph Adjuster-1 (DI Systems | Water/Glycerin | 100 | 0.667 | 1.00 |
| and water purification) | | | | |
| Potassium Bicarbonate | Water/Glycerin | 90 | 0.60 | 0.90 |
| Ph Adjuster-1 (DI Systems | Oil | 30.00 | 0.200 | 0.3 |
| and water purification) | | | | |
| MCT Oil (92% MCT from | Oil | 3400.00 | 22.667 | 34.00 |
| Coconut Oil CS) | | | | |
| TPGS-1 | Oil | 100.8 | 0.672 | 1.01 |
| Algal Oil (40%) | Oil | 1100.00 | 7.33 | 11.00 |
| Canola Oil | Oil | 950.00 | 6.33 | 9.50 |
| Nat. Graham Cracker | Emulsion/Flavor | 206 | 1.3733 | 2.06 |
| (605185)(Gold Coast) | | | | |
| Nat. S'mores | Emulsion/Flavor | 56.3 | 0.3753 | 0.563 |
| (605188)(Gold Coast) | | | | |
| Totals | | 15000.00 | 100.00 | 150.00 |

TABLE 23
“Root Beer Float” Emulsion with Whey Protein Isolate and Whey Protein
Concentrate containing approximately 400 mg DHA, 2 g protein and 3 g MCT per 15 ml

| Ingredient | Phase | mg/serving | %/serving | g/batch |
|---|---|---|---|---|
| Water | Water/Glycerin | 3822.13 | 25.481 | 38.2213 |
| Glycerin | Water/Glycerin | 2672.570 | 17.817 | 26.7 |
| 80% Whey Protein | Water/Glycerin | 800.000 | 5.333 | 8.000 |
| Concentrate | | | | |
| 90% Whey Protein Isolate | Water/Glycerin | 1600.000 | 10.667 | 16.000 |
| Ph Adjuster-1 (DI Systems | Water/Glycerin | 100 | 0.667 | 1.00 |
| and water purification) | | | | |
| Potassium Bicarbonate | Water/Glycerin | 90 | 0.6000 | 0.900 |
| Ph Adjuster-1 (DI Systems | Oil | 30.00 | 0.200 | 0.3 |
| and water purification) | | | | |
| MCT Oil (92% MCT from | Oil | 3400.00 | 22.667 | 34.00 |
| Coconut Oil CS) | | | | |
| TPGS-1 | Oil | 100.8 | 0.672 | 1.01 |
| Algal Oil (40%) | Oil | 1100.00 | 7.333 | 11.00 |
| Canola Oil | Oil | 950.00 | 6.33 | 9.50 |
| Nat. Root Beer (OC- | Emulsion/Flavor | 224.5 | 1.4967 | 2.2450 |
| 05134)(OC Flavors) | | | | |
| Nat. Vanilla (OC-05130)(OC | Emulsion/Flavor | 80 | 0.5333 | 0.800 |
| Flavors) | | | | |
| Nat. Root Beer (OC- | Emulsion/Flavor | 30 | 0.2000 | 0.300 |
| 04637)(OC Flavors) | | | | |
| Totals | | 15000.00 | 100.00 | 150.00 |

The water/glycerin phase was prepared by first weighing the appropriate amounts of water, glycerin, 80% whey protein concentrate (if applicable), 90% whey protein isolate (if applicable), potassium bicarbonate and pH adjuster. Next, water and glycerin were heated to 65° C. Once the water phase reached 65° C., the 80% whey protein concentrate was added (if applicable). The resulting mixture was vigorously mixed and the 90% whey protein isolate was added (if applicable) with continued vigorous mixing. Once the whey protein was dissolved, pH adjuster was added to the water/glycerin phase. Potassium bicarbonate was added just prior to emulsion.

The oil phase was prepared by first weighing the appropriate amounts of TPGS, MCT oil, canola oil, and algal oil. The Vitamin E TPGS was heated to 60° C. and dissolved in the Oil Phase Tank. The MCT Oil was added and mixed with the TPGS. The temperature was maintained at 40° C. Next, the canola oil and then algal oil were added to the TPGS/MCT oil mixture and mixed. The temperature was maintained at 40° C.

The emulsion was prepared by adding the oil phase at 40° C. to the polar phase slowly while mixing at low to medium (1000-15000 RPM) using an Arde Barinco Mixer Type 74D (Serial No. L-1274) until the mixture is homogeneous, or approximately 5 minutes. Next, flavorings (i.e., Nat Graham cracker and Nat S'mores) were added and mixed. The emulsion was allowed to cool in a cooler with mixing to 25° C. and filled into new totes.

### Example 13

### Stability Analysis

The emulsion was prepared described in Example 12. The final emulsion contained 400 mg DHA; 2 g protein; 3 g MCT in a 15 mL serving size. This “smoothie” emulsion was processed into 6 separate bottles. Process included no iron water (Ultra DI Water), liquid nitrogen displacement and gas purge prior to packaging controls as well as processes and compositions that use potassium bicarbonate during processing in addition to the high dimer TPGS (ESOLV®). A 16 oz final volume was packaged in a PET (polyethylene terephthalate) bottle with heat induction and nitrogen gas purge as well as liquid nitrogen dose.

16 oz. bottles of the “smoothie” emulsion were placed in a stability chamber (Manufactured by Tabai Espec Corp.; Model: PRA-1AP; Serial No. 2980) at 41° C. and 75% relative humidity (RH) for 9 weeks per ICH guidelines (9 weeks in the stability chamber is the equivalent of 18 months on a room temperature shelf). The products were sampled at 3 weeks, 6 weeks and 9 weeks and tested for product stability, including DHA levels. Levels of arsenic, cadmium, mercury and lead also were tested. Levels of various microbes, including yeast, mold, enterobacteriacae, E. coli, Salmonella spp., Staphylococcus aureus, Clostridium spp., and Pseudomonas aeruginosa. Results are detailed in Table 24, below.

6 of 6 samples did not have any off taste that would otherwise be associated with Omega-3 DHA, MCT or protein degradation after 9 week accelerated stability. All 6 samples did not have any negative characteristics, such as precipitation, that can be associated with high fate Omega 3 emulsion. All 6 products were no different than the control and samples post study were no different than the beginning of the study. Micro testing shows within specification as well as total DHA. Stability was influenced by sample packaging, including nitrogen dosing in the bottles under high pressure and the ability of the samples to equate ambient conditions.

Exemplary stability and contamination data are provided in Table 24 below, In a 15 mL sample, the level of DHA at T=0 was 443.73 mg and at T=9 weeks was 438.32 mg. Flavor was ranked as ‘good’ at both time points. At 9 weeks, test results were as follows:

TABLE 24
Analyses after 9 weeks in stability chamber

| Analyses | Results | |
|---|---|---|
| DHA (GC) | 438.32 mg/15 ml | |
| Arsenic (As) | 0.004 | ppm |
| Cadmium (Cd) | <0.01 | ppm |
| Mercury (Hg) | 0.001 | ppm |
| Lead (Pb) | 0.033 | ppm |
| Total plate count | <10 | CFU/g |
| Yeast and Mold | <10 | CFU/g |
| Enterobacteriacae | <1 | MPN/g |

| | |
|---|---|
| Escherichia coli | Negative/10 g |
| Salmonella spp. | Negative/10 g |
| Staphylococcus aureus | Negative/10 g |
| Clostridium spp. | Negative/10 g |
| Pseudomonas aeruginosa | Negative/10 g |

### Example 14

### Water Activity

Water activity of the emulsions produced according to the protocol described in Example 12 was tested. The water activity (AW) of a food is calculated as the ratio between the vapor pressure the food sample without influence from the outside atmosphere and the vapor pressure of distilled water under the same conditions. For example, a water activity of 0.90 AW of a food means that the vapor pressure of the food is 90% of distilled water.

Food water activity greater than 0.95 provides sufficient moisture to support bacteria, yeast, and mold growth. Thus, the water activity should be 0.95 or less to reduce the risk of contamination. Decreasing the amount of available moisture in the food inhibits organism growth. For example, water activity of food at or less than 0.85 AW is assumed to not support microbial growth, and is not subject to the regulations of the U.S. Food and Drug Administration rules set forth in Title 21, Code of Federal Regulations CFR Sections 108, 113, and 114.

Water activity of the emulsions produced according to the protocol described in Example 12 was 0.5238 AW at T=0 and T=1. In a second experiment, water activity of the emulsion produced according to the protocol described in Example 12 was 0.8446 AW at T=0.

### Example 15

### Particle size

The emulsions herein that include the relatively high nut protein and/or whey protein and low surfactant, such as TPGS, (between about 0.5% and 1% (w/v), such as between about 0.5-0.75%, such as between about 0.65-0.70% (w/v) result in emulsions in which the particles are between about 5 μm and 11 μM in diameter. These properties provide a creamy taste and consistency to the emulsions and provide stability. The emulsions incorporate a healthful amount of protein, and also provide for incorporation of healthful oils, such as algal oils, fish oils, CBD oils, and other such nutritional/supplement products. The particle size distribution is between about 5 μm-15 where at least about 95% of the particles are in this range. In some instances the particle sizes range between 5 μm and 11 μm, with substantially or all, between this range, and about 90% between 5 mM and 8 μm.

The particle size of the emulsions produced according to the protocols described in Example 10 (not PBJ), Example 12 (Breakfast Smoothie and Root Beer float) were tested; the results are set forth in Tables 25-27, below. Particle size was assessed using a HORIBA Laser Scattering Particle Size Distribution Analyzer (Horiba Scientific; Model LA-960) and data were analyzed using Windows [Wet] Version. 8.10. For each of the following analyses the circulation speed was 3, the agitation speed was 2, and the convergence factor was 15. The refractive index of the emulsion in water was 1.5-0.010 for the emulsion and 1.33 for water. D(v,0.1) designates that 10% of the particles are smaller than this diameter. D(v,0.5) designates that 50% of particles are smaller than this diameter (this is equivalent to the median). D(v,0.9) designates that 90% of particles are smaller than this diameter.

The column headings in Tables 25-27 indicate the following: “No.” designates the channel number; “Diameter” designates the smallest size in a given channel in microns (μm); “q” designates the percent (%) of each size particle by volume in a given size channel; and “Undersize” designates the percent (%) below the channel. For example, in Table 25, the first channel is between 5.122 and 5.867 μm and 11.9% of the total particles are between 5.122 and 5.867 μm and 100% of particles are between 5.122 μm and 11.565 μm.

Emulsions produced in accord with the protocols described herein exhibit particle sizes greater than 3 μm, generally greater than or equal to 5 μm, and generally greater than 7 μm.

The emulsions produced according to the protocol in Example 10, exhibits a mean particle size of 5.81837 μm and median size of 6.18392 μm, with a standard deviation of 1.0805 μm. D(v,0.1), D(v,0.5) and D(v,0.9) were 5.10244 μm, 5.81837 μm and 7.80142 μm, respectively. The surface area was 9956.7 cm²/cm². The raw data showing the distribution of particles size are set forth in Table 25, below. The particles between about 5 μm and 11 μM in diameter.

TABLE 25
Particle size data of emulsion containing almond
butter, whey protein, MCT oil and algal oil

| No. | Diameter (μm) | q (%) | Undersize (%) |
|---|---|---|---|
| 1 | 5.122 | 11.912 | 11.912 |
| 2 | 5.867 | 40.571 | 52.483 |
| 3 | 6.72 | 23.613 | 76.096 |
| 4 | 7.697 | 13.199 | 89.294 |
| 5 | 8.816 | 7.087 | 96.381 |
| 6 | 10.097 | 3.619 | 100 |
| 7 | 11.565 | 0.0 | 100 |
| 8 | 13.246 | 0.0 | 100 |
| 9 | 15.172 | 0.0 | 100 |
| 10 | 17.377 | 0.0 | 100 |
| 11 | 19.904 | 0.0 | 100 |
| 12 | 22.797 | 0.0 | 100 |
| 13 | 26.111 | 0.0 | 100 |
| 14 | 29.907 | 0.0 | 100 |
| 15 | 34.255 | 0.0 | 100 |
| 16 | 39.234 | 0.0 | 100 |
| 17 | 44.938 | 0.0 | 100 |
| 18 | 51.471 | 0.0 | 100 |
| 19 | 58.953 | 0.0 | 100 |
| 20 | 67.523 | 0.0 | 100 |
| 21 | 77.339 | 0.0 | 100 |
| 22 | 88.583 | 0.0 | 100 |
| 23 | 101.46 | 0.0 | 100 |
| 24 | 116.21 | 0.0 | 100 |
| 25 | 133.103 | 0.0 | 100 |
| 26 | 152.453 | 0.0 | 100 |
| 27 | 174.616 | 0.0 | 100.0 |
| 28 | 200 | 0.0 | 100.0 |
| 29 | 229.075 | 0.0 | 100.0 |
| 30 | 262.376 | 0.0 | 100.0 |
| 31 | 300.518 | 0.0 | 100.0 |
| 32 | 344.206 | 0.0 | 100.0 |
| 33 | 394.244 | 0.0 | 100.0 |
| 34 | 451.556 | 0.0 | 100.0 |
| 35 | 517.2 | 0.0 | 100.0 |
| 36 | 592.387 | 0.0 | 100.0 |
| 37 | 678.504 | 0.0 | 100.0 |
| 38 | 777.141 | 0.0 | 100.0 |
| 39 | 890.116 | 0.0 | 100.0 |
| 40 | 1019.515 | 0.0 | 100.0 |
| 41 | 1167.725 | 0.0 | 100.0 |
| 42 | 1337.481 | 0.0 | 100.0 |
| 43 | 1531.914 | 0.0 | 100.0 |
| 44 | 1754.613 | 0.0 | 100.0 |
| 45 | 2009.687 | 0.0 | 100.0 |
| 46 | 2301.841 | 0.0 | 100.0 |
| 47 | 2636.467 | 0.0 | 100.0 |
| 48 | 3019.738 | 0.0 | 100.0 |
| 49 | 3458.727 | 0.0 | 100.0 |
| 50 | 3961.532 | 0.0 | 100.0 |
| 51 | 4537.433 | 0.0 | 100.0 |
| 52 | 5000 | 0.0 | 100.0 |

The emulsion produced according to the protocol set forth in Example 12 exhibits a mean particle size of 5.74125 μm and median size of 6.03320 μm with a standard deviation of 0.9391 μm. D(v,0.1), D(v,0.5) and D(v,0.9) were 5.09625 μm, 5.74125 μm and 7.41775 μm, respectively. The surface area was 10150 cm²/cm². The raw data are set forth in Table 26, below. The particles between about 5 μm and 11 μM in diameter.

TABLE 26
Particle size data of emulsion containing
whey protein, MCT oil and Algal oil

| No. | Diameter (μm) | q (%) | Undersize (%) |
|---|---|---|---|
| 1 | 5.122 | 12.670 | 12.670 |
| 2 | 5.867 | 44.414 | 57.084 |
| 3 | 6.720 | 24.370 | 81.455 |
| 4 | 7.697 | 11.737 | 93.192 |
| 5 | 8.816 | 4.958 | 98.150 |
| 6 | 10.097 | 1.850 | 100.0 |
| 7 | 11.565 | 0.0 | 100.0 |
| 8 | 13.246 | 0.0 | 100.0 |
| 9 | 15.172 | 0.0 | 100.0 |
| 10 | 17.377 | 0.0 | 100.0 |
| 11 | 19.904 | 0.0 | 100.0 |
| 12 | 22.797 | 0.0 | 100.0 |
| 13 | 26.111 | 0.0 | 100.0 |
| 14 | 29.907 | 0.0 | 100.0 |
| 15 | 34.255 | 0.0 | 100.0 |
| 16 | 39.234 | 0.0 | 100.0 |
| 17 | 44.938 | 0.0 | 100.0 |
| 18 | 51.471 | 0.0 | 100.0 |
| 19 | 58.953 | 0.0 | 100.0 |
| 20 | 67.523 | 0.0 | 100.0 |
| 21 | 77.339 | 0.0 | 100.0 |
| 22 | 88.583 | 0.0 | 100.0 |
| 23 | 101.460 | 0.0 | 100.0 |
| 24 | 116.210 | 0.0 | 100.0 |
| 25 | 133.103 | 0.0 | 100.0 |
| 26 | 152.453 | 0.0 | 100.0 |
| 45 | 2009.687 | 0.0 | 100.0 |
| 46 | 2301.841 | 0.0 | 100.0 |
| 47 | 2636.467 | 0.0 | 100.0 |
| 48 | 3019.738 | 0.0 | 100.0 |
| 49 | 3458.727 | 0.0 | 100.0 |
| 50 | 3961.532 | 0.0 | 100.0 |
| 51 | 4537.433 | 0.0 | 100.0 |
| 52 | 5000.000 | 0.0 | 100.0 |
| 27 | 174.616 | 0.0 | 100.0 |
| 28 | 200.000 | 0.0 | 100.0 |
| 29 | 229.075 | 0.0 | 100.0 |
| 30 | 262.376 | 0.0 | 100.0 |
| 31 | 300.518 | 0.0 | 100.0 |
| 32 | 344.206 | 0.0 | 100.0 |
| 33 | 394.244 | 0.0 | 100.0 |
| 34 | 451.556 | 0.0 | 100.0 |
| 35 | 517.200 | 0.0 | 100.0 |
| 36 | 592.387 | 0.0 | 100.0 |
| 37 | 678.504 | 0.0 | 100.0 |
| 38 | 777.141 | 0.0 | 100.0 |
| 39 | 890.116 | 0.0 | 100.0 |
| 40 | 1019.515 | 0.0 | 100.0 |
| 41 | 1167.725 | 0.0 | 100.0 |
| 42 | 1337.481 | 0.0 | 100.0 |
| 43 | 1531.914 | 0.0 | 100.0 |
| 44 | 1754.613 | 0.0 | 100.0 |

The emulsion produced according to the protocol in Example 12 (root beer float) exhibits a mean particle size of 7.04694 μm and median size of 8.13873 μm with a standard deviation of 3.4420 μm. D(v,0.1), D(v,0.5) and D(v,0.9) were 5.30499 μm, 7.04694 μm and 12.29492 μm, respectively. The surface area was 8274.7 cm²/cm². The raw data showing the distribution are set forth in Table 27, below.

TABLE 27
Particle size data of emulsion containing
whey protein, MCT oil and Algal oil

| No. | Diameter (μm) | q (%) | Undersize (%) |
|---|---|---|---|
| 1 | 5.122 | 4.385 | 4.385 |
| 2 | 5.867 | 21.742 | 26.127 |
| 3 | 6.720 | 18.524 | 44.651 |
| 4 | 7.697 | 15.273 | 59.924 |
| 5 | 8.816 | 12.198 | 72.122 |
| 6 | 10.097 | 9.322 | 81.444 |
| 7 | 11.565 | 6.566 | 88.009 |
| 8 | 13.246 | 4.414 | 92.424 |
| 9 | 15.172 | 2.870 | 95.294 |
| 10 | 17.377 | 1.843 | 97.137 |
| 11 | 19.904 | 1.195 | 98.332 |
| 12 | 22.797 | 0.789 | 99.121 |
| 13 | 26.111 | 0.528 | 99.649 |
| 14 | 29.907 | 0.351 | 100.0 |
| 15 | 34.255 | 0.0 | 100.0 |
| 16 | 39.234 | 0.0 | 100.0 |
| 17 | 44.938 | 0.0 | 100.0 |
| 18 | 51.471 | 0.0 | 100.0 |
| 19 | 58.953 | 0.0 | 100.0 |
| 20 | 67.523 | 0.0 | 100.0 |
| 21 | 77.339 | 0.0 | 100.0 |
| 22 | 88.583 | 0.0 | 100.0 |
| 23 | 101.460 | 0.0 | 100.0 |
| 24 | 116.210 | 0.0 | 100.0 |
| 25 | 133.103 | 0.0 | 100.0 |
| 26 | 152.453 | 0.0 | 100.0 |
| 27 | 174.616 | 0.0 | 100.0 |
| 28 | 200.000 | 0.0 | 100.0 |
| 29 | 229.075 | 0.0 | 100.0 |
| 30 | 262.376 | 0.0 | 100.0 |
| 31 | 300.518 | 0.0 | 100.0 |
| 32 | 344.206 | 0.0 | 100.0 |
| 33 | 394.244 | 0.0 | 100.0 |
| 34 | 451.556 | 0.0 | 100.0 |
| 35 | 517.200 | 0.0 | 100.0 |
| 36 | 592.387 | 0.0 | 100.0 |
| 37 | 678.504 | 0.0 | 100.0 |
| 38 | 777.141 | 0.0 | 100.0 |
| 39 | 890.116 | 0.0 | 100.0 |
| 40 | 1019.515 | 0.0 | 100.0 |
| 41 | 1167.725 | 0.0 | 100.0 |
| 42 | 1337.481 | 0.0 | 100.0 |
| 43 | 1531.914 | 0.0 | 100.0 |
| 44 | 1754.613 | 0.0 | 100.0 |
| 45 | 2009.687 | 0.0 | 100.0 |
| 46 | 2301.841 | 0.0 | 100.0 |
| 47 | 2636.467 | 0.0 | 100.0 |
| 48 | 3019.738 | 0.0 | 100.0 |
| 49 | 3458.727 | 0.0 | 100.0 |
| 50 | 3961.532 | 0.0 | 100.0 |
| 51 | 4537.433 | 0.0 | 100.0 |
| 52 | 5000.000 | 0.0 | 100.0 |

### Example 16

### Comparative Liquid Emulsions Containing More than 1.5% TPGS, No Nut Butter or Whey

The resulting emulsion in this Example has a particle size between about 1 μm and 3 μm, which does not have the advantageous properties of the emulsions provided herein, in which the average particle size are 5 μm or larger, such as those in which at least 90% of the particles are between 5-15 μm. This product is less stable, and less tasty and less creamy.

Appropriate quantities of the raw materials were weighed for the 1100 g batches as shown in Table 28 below:

TABLE 28
Berry Flavor Emulsion with 1.5% TPGS

| Ingredient | Phase | mg/serving | %/serving | g/batch |
|---|---|---|---|---|
| Water | Water/Glycerin | 4068.80 | 27.125 | 81.376 |
| Glycerin | Water/Glycerin | 1500.00 | 10.00 | 30.00 |
| Saladizer | Water/Glycerin | 14.00 | 0.093 | 0.28 |
| Sucrose Fatty Acid Ester | Water/Glycerin | 250.00 | 1.67 | 5.00 |
| Xylitol | Water/Glycerin | 2250.00 | 15.00 | 45.00 |
| TPGS (Oil Phase) | Oil | 225.00 | 1.50 | 4.50 |
| Safflower Oil (Oil Phase) | Oil | 5600.00 | 37.33 | 112.00 |
| Citric Acid pH 3.2-3.6 (Oil Phase) | Oil | 68.00 | 0.453 | 1.36 |
| Blueberry Juice concentrate | Emulsion/Flavor | 750.00 | 5.00 | 15.00 |
| Nat. Vanilla (WILD)(DABK820) | Emulsion/Flavor | 50.00 | 0.33 | 1.00 |
| Nat. Strawberry | Emulsion/Flavor | 180.00 | 1.20 | 3.60 |
| (KERRY)(53308801) | | | | |
| Raspberry (WILD(DABJ876) | Emulsion/Flavor | 30.80 | 0.2053 | 0.616 |
| Nat Grape (WILD)(DABJ 829) | Emulsion/Flavor | 13.40 | 0.0893 | 0.268 |
| Totals | | 15000.00 | 100.00 | 1100.00 |

The water/glycerin phase was prepared by first weighing the appropriate amounts of water, glycerin, Saladizer® brand emulsion stabilizer, sucrose fatty acid ester and xylitol. SALADIZER® brand emulsion stabilizer is a blend of xanthan gum, guar gum and sodium alginate. The items were added, in that order and mixed at 32 RPM using Arde Barinco Shear with heating to 60° C. add Saladizer, Ticamulsion A-2010 mix with IKA mixer until dissolved.

The oil phase was prepared by first weighing the appropriate amounts of TPGS, safflower oil, and citric acid. The Vitamin E TPGS was heated to 60° C. and dissolved in the Oil Phase Tank. The safflower oil, and citric acid were added and mixed. The temperature was maintained at 40° C.

The emulsion was prepared by adding the oil phase at 40° C. to the polar phase slowly while mixing at low to medium (1000-15000 RPM) using an Arde Barinco Mixer Type 74D (Serial No. L-1274) until the mixture is homogeneous, or approximately 5 minutes. Next, flavorings (i.e., blueberry juice concentrate, natural vanilla, natural strawberry, raspberry and natural grape) were added and mixed. The emulsion was allowed to cool in a cooler with mixing to 25° C. and filled into totes.

### Example 17

### Liquid Emulsions Containing Collagen and Whey Protein at Lower pH

Appropriate quantities of the raw materials were weighed for the 2700 kg (15 mL serving size) batches as shown below:

TABLE 29
“Chocolate Twist” composition with approximately
3400 mg CLA, and 500 mg Collagen per 15 mL serving

| Ingredient | Phase | mg/serving | %/serving | kg/batch |
|---|---|---|---|---|
| Water | Water/Glycerin | 3833.63 | 25.558 | 690.0534 |
| Glycerin | Water/Glycerin | 2792.570 | 18.617 | 502.66 |
| BioCell ® Collagen | Water/Glycerin | 550.00 | 3.667 | 99.00 |
| 80% Whey Protein Concentrate | Water/Glycerin | 1230.00 | 8.200 | 221.40 |
| Chocolate Powder | Water/Glycerin | 500 | 3.3333 | 90.00 |
| Ph Adjuster-1 (DI Systems and | Water/Glycerin | 150 | 1.00 | 27.00 |
| water purification) | | | | |
| TPGS-1 | Oil | 100.8 | 0.672 | 18.14 |
| CLA 78% | Oil | 4800.00 | 32.00 | 864.00 |
| Sunflower Oil Organic | Oil | 650.00 | 4.333 | 117.00 |
| Ph Adjuster-1 (DI Systems and | Oil | 42.00 | 0.280 | 7.56 |
| water purification) | | | | |
| Nat Chocolate (Gold | Emulsion/Flavor | 291 | 1.9400 | 52.38 |
| Coast)(600356) | | | | |
| Citric acid | Emulsion | 60 | 0.4000 | 10800.000 |
| Totals | | 15000.00 | 100.00 | 2700.00 |

The water/glycerin phase was prepared by first weighing the appropriate amounts of water, glycerin, collagen, 80% whey protein concentrate, and pH adjuster. Next, water and glycerin were heated to 40° C. Once the water phase reached 40° C., the collagen was added and mixed. Then, the chocolate powder was added. The mixture was then reheated to 75° C. and the 80% whey protein concentrate was added and mixed. Once the whey protein was dissolved, pH adjuster was added to the water/glycerin phase. The temperature was maintained at 40° C.

The oil phase was prepared by first weighing the appropriate amounts of TPGS, sunflower oil, CLA and pH adjuster. The Vitamin E TPGS was heated to 60° C. and dissolved in the Oil Phase Tank. The sunflower oil was added and mixed with the TPGS. The temperature was maintained at 40° C. Next, the CLA was added to the TPGS/sunflower oil mixture and mixed and the temperature was maintained at 40° C. Finally, the pH adjuster was added to the water/glycerin phase. The temperature was maintained at 40° C.

The emulsion was prepared by adding the oil phase at 40° C. to the polar phase slowly while mixing at low to medium (1000-15000 RPM) using an Arde Barinco Mixer Type 74D (Serial No. L-1274) until the mixture is homogeneous, or approximately 5 minutes. Next, flavoring (i.e., Nat Chocolate) and citric acid were added and mixed; resulting pH was lower than 4.6. The emulsion was allowed to cool in a cooler with mixing to 30° C. and filled into new totes.

### Example 18

### Liquid Emulsions Containing Nut Butter at Lower pH

Appropriate quantities of the raw materials were weighed for the 263000 g batches (15 mL serving size) as shown in Table 30 below:

TABLE 30
Almond Raspberry Emulsion with Almond butter containing
approximately 400 mg DHA and 3 g MCT per 15 ml

| Ingredient | Phase | mg/serving | %/serving | g/batch |
|---|---|---|---|---|
| Water | Water/Glycerin | 2419.20 | 16.128 | 42416.64 |
| Glycerin | Water/Glycerin | 1800.00 | 12.00 | 31560.0 |
| Almond Butter | Water/Glycerin | 4950.00 | 33.00 | 86790.00 |
| Ph Adjuster-1 (DI Systems and water | Water/Glycerin | 48.00 | 0.32 | 841.60 |
| purification) | | | | |
| Potassium Bicarbonate | Water/Glycerin | 200.00 | 1.33 | 3506.667 |
| TPGS-1 | Oil | 100.80 | 0.67 | 1767.36 |
| MCT Oil (92% MCT from Coconut Oil | Oil | 3400.00 | 22.67 | 59613.33 |
| CS) | | | | |
| Canola Oil | Oil | 450.00 | 3.00 | 7890.00 |
| Algal Oil | Oil | 1100.00 | 7.33 | 19286.6667 |
| Raspberry Juice Concentrate | Emulsion/Flavor | 432 | 2.8800 | 7574.4000 |
| Nat Raspberry Flavor | Emulsion/Flavor | 100 | 0.6667 | 1753.333 |
| Potassium Bicarbonate | Emulsion | 200 | 1.333 | 3506.667 |
| Totals | | 15000.00 | 100.00 | 263000.00 |

The polar phase was prepared by first weighing the appropriate amounts of water, glycerin) almond butter, pH adjuster and potassium bicarbonate. Next, water and glycerin, were heated to 75° C. Once the polar phase reached 75° C., the almond butter was added and mixed. The mixture was heated for 2 hours at 55° C. The mixture temperature was maintained at 55° C. Next, pH adjuster was added to the water/glycerin phase. Just prior to emulsion, potassium bicarbonate was added to the water/glycerin phase.

The oil phase was prepared by first weighing the appropriate amounts of TPGS, MCT Oil, Canola Oil, and Algal Oil. The Vitamin E TPGS was heated to 60° C. and dissolved in the Oil Phase Tank. The MCT oil was added and mixed with the TPGS. The temper-ature was maintained at 40° C. Next, the canola oil was added to the TPGS/MCT oil mixture and mixed. The algal oil was added. The temperature was maintained at 40° C.

The emulsion was prepared by adding the oil phase at 40° C. to the polar phase slowly while mixing at low to medium (1000-15000 RPM) using an Arde Barinco Mixer Type 74D (Serial No. L-1274) until the mixture was homogeneous, or for approximately 5 minutes. Next, flavoring (i.e., Natural Raspberry flavoring and Raspberry juice concentrate) was added and mixed. The emulsion was allowed to cool in a cooler with mixing to 30° C. and filled into new totes. The pH of the resulting emulsion is approximately 5.6.

### Example 19

### Liquid Emulsions Containing Whey Protein at Lower pH

Appropriate quantities of the raw materials were weighed for the 6000 g batches (15 mL serving size) as shown in Tables 31-33 below:

TABLE 31
Tangerine Emulsion with Whey Protein Isolate and Whey Protein Concentrate
containing approximately 400 mg DHA, 2 g protein and 3 g MCT per 15 ml

| Ingredient | Phase | mg/serving | %/serving | g/batch |
|---|---|---|---|---|
| Water | Water/Glycerin | 3541.63 | 23.611 | 1416.652 |
| Glycerin | Water/Glycerin | 2672.570 | 17.817 | 1069.03 |
| 80% Whey Protein | Water/Glycerin | 800.00 | 5.333 | 320.0 |
| Concentrate | | | | |
| 90% Whey Protein Isolate | Water/Glycerin | 1600.00 | 10.667 | 640.00 |
| Ph Adjuster-1 (DI Systems | Water/Glycerin | 100 | 0.667 | 40.00 |
| and water purification) | | | | |
| Potassium Bicarbonate | Water/Glycerin | 90 | 0.6000 | 36.00 |
| Ph Adjuster-1 (DI Systems | Oil | 30.00 | 0.200 | 12.0 |
| and water purification) | | | | |
| MCT Oil (92% MCT from | Oil | 3400.00 | 22.667 | 1360.000 |
| Coconut Oil CS) | | | | |
| TPGS-1 | Oil | 100.8 | 0.672 | 40.32 |
| Algal Oil (40%) | Oil | 1100.00 | 7.333 | 440.0000 |
| Canola Oil | Oil | 950.00 | 6.33 | 380.00 |
| Nat Pink Grapefruit Flavor | Emulsion/Flavor | 113 | 0.7533 | 45.2000 |
| Nat Tangerine Flavor | Emulsion/Flavor | 91 | 0.6067 | 36.400 |
| Nat Vanilla Powder Extract | Emulsion/Flavor | 300 | 2.0000 | 120.000 |
| Nat Vanilla Liquid Flavor | Emulsion/Flavor | 61 | 0.4067 | 24.400 |
| Citric Acid | Emulsion | 50 | 0.3333 | 20.000 |
| Totals | | 15000.00 | 100.00 | 6000.00 |

TABLE 32
Blueberries and Cream Emulsion with Whey Protein Isolate
and Whey Protein Concentrate containing approximately
400 mg DHA, 2 g protein and 3 g MCT per 15 ml

| Ingredient | Phase | mg/serving | %/serving | g/batch |
|---|---|---|---|---|
| Water | Water/Glycerin | 3341.63 | 22.278 | 1336.652 |
| Glycerin | Water/Glycerin | 2672.570 | 17.817 | 1069.0 |
| 80% Whey Protein | Water/Glycerin | 800.000 | 5.333 | 320.000 |
| Concentrate | | | | |
| 90% Whey Protein Isolate | Water/Glycerin | 1600.000 | 10.667 | 640.000 |
| Ph Adjuster-1 (DI Systems | Water/Glycerin | 100 | 0.667 | 40.00 |
| and water purification) | | | | |
| Potassium Bicarbonate | Water/Glycerin | 90 | 0.6000 | 36.00 |
| Ph Adjuster-1 (DI Systems | Oil | 30.00 | 0.200 | 12.0 |
| and water purification) | | | | |
| MCT Oil (92% MCT from | Oil | 3400.00 | 22.667 | 1360.000 |
| Coconut Oil CS) | | | | |
| TPGS-1 | Oil | 100.8 | 0.672 | 40.32 |
| Algal Oil (40%) | Oil | 1100.00 | 7.333 | 440.0000 |
| Canola Oil | Oil | 950.00 | 6.33 | 380.00 |
| Nat Blueberry Juice | Emulsion/Flavor | 313 | 2.0867 | 125.2000 |
| Concentrate | | | | |
| Nat Blueberry Flavor | Emulsion/Flavor | 91 | 0.6067 | 36.400 |
| Nat Vanilla Powder Extract | Emulsion/Flavor | 300 | 2.0000 | 120.000 |
| Nat Vanilla Liquid Flavor | Emulsion/Flavor | 61 | 0.4067 | 24.400 |
| Citric Acid | Emulsion | 50 | 0.3333 | 20.000 |
| Totals | | 15000.00 | 100.00 | 6000.00 |

TABLE 33
Peaches and Cream Emulsion with Whey Protein Isolate and Whey Protein Concentrate
containing approximately 400 mg DHA, 2 g protein and 3 g MCT per 15 ml

| Ingredient | Phase | mg/serving | %/serving | g/batch |
|---|---|---|---|---|
| Water | Water/Glycerin | 3541.63 | 23.611 | 1416.652 |
| Glycerin | Water/Glycerin | 2672.570 | 17.817 | 1069.0 |
| 80% Whey Protein | Water/Glycerin | 800.000 | 5.333 | 320.000 |
| Concentrate | | | | |
| 90% Whey Protein Isolate | Water/Glycerin | 1600.000 | 10.667 | 640.000 |
| Ph Adjuster-1 (DI Systems | Water/Glycerin | 100 | 0.667 | 40.00 |
| and water purification) | | | | |
| Potassium Bicarbonate | Water/Glycerin | 90 | 0.6000 | 36.00 |
| Ph Adjuster-1 (DI Systems | Oil | 30.00 | 0.200 | 12.0 |
| and water purification) | | | | |
| MCT Oil (92% MCT from | Oil | 3400.00 | 22.667 | 1360.000 |
| Coconut Oil CS) | | | | |
| TPGS-1 | Oil | 100.8 | 0.672 | 40.32 |
| Algal Oil (40%) | Oil | 1100.00 | 7.333 | 440.0000 |
| Canola Oil | Oil | 950.00 | 6.33 | 380.00 |
| Nat Peach Flavor | Emulsion/Flavor | 113 | 0.7533 | 45.2000 |
| Nat Mango Flavor | Emulsion/Flavor | 91 | 0.6067 | 36.400 |
| Nat Vanilla Powder Extract | Emulsion/Flavor | 300 | 2.0000 | 120.000 |
| Nat Vanilla Liquid Flavor | Emulsion/Flavor | 61 | 0.4067 | 24.400 |
| Citric Acid | Emulsion | 50 | 0.3333 | 20.000 |
| Totals | | 15000.00 | 100.00 | 6000.00 |

The water/glycerin phase was prepared by first weighing the appropriate amounts of water, glycerin, 80% whey protein concentrate (if applicable), 90% whey protein isolate, potassium bicarbonate and pH adjuster. Next, water and glycerin were heated to 65° C. When the water phase reached 65° C., the 80% whey protein concentrate was added The resulting mixture was vigorously mixed and the 90% whey protein isolate was added with continued vigorous mixing. Once the whey protein was dissolved, pH adjuster was added to the water/glycerin phase. Potassium bicarbonate was added just prior to emulsion.

The oil phase was prepared by first weighing the appropriate amounts of TPGS, MCT oil, canola oil, and algal oil. The Vitamin E TPGS was heated to 60° C. and dissolved in the Oil Phase Tank. The MCT Oil was added and mixed with the TPGS. The temperature was maintained at 40° C. Next, the canola oil and then algal oil were added to the TPGS/MCT oil mixture and mixed. The temperature was maintained at 40° C.

The emulsion was prepared by adding the oil phase at 40° C. to the polar phase slowly while mixing at low to medium (1000-15000 RPM) using an Arde Barinco Mixer Type 74D (Serial No. L-1274) until the mixture is homogeneous, or approximately 5 minutes. Next, flavorings (i.e., Nat Peach flavor, Nat Mango Flavor, Nat Vanilla Powder Extract, Nat Vanilla Liquid Flavor, Nat Blueberry Flavor, Nat. Blueberry Juice Concentrate, Nat Pink Grapefruit Flavor, and/or Nat Tangerine Flavor) and citric acid were added and mixed. The emulsion was allowed to cool in a cooler with mixing to 25° C. and filled into new totes.

The pH of the resulting Peaches and Cream and Tangerine emulsions was approximately 4.7, and the pH of the blueberries and cream emulsion was approximately 5.6.

### Example 20

### Stability Analysis: Emulsion at pH >4.61 and <6.00

Emulsions were prepared as described in Examples 17-19. Each of these “smoothie” emulsions was processed into 6 separate bottles. Process included no iron water (Ultra DI Water), liquid nitrogen displacement and gas purge prior to packaging controls as well as processes and compositions that use potassium bicarbonate during processing in addition to the high dimer TPGS (sold as ESOLV® TPGS, Virun, see. U.S. Pat. No. 9,351,517). A 16 oz. final volume was packaged in a PET bottle with heat induction and nitrogen gas purge as well as liquid nitrogen dose.

16 oz. bottles of each “smoothie” emulsion was placed in a stability chamber (Manufactured by Tabai Espec Corp.; Model: PRA-1AP; Serial No. 2980) at 41° C. and 75% relative humidity (RH) for 12 weeks per ICH guidelines (12 weeks in the stability chamber is the equivalent of 24 months on a room temperature shelf). The products were sampled at 0 weeks, and 12 weeks and tested for product stability, including DHA levels, detailed in Table 34, below.

TABLE 34
Stability at 12 weeks

| | | T = 0 | T = 12 weeks |
|---|---|---|---|
| Blueberries and Cream | EPA DHA per 15 mL | 450 mg | 445 mg |
| | Flavor | good | good |
| Peaches and Cream | EPA DHA per 15 mL | 443 mg | 447 mg |
| | Flavor | good | good |
| Almond Raspberry | EPA DHA per 15 mL | 437 mg | 436 mg |
| | Flavor | good | good |
| Tangerine | EPA DHA per 15 mL | 435 mg | 432 mg |
| | Flavor | good | good |

6 of 6 samples each of 5 groups (4 flavors and one control at higher pH) did not have any off taste that would otherwise be associated with Omega-3 DHA, MCT or protein degradation after 12 week accelerated stability. All 6 samples did not have any negative characteristics, such as precipitation, that can be associated with high fat Omega 3 emulsion. All emulsions at the lower pH post study were no different from the beginning of the study. Micro testing shows within specification as well as total DHA. Stability was influenced by sample packaging, including nitrogen dosing in the bottles under high pressure and the ability of the samples to equate ambient conditions. Lower pH (such as 4.61, to about 6) can increase the stability of the emulsions.

### Example 21

### Liquid Emulsions Containing Nut Butter and Collagen

Appropriate quantities of the raw materials were weighed for the 300 g batches (30 mL serving size) as shown in Table 35 below:

TABLE 35
Pecan flavor Emulsion with Almond butter, Cordyceps, L-Theanine and Algal and MCT oil

| Ingredient | Phase | mg/serving | %/serving | g/batch |
|---|---|---|---|---|
| Water | Water/Glycerin | 8689.00 | 28.963 | 86.89 |
| Glycerin | Water/Glycerin | 3800.000 | 12.667 | 38.0 |
| Collagen Peptides (90% Fish | Water/Glycerin | 5700.000 | 19.000 | 57.000 |
| Collagen) | | | | |
| Almond Butter | Water/Glycerin | 3200.000 | 10.667 | 32.000 |
| Ph Adjuster-1 (DI Systems and water | Water/Glycerin | 100 | 0.333 | 1.00 |
| purification) | | | | |
| Potassium Bicarbonate | Water/Glycerin | 200 | 0.6667 | 2.000 |
| Cordyceps (500 mg) | Water/Glycerin | 525 | 1.7500 | 5.250 |
| L-Theanine (SunTheanine;(200 mg)) | Water/Glycerin | 210 | 0.7000 | 2.100 |
| TPGS-1 | Oil | 201.0 | 0.670 | 2.01 |
| Algal Oil (40%) | Oil | 1100.000 | 3.667 | 11.00000 |
| MCT Oil (92% MCT from Coconut Oil | Oil | 5750.000 | 19.167 | 57.50000 |
| CS) | | | | |
| Nat. Pecan (Gold Coast)(381302) | Emulsion/Flavor | 412 | 1.3733 | 4.1200 |
| Nat. Caramel (Gold Coast)(603040) | Emulsion/Flavor | 113 | 0.3767 | 1.130 |
| Totals | | 30000.00 | 100.000 | 300.00 |

The polar phase was prepared by first weighing the appropriate amounts of water, glycerin, almond butter, pH adjuster and potassium bicarbonate. Next, water and glycerin were heated to 65° C. Once the water phase reached 65° C., the almond butter was added and mixed. Next, the L-Theanine was added to the mixture and dissolved. Next, the Cordyceps was added to the mixture and dissolved. The mixture was heated to 55° C. and maintained for 2 hours at 55° C. After 2 hours, and just prior to emulsion, pH adjuster (TEA) and then potassium bicarbonate was added to the water/glycerin phase.

The oil phase was prepared by first weighing the appropriate amounts of TPGS, MCT Oil and Algal Oil. The Vitamin E TPGS was heated to 60° C. and dissolved in the Oil Phase Tank. The MCT oil was added and mixed with the TPGS. The temperature was maintained at 40° C. Next, the algal oil was added to the TPGS/MCT oil mixture and mixed thoroughly, where the temperature was maintained at 40° C.

The emulsion was prepared by adding the oil phase at 40° C. to the polar phase slowly while mixing at low to medium (1000-15000 RPM) using an Arde Barinco Mixer Type 74D (Serial No. L-1274) until the mixture is homogeneous, or approximately 5 minutes. Next, flavoring (i.e., Caramel and Pecan) was added and mixed. The emulsion was allowed to cool in a cooler with mixing to 25° C. and filled into new totes.

### Example 22

### Liquid Emulsions Containing Nut Butter

Appropriate quantities of the raw materials were weighed for the 150 g batches (15 mL serving size) as shown in Table 36 below:

TABLE 36
Emulsion with Almond butter, L-Theanine, Malitake, and MCT and Algal Oil

| Ingredient | Phase | mg/serving | %/serving | g/batch |
|---|---|---|---|---|
| Water | Water/Glycerin | 1831.45 | 12.210 | 18.3145 |
| Glycerin | Water/Glycerin | 255.750 | 1.705 | 2.6 |
| Almond Butter | Water/Glycerin | 3000.000 | 20.000 | 30.000 |
| Sugar* | Water/Glycerin | 750.000 | 5.000 | 7.500 |
| Ph Adjuster-1 (DI Systems and water | Water/Glycerin | 48 | 0.320 | 0.48 |
| purification) | | | | |
| Potassium Bicarbonate | Water/Glycerin | 200 | 1.3333 | 2.000 |
| L-Theanine (SunTheanine ®)(200 mg) | Water/Glycerin | 210 | 1.4000 | 2.100 |
| Maitake (500 mg) | Water/Glycerin | 525 | 3.5000 | 5.250 |
| TPGS-1 | Oil | 100.8 | 0.672 | 1.01 |
| MCT Oil (92% MCT from Coconut Oil | Oil | 5750.000 | 38.333 | 57.50000 |
| CS) | | | | |
| Algal Oil (40%) | Oil | 1100.0 | 7.333 | 11.00 |
| Nat. Pecan (Gold Coast)(381302) | Emulsion/Flavor | 633 | 4.2200 | 6.3300 |
| Nat. Caramel (Gold Coast)(603040) | Emulsion/Flavor | 596 | 3.9733 | 5.960 |
| Totals | | 15000.00 | 100.000 | 150.00 |

*sugar is optional, and can be replaced with additional nut butter and/or water/glycerin

The polar phase was prepared by first weighing the appropriate amounts of water, glycerin, almond butter, sugar, pH adjuster and potassium bicarbonate. Next, water and glycerin were heated to 65° C. Once the water phase reached 65° C., the almond butter was added and mixed. The optional sugar is added prior to adding the nut butter. Next, the L-Theanine was added to the mixture and dissolved. Next, the Maitake was added to the mixture and dissolved. The mixture was heated to 55° C. and maintained for 2 hours at 55° C. After 2 hours, and just prior to emulsion, pH adjuster (triethanolyamine(TEA)) and then potassium bicarbonate were added to the water/glycerin phase.

The oil phase was prepared by first weighing the appropriate amounts of TPGS, MCT Oil and Algal Oil. The Vitamin E TPGS was heated to 60° C. and dissolved in the Oil Phase Tank. The MCT oil was added and mixed with the TPGS. The temperature was maintained at 40° C. Next, the algal oil was added to the TPGS/MCT oil mixture and mixed thoroughly, where the temperature was maintained at 40° C.

The emulsion was prepared by adding the oil phase at 40° C. to the polar phase slowly while mixing at low to medium (1000-15000 RPM) using an Arde Barinco Mixer Type 74D (Serial No. L-1274) until the mixture is homogeneous, or approximately 5 minutes. Next, flavoring (i.e., Caramel and Pecan) was added and mixed. The emulsion was allowed to cool in a cooler with mixing to 25° C. and filled into new totes.

### Example 23

### Liquid Emulsions Containing Nut Butter

Appropriate quantities of the raw materials were weighed for the 150 g batches (30 mL serving size) as shown in Table 37 below:

TABLE 37
Emulsion with Almond butter, 400 mg DHA and 5 g MCT per 30 mL serving

| Ingredient | Phase | mg/serving | %/serving | g/batch |
|---|---|---|---|---|
| Water | Water/Glycerin | 10429.20 | 34.764 | 52.146 |
| Glycerin | Water/Glycerin | 6697.000 | 22.323 | 33.5 |
| Almond Butter | Water/Glycerin | 3000.000 | 10.000 | 15.000 |
| Ph Adjuster-1 (DI Systems and water | Water/Glycerin | 100 | 0.333 | 0.50 |
| purification) | | | | |
| Potassium Bicarbonate | Water/Glycerin | 200 | 0.6667 | 1.000 |
| Chocamine ® *(cocoa with 12% | Water/Glycerin | 1050.000 | 3.500 | 5.250 |
| theobromide) (1000 mg) | | | | |
| L-Theanine (200 mg) | Water/Glycerin | 210.000 | 0.700 | 1.050 |
| Reishi (500 mg) | Water/Glycerin | 525 | 1.750 | 2.625 |
| Zynamite ®* (Mangifera indica | Water/Glycerin | 210 | 0.7000 | 1.0500 |
| leaves; >60% active Mangiferin) (200 mg) | | | | |
| TPGS-1 | Oil | 100.8 | 0.336 | 0.50 |
| MCT Oil (92% MCT from Coconut Oil CS) | Oil | 5750.000 | 19.167 | 28.75000 |
| Algal Oil (40%) | Oil | 1100.000 | 3.667 | 5.50000 |
| Nat. Pecan (Gold Coast)(381302) | Emulsion/Flavor | 412 | 1.3733 | 2.060 |
| Nat. Caramel (Gold Coast)(603040) | Emulsion/Flavor | 216 | 0.7200 | 1.080 |
| Totals | | 15000.00 | 100.000 | 150.00 |

*Zynamite ® (mango leaf extract containing 60% mangiferin, sold by Nektium; see, e.g., U.S. patent Pub. No. 20,190,216,872); Chocomine ® cocoa extract (available from numerous sources, e.g., RFI Ingredients)

The polar phase was prepared by first weighing the appropriate amounts of water, glycerin, almond butter, pH adjuster and potassium bicarbonate. Next, water and glycerin were heated to 75° C. Once the water phase reached 75° C., the almond butter was added and mixed. Next, the Chocamine®, L-Theanine, Reishi and Zynamite were sequentially added to the mixture and each dissolved. The mixture was heated to 55° C. and maintained for 2 hours at 55° C. After 2 hours, and just prior to emulsion, pH adjuster (TEA) and then potassium bicarbonate was added to the water/glycerin phase.

The oil phase was prepared by first weighing the appropriate amounts of TPGS, MCT Oil and Algal Oil. The Vitamin E TPGS was heated to 60° C. and dissolved in the Oil Phase Tank. The MCT oil was added and mixed with the TPGS. The temperature was maintained at 40° C. Next, the algal oil was added to the TPGS/MCT oil mixture and mixed thoroughly, where the temperature was maintained at 40° C.

The emulsion was prepared by adding the oil phase at 40° C. to the polar phase slowly while mixing at low to medium (1000-15000 RPM) using an Arde Barinco Mixer Type 74D (Serial No. L-1274) until the mixture is homogeneous, or approximately 5 minutes. Next, flavoring (i.e., Caramel and Pecan) was added and mixed. The emulsion was allowed to cool in a cooler with mixing to 25° C. and filled into new totes.

### Example 24

### Liquid Emulsions Containing Macadamia Nut Butter

Appropriate quantities of the raw materials were weighed for the 150 g batches (30 mL serving size) as shown in Tables 38 and 39 below:

TABLE 38
Mocha flavored Emulsion with Macadamia butter,
400 mg DHA and 5 g MCT per 15 mL serving

| Ingredient | Phase | mg/serving | %/serving | g/batch |
|---|---|---|---|---|
| Water | Water/Glycerin | 2574.20 | 17.161 | 471.9366667 |
| Glycerin | Water/Glycerin | 1563.000 | 10.420 | 286.6 |
| Macadamian nut butter | Water/Glycerin | 1700.000 | 11.333 | 311.667 |
| Ph Adjuster-1 (DI Systems and | Water/Glycerin | 48 | 0.320 | 8.80 |
| water purification) | | | | |
| Potassium Bicarbonate | Water/Glycerin | 200 | 1.3333 | 36.667 |
| Cera-Q (65% total silk protein | Water/Glycerin | 323.000 | 2.153 | 59.217 |
| hydrolysate)(Silk Peptide)(200 mg) | | | | |
| Citicholine (Cognizin ®) (250 mg) | Water/Glycerin | 263.000 | 1.753 | 48.217 |
| Lions Mane Mushroom Mycellia | Water/Glycerin | 525 | 3.500 | 96.250 |
| (500 mg) | | | | |
| L-Theanine | Water/Glycerin | 210 | 1.4000 | 38.5000 |
| (Suntheanine ®)(200 mg) | | | | |
| TPGS-1 | Oil | 100.8 | 0.672 | 18.48 |
| MCT Oil (92% MCT from Coconut | Oil | 5250.000 | 35.000 | 962.50000 |
| Oil CS) | | | | |
| Algal Oil (40%) | Oil | 1100.000 | 7.333 | 201.66667 |
| Nat. Caramel Coffee (600464)(Gold | Emulsion/Flavor | 255 | 1.7000 | 46.750 |
| Coast) | | | | |
| Nat. Chocolate (600356)(Gold | Emulsion/Flavor | 238 | 1.5867 | 43.633 |
| Coast) | | | | |
| Chocolate powder | Emulsion/Flavor | 150 | 1.0000 | 27.500 |
| Totals | | 15000.00 | 100.000 | 150.00 |

TABLE 39
Plain Emulsion with Macadamia butter, 400
mg DHA and 5 g MCT per 15 mL serving

| Ingredient | Phase | mg/serving | %/serving | g/batch |
|---|---|---|---|---|
| Water | Water/Glycerin | 2767.20 | 18.448 | 193704 |
| Glycerin | Water/Glycerin | 1563.000 | 10.420 | 109410.0 |
| Macadamia nut butter | Water/Glycerin | 1700.000 | 11.333 | 119000.000 |
| Ph Adjuster-1 (DI Systems | Water/Glycerin | 48 | 0.320 | 3360.00 |
| and water purification) | | | | |
| Potassium Bicarbonate | Water/Glycerin | 200 | 1.3333 | 14000.000 |
| Cera-Q (65% total silk | Water/Glycerin | 323.000 | 2.153 | 22610.000 |
| protein hydrolysate)(Silk | | | | |
| Peptide)(200 mg) | | | | |
| Citicholine (Cognizin ®) | Water/Glycerin | 263.000 | 1.753 | 18410.000 |
| (250 mg) | | | | |
| Lions Mane Mushroom | Water/Glycerin | 525 | 3.500 | 36750.000 |
| Mycellia (500 mg) | | | | |
| L-Theanine | Water/Glycerin | 210 | 1.4000 | 14700.0000 |
| (Suntheanine ®)(200 mg) | | | | |
| TPGS-1 | Oil | 100.8 | 0.672 | 18.48 |
| MCT Oil (92% MCT from | Oil | 5750.000 | 38.333 | 402500.00000 |
| Coconut Oil CS) | | | | |
| Algal Oil (40%) | Oil | 1100.000 | 7.333 | 77000.00000 |
| Vanilla powder | Emulsion/Flavor | 450 | 3.0000 | 31500.000 |
| Totals | | 15000.00 | 100.000 | 150.00 |

For each, the polar phase was prepared by first weighing the appropriate amounts of water, glycerin, macadamia nut butter, pH adjuster and potassium bicarbonate. Next, water and glycerin were heated to 75° C. Once the water phase reached 75° C., the macadamia butter was added and mixed. Next, the Silk protein/peptide, Citicholine, Lions Mane Mushroom Mycellia and L-Theanine were sequentially added to the mixture and each dissolved. The mixture was heated to 55° C. and maintained for 2 hours at 55° C. After 2 hours, and just prior to emulsion, pH adjuster (triethanolamine; TEA) and then potassium bicarbonate were added to the water/glycerin phase.

The oil phase was prepared by first weighing the appropriate amounts of TPGS, MCT Oil and Algal Oil. The Vitamin E TPGS was heated to 60° C. and dissolved in the Oil Phase Tank. The MCT oil was added and mixed with the TPGS. The temperature was maintained at 40° C. Next, the algal oil was added to the TPGS/MCT oil mixture and mixed thoroughly, where the temperature was maintained at 40° C.

The emulsion was prepared by adding the oil phase at 40° C. to the polar phase slowly while mixing at low to medium (1000-15000 RPM) using an Arde Barinco Mixer Type 74D (Serial No. L-1274) until the mixture is homogeneous, or approximately 5 minutes. Next, flavoring (i.e., Vanilla, chocolate, caramel coffee and/or natural chocolate) was added and mixed. The emulsion was allowed to cool in a cooler with mixing to 25° C. and filled into new totes.

Since modifications will be apparent to those of skill in this art, it is intended that this invention be limited only by the scope of the appended claims.

1. An edible emulsion, comprising:
a) one or more polar protic solvents in an amount between about 13% and 50%, by weight, of the emulsion;
b) a protein composition selected from one or more of a nut butter, whey protein, and hydrolyzed collagen, in an amount between about 12% and 45%, by weight, of the emulsion, wherein:
the whey protein is an 80% whey protein concentrate or 90% whey protein isolate;
the nut butter is prepared from nuts or seeds that contain about 10% to 35% protein, by weight, and about 30% to 70% fat, by weight;
c) one or more edible oils in an amount between about 10% to 40%, by weight; and
d) a surfactant, wherein the amount of surfactant is between 0.5% up to less than 2%, or is 0.5% up to 1.5%,
whereby the emulsion comprises particles with a diameter between about 3 μm, 4 μm or 5 μm and up to, and including, about 10 μm, 12 μm, 13 μm, 14 μm or 15 μm.

2. The emulsion of claim 1, selected from a mixture, wherein:
a) the amount of polar protic solvent(s) is between about 25% and 50%, by weight;
the amount of the protein composition is between about 12% and 38%, by weight; and
the amount of oil(s) is between about 30% and 40%, by weight, of the emulsion; or
b) the amount of polar protic solvent(s) is between about 20% and 30%, by weight;
the amount of the protein composition is between about 25% and 38%, by weight; and
the amount of oil(s) is between 10% and 15%, by weight, of the emulsion; or
c) the amount of polar protic solvent(s) is between 15% and 30%, by weight;
the amount of the protein composition is between about 12% and 38%, by weight; and
the amount of oil is between about 10% and 20%, by weight, of the emulsion; or
d) the amount of polar protic solvent(s) is between about 35% and 50%, by weight;
the amount of the protein composition is between about 10% and 30%, by weight; and
the amount of oil(s) is between about 30% and 40%, by weight, of the emulsion.

3. The emulsion of claim 1, wherein:
the amount of polar protic solvent(s) is between about 15% and 20%, by weight;
the amount of the protein composition is between about 30% or 35% and 50%, by weight; and
the amount of oil(s) is between about 10% and 20%, by weight, of the emulsion.

4. The emulsion of claim 3, wherein:
the amount of protein composition is between 40% and 45%, by weight; and
the amount of oil(s) is between about 10% and 15%, by weight, of the emulsion.

5. The emulsion of claim 3, that is a spreadable emulsion that has the viscosity of from jelly to peanut butter, which is about 500-30,000 centipoise (cps).

6. The emulsion of claim 1, wherein the surfactant is a polyalkylene glycol derivative of vitamin E.

7. The emulsion of claim 1, wherein the surfactant is a polyalkylene glycol derivative of vitamin E that is a polyethylene glycol (PEG)-derivative of vitamin E.

8. The emulsion of claim 7, wherein the PEG-derivative of vitamin E is tocopheryl polyethylene glycol succinate (TPGS).

9. The emulsion of claim 6, wherein:
the polyalkylene glycol derivative of vitamin E is a high dimer PEG-derivative of vitamin E mixture that comprises at least 13 wt % water-soluble dimer and up to 87 wt % monomer.

10. The emulsion of claim 1, wherein:
the surfactant is a polyalkylene glycol derivative of vitamin E; and
the polyalkylene glycol derivative of vitamin E is substantially free of any free polyalkylene glycol (PEG) moieties.

11. The emulsion of claim 1, wherein the polar protic solvent is water or glycerin or a mixture of water and glycerin.

12. The emulsion of claim 11, wherein:
the polar protic solvent is a mixture of water and glycerin; and
the amount of water is greater than the amount of glycerin.

13. The emulsion of claim 1, wherein the amount of oil is 10%-15%, by weight, of the emulsion, or is 30%-40%, by weight, or is 35%-40%, by weight, of the emulsion.

14. The emulsion of claim 1, wherein the oil is one or more of vitamin E oil, flaxseed oil, coconut oil, conjugated linoleic acid (CLA), borage oil, rice bran oil, D-limonene, canola oil, corn oil, MCT (medium chain triglycerides) oil, and oat oil.

15. The emulsion of claim 1 that comprises about 0.05%-0.5%, by weight, of a nutraceutical or supplement or therapeutically active oil.

16. The emulsion of claim 1, wherein the oil comprises a cannabinoid.

17. The emulsion of claim 15 that comprises about 0.3%-0.5%, by weight, CBD oil.

18. The emulsion of claim 15, wherein the nutraceutical or supplement or therapeutically active oil is a fish oil or algal oil or hemp oil.

19. The emulsion of claim 1, wherein the protein composition is a nut butter, a whey protein, or collagen, or a mixture of a nut butter and whey protein, or a mixture of collagen and whey protein, or a mixture of nut butter and collagen, or a mixture of whey protein, nut butter and collagen.

20. The emulsion of claim 1, wherein the emulsion comprises 7%-15% or 15%-30%, by weight, whey protein or 80% whey protein concentrate or 90% whey protein isolate; and, optionally, 3%-4%, by weight, collagen.

21. The emulsion of claim 1, where in the emulsion comprises 30%-40% or 40%-45%, by weight, of a nut butter.

22. The emulsion of claim 1, where in the emulsion comprises 5%-15% or 15%-30%, by weight, of a nut butter.

23. An emulsion of claim 1, wherein the protein composition comprises a mixture of 80% whey protein concentrate and 90% whey protein isolate in an amount between about 5% and 16%, by weight, of the emulsion.

24. An emulsion of claim 1, comprising, by weight of the emulsion a mixture selected from among:
(a) 15%-20% water;
10%-15% glycerin;
25%-36% nut butter;
0.6%-0.7% TPGS;
30%-38% oil selected from one or more of MCT oil, CLA, algal oil, fish oil, canola oil, sunflower oil, and hemp seed oil; and
1%-5% flavors; or
b) 15%-30% water;
10%-15% glycerin;
10%-30% nut butter and/or collagen;
0.6%-0.7% TPGS;
20%-30% oil selected from one or more of MCT oil, CLA, algal oil, fish oil, canola oil, sunflower oil, and hemp seed oil;
1%-10% other active ingredients; and
1%-7% flavors; or
c) 15%-30% water;
10%-25% glycerin;
10%-17% nut butter;
0.6%-0.7% TPGS;
35%-50% oil selected from one or more of MCT oil, CLA, algal oil, fish oil, canola oil, sunflower oil, and hemp seed oil;
2%-15% other active ingredients; and
1%-7% flavors; or
d) 10%-15% water;
1%-5% glycerin;
15%-25% nut butter;
0.6%-0.7% TPGS;
35%-50% oil selected from one or more of MCT oil, CLA, algal oil, fish oil, canola oil, sunflower oil, and hemp seed oil;
2%-10% other active ingredients; and
1%-7% flavors; or
e) 30%-40% water;
15%-25% glycerin;
5%-15% nut butter;
0.6%-0.7% TPGS;
20%-30% oil selected from one or more of MCT oil, CLA, algal oil, fish oil, canola oil, sunflower oil, and hemp seed oil;
2%-10% other active ingredients; and
1%-7% flavors.

25. The emulsion of claim 1 that comprises a nut butter, wherein the nut butter is selected from one or more of almond, pecan, pistachio, walnut, Brazil nut, peanut, hazelnut, and cashew nut butter.

26. The emulsion of claim 1, wherein the pH is adjusted to or is between 6 and 8.

27. The emulsion of claim 1, wherein the pH is adjusted to or is between 4.61 and 6.

28. An oil-in-water emulsion, comprising: a polar protic solvent, and
a) a nut butter in an amount of at least 25% up to 45% or 50%, by weight, of the emulsion;
b) less than about 1%, by weight, of polyalkylene glycol derivative of vitamin E; and
c) at least 11% to 40%, by weight, of one or more oils,
wherein the oils are present in the emulsion as droplets having a mean median particle size of greater than 5 μm but less about 10 μm.

29. The emulsion of claim 28, wherein the oils comprise CBD oil.

30. The emulsion of claim 28, wherein the polar protic solvent is water, glycerin or a mixture thereof.

31. The emulsion of claim 28, wherein in the polyalkylene glycol derivative of vitamin E is a PEG-derivative of vitamin E.

32. The emulsion of claim 28, wherein the polyalkylene glycol derivative of vitamin E is tocopheryl polyethylene glycol succinate (TPGS).

33. The emulsion of claim 28, comprising 0.6% to 0.7%, by weight, TPGS.

34. The emulsion of claim 33, wherein the TPGS is PEG free.

35. The emulsion of claim 28, wherein the pH is adjusted to or is between 4.61 and 6.

36. A method for preparing an emulsion, comprising:
a) providing a first mixture, wherein:
the first mixture comprises one or more polar protic solvents in an amount between about 13% and 50%, by weight, of the emulsion;
the first mixture comprises a protein composition selected from one or more of a nut butter, whey protein, and hydrolyzed collagen, in an amount between about 10% and 45%, by weight, of the emulsion;
b) providing a second mixture wherein:
the second mixture comprises one or more edible oils in an amount between about 10% and 40%, by weight; and
the second mixture comprises less than about 1%, by weight, of polyalkylene glycol derivative of vitamin E; and
c) combining the first mixture with the second mixture under high-shear conditions to form an emulsion of the non-polar compound or mixture of non-polar compounds, whereby in the resulting emulsion, the non-polar compounds or mixture thereof comprise particles with a diameter between about 5 μm and 15 μm.
